(19) United States
(12) Patent Application Publication
(10) Pub. No.: US 2025/0135409 A1
(43) Pub. Date: May 1, 2025

(54) Ultralow-Fouling Zwitterionic Polyurethane-Modified Membrane Methods and Devices for Rapid Separation of Plasma From Whole Blood

(71) Applicant: The Board of Trustees of the University of Illinois, Urbana, IL (US)

(72) Inventors: Gang Cheng, Chicago, IL (US); Sangil Kim, Urbana, IL (US); Seol Hyang, Urbana, IL (US); Wang Kun, Urbana, IL (US)

(21) Appl. No.: 18/682,855

(22) PCT Filed: Aug. 10, 2022
(86) PCT No.: PCT/US2022/039979

§ 371 Date: Feb. 9, 2024

Related U.S. Application Data
(60) Provisional application No. 63/231,489, filed on Aug. 10, 2021.

(51) Int. Cl. B01D 71/54; B01D 69/02; C08G 18/10; C08G 18/32; C08G 18/83; G01N 1/40

(52) U.S. Cl. CPC B01D 71/54; B01D 69/02; C08G 18/10; C08G 18/3275; C08G 18/832; G01N 1/4077; B01D 2325/02833; B01D 2325/02834; G01N 2001/4088

(57) ABSTRACT

A plasma separation device including a blood inlet and a plasma outlet, the blood inlet comprising an inlet tunnel configured for loading a whole blood sample and a first chamber configured for collecting the whole blood sample; the plasma outlet comprising a second chamber for collecting plasma separated from the whole blood; the device comprising an anti-fouling membrane disposed between the blood inlet and the plasma outlet, the anti-fouling membrane comprising a zwitterionic polyurethane or pre-polymer thereof, wherein the zwitterionic polyurethane or pre-polymer thereof comprises a monomeric unit comprising a zwitterion or precursor thereof and optionally a monomeric unit derived from a polyol, wherein the monomeric unit derived from a polyol is present in a molar ratio in a range of about 0 to about 0.80 relative to the combined amount of monomeric unit derived from a polyol and the monomeric unit comprising a zwitterion or precursor thereof.

### CROSS-REFERENCE TO RELATED APPLICATION

Priority is claimed to U.S. Provisional Patent Application 63/231,489, filed Aug. 10, 2021, the entire disclosure of which is incorporated herein by reference.

### STATEMENT OF GOVERNMENT INTEREST

This invention was made with government support under grant number DMR-1454837 and DMR-1741935 awarded by the National Science Foundation (NSF). The government has certain rights in the invention.

### BACKGROUND

### Field of the Disclosure

This disclosure relates to polymers with tunable mechanical swelling properties having a zwitterionic precursor monomeric unit, uses thereof, and methods of preparation thereof.

### Brief Description of Related Technology

Human blood consists of 45% erythrocytes (red blood cells [RBCs]), 1% leukocytes (white blood cells [WBCs]), 1% thrombocytes (platelets), and 55% plasma. Blood plasma contains a myriad of biomarkers that are useful for medical diagnostic purposes. Therapeutic plasma exchange has been used for various life-threatening and debilitating diseases. Plasma components, such as nucleic acids, proteins, and metabolites, are widely used in clinical settings to diagnose and track the treatment of diseases such as human immunodeficiency virus (HIV), sepsis, malaria, and cancer. However, unwanted cellular contents in the plasma can interfere with pathogen detection and compromise clinical applications of blood plasma. For example, the presence of cellular components (e.g., hemoglobin and blood cells) can inhibit deoxyribonucleic acid (DNA) polymerases or reverse transcriptase in polymerase chain reaction (PCR) tests, leading to inaccurate quantification or even false-negative results. Thus, removing blood cells is an essential step when performing blood tests for clinical diagnostic and therapeutic purposes.

Currently, blood separation is typically performed in a diagnostic laboratory equipped with a high-speed centrifuge, which may be prohibitive for many rural and less-developed regions. Moreover, in less-developed areas, blood samples must be collected from surrounding clinics and delivered to a central diagnostic laboratory. These time-consuming sample treatment processes increase the diagnosis-to-treatment interval and impact the accuracy of results due to contamination or hemolysis.

Hence, a rapid and simple plasma separation device that can be employed at the clinic/bedside is highly desirable for accurate and point-of-care pathogen diagnostics.

Various microfluidic-based plasma separation devices have been developed for on-site testing and point-of-care diagnostics. These devices can be classified into different categories based on the separation mechanism, including asymmetric capillary, blood cell sedimentation, crossflow filtration, inertial force, erythrocyte capture, and size-selective separation. However, microfluidic-based devices require either highly diluted blood or yield only a small amount of plasma, ranging from a few to tens of microliters. The sample volume is often a limiting factor for clinical diagnosis, as small samples may not possess sufficient target components for tests such as PCR. For example, 20 million people carrying HIV are currently receiving antiretroviral therapy, and treatment monitoring for this therapy has a viral load threshold of 1000-copy/mL. At such low concentrations, the number of virus copies in tens of microliters of plasma has reached the detection limit for state-of-the-art traditional HIV viral load assays. This concentration is also below the detection capability of most current point-of-care HIV viral load tests.

Membrane-based separation serves as a good alternative that is both simple and inexpensive. In one example, 27.4 μL plasma was extracted from 75 μL undiluted blood in 4.3 min using a membrane-integrated plasma collection tube. In another example, a membrane-based, sedimentation-assisted device was developed that can extract 275 μL plasma from 1.8 mL whole blood in 7 min. Later, a superhydrophobic plasma separator was reported that delivers 65 μL plasma from 200 μL whole blood in 10 min. The above plasma separation processes rely on blood cell capture on an asymmetric membrane, which limits the blood handling capacity to a certain area of the membrane and prevents the treatment of large blood volumes. In membrane-based separations, membrane fouling has been a long-standing challenge, which hinders the wide adoption of membrane-based devices for biomedical applications. Proteins adsorb on the surface or in the pores of membranes within seconds to minutes after the first blood-contact, followed by the adhesion of blood cells, fibrinolysis, and coagulation, which cause clogging of the membrane pores and significantly decreases the membrane flux.

Although several polymers, for example, poly(ethylene glycol) (PEG) have been broadly employed to modify membrane surfaces to improve the anifouling properties of the membrane, they are insufficient to resist protein adsoption on the membrane surface.

Polyurethane (PU) comprises a large family of materials with the common characteristic that carries urethane linkages along the polymer backbone. In recent years, various PUs have been developed to provide good biocompatibility, high strength, high elasticity and processing versatility over a wide range of biomedical applications. These properties are important for in vivo applications, including catheters, drug delivery, tissue engineering, as well as in a variety of injection molded devices. Protein absorption on PUs, which is the initial stage of the blood coagulation cascade, was found to be slower or less than other materials due to hydrogen bond forming groups. This property makes PUs very attractive for a variety of medical applications that require both tunable strength and antithrombotic properties. However, there are several challenges remaining before fully realizing the potential of PU for these applications. First, anti-fouling properties of known PUs are unsatisfactory for applications in complex biological media (e.g., blood, body fluid and cell lysate). Second, most PUs do not possess both anti-fouling properties and functionality to conjugate other moieties. Thirdly, PU-based coatings can slightly reduce bacterial attachment, but cannot resist long-term biofilm formation. For example, biofilm formation on medical implants results in the formation of persistent infections that are up to 1000 times more resistant to conventional antibiotics than free bacteria. In response to these challenges, researchers have tried to incorporate hydrolysable/degradable or antifouling moieties into PUs to improve their anti-fouling properties. However, for degradable PU approach, the hydrophobic degradable moieties, such as polycaprolactone (PCL) or polylactic acid (PLA), still lead to the protein adsorption, since the degradation rate of the degradable moieties are significantly slower than the blood adsorption/coagulation rate. For anti-fouling approach, anti-fouling moieties, such as polyethylene glycol (PEG), have been incorporated into PU. Although PEG has been used alone or combined with other component for a broad spectrum of applications for anti-fouling purposes almost over 30 years, the critical challenges of PEG for in vivo applications, such as foreign body response, infection, and thrombosis, remain unsolved.

Zwitterionic materials, biologically inspired by phosphatidylcholine (PC) group in the phospholipidbilayer of cell membranes, possess both anionic and cationic groups with overall charge neutrality. Since they have been developed, zwitterionic materials have demonstrated excellent anti-fouling properties for blood, microorganisms, and mammalian cells. Compared to PEG-based surfaces, zwitterionic materials can form strong hydration layer via ionic solvation to resist foulants. With quaternary ammonium as common cationic groups, and phosphate, carboxylate or sulfonate as common anionic groups, zwitterionic polymers can be broadly classified into poly(phosphobetaine) (PPB), poly(carboxybetaine) (PCB) and poly(sulfobetaine) (PSB). Among them, PCB-based materials have demonstrated the outstanding antifouling properties of resisting proteins, mammalian cells and microbes, excellent biocompatibility as well as capability of functionalization for applications in biomedical devices.

Several approaches have been extensively studied to incorporate zwitterionic functional groups onto materials. Surface modification methods are commonly used, as this process is simple and time-saving. However, the modifications can be quickly depleted from the material surface in aqueous media due to the high water solubility of most zwitterionic agents. After detachment of the zwitterionic coating, the underlying substrate loses its antifouling property, which can cause a foreign body reaction in vivo. Thus, the surface coating method is not suitable for bio-application. Although end functional groups, such as dopamine, have been introduced to zwitterionic polymers to anchor the polymers on a membrane surface, it is challenging to use this approach to obtain a high density of zwitterionic groups, which is critical to achieving good antifouling performance.

Another approach to stabilize the zwitterionic polymer layer on the membrane surface is the “graft-from” method, which has better stability than surface modification. However, this method involves complicated and time-consuming surface modification procedures that hinder technological adoption for high-volume production. Other zwitterionic polymers used for membrane surface modification include block copolymers that possess an anchoring subunit to provide hydrophobic or electrostatic interactions. However, the zwitterionic subunit surface density can be diluted by the anchoring subunits, which hinders the effectiveness of the antifouling properties provided by the zwitterionic groups. Recently, zwitterionic polymers have been developed to incorporate zwitterionic functional groups in bulk material, which can overcome the disadvantages of “graft-to” and “graft-from” methods. Nevertheless, due to their high polarity and solubility in water, linear zwitterionic materials usually exhibit a relatively low Young's modulus and unsatisfactory elasticity. Although crosslinking was applied to increase the mechanical properties of zwitterionic materials, the large-scale fabrication and shaping of crosslinked materials are hard.

Although the challenges remain for zwitterionic PUs due to the lack of chemistry, zwitterionic PUs still have the greatest potential for the most challenging in vivo applications. PUs can not only provide an antifouling surface/bio-interface, but also have the tunable bulk mechanical properties. PU's morphology presents two very different structural phases: alternated hard and soft segments. Hard segments are responsible for high mechanical resilience while soft segments provide the PU an elastomeric behavior. Therefore, their singular molecular structure provide them good properties such as high strength, ductility, chemical stability, and ease of processability.

Overall, for antifouling functional materials employed in membrane modifications, a superior antifouling ability, high solubility in solvents, low solubility in water, and strong intermolecular interactions with the host membrane are desired to form a stable, high-density coating. Yet, none of the existing materials provide all of the required properties.

There exists a need in the art to provide membranes for membrane-based separation for biomedical applications, such as protective fabrics, respirator filters, and biomedical applications (e.g., hemodialysis, plasma separation, and the like) that demonstrate ultralow biomolecule fouling properties, high water flux, mechanical stability (flexibility), chemical stability, and low manufacturing costs.

### SUMMARY

One aspect of the disclosure provides a plasma separation device including a blood inlet and a plasma outlet, the blood inlet comprising an inlet tunnel configured for loading a whole blood sample and a first chamber configured for collecting the whole blood sample; the plasma outlet comprising a second chamber for collecting plasma separated from the whole blood; the device comprising an anti-fouling membrane disposed between the blood inlet and the plasma outlet configured for separating the plasma from the whole blood, the anti-fouling membrane comprising a zwitterionic polyurethane or pre-polymer thereof, wherein the zwitterionic polyurethane or pre-polymer thereof comprises a monomeric unit comprising a zwitterion or precursor thereof and optionally a monomeric unit derived from a polyol, wherein the monomeric unit derived from a polyol is present in a molar ratio of 0, 0.1, 0.15, 0.20, 0.25, 0.30, 0.35, 0.40, 0.45, 0.50, 0.55, 0.60, 0.65, 0.70, 0.75, or 0.80 relative to the combined amount of monomeric unit derived from a polyol and the monomeric unit comprising a zwitterion or precursor thereof.

Another aspect of the disclosure provides a filter device including a filter, the filter having a surface morphology and a pore size distribution, the filter comprising a porous membrane support having a surface morphology and a pore size distribution; and a zwitterionic polyurethane or pre-polymer thereof, wherein the porous membrane support includes a layer of the zwitterionic polyurethane or pre-polymer thereof on a surface of the porous membrane support; and wherein the surface morphology and pore size distribution of the filter is substantially similar to the surface morphology and the pore size distribution of the porous membrane support prior to the addition of the zwitterionic polyurethane or pre-polymer thereof.

Another aspect of the disclosure provides a method of preparing a plasma separation device comprising the steps of: assembling a device with a blood inlet and a plasma outlet, providing an anti-fouling membrane disposed between the blood inlet and the plasma outlet; wherein the anti-fouling membrane comprises a zwitterionic polyurethane or pre-polymer thereof.

Another aspect of the disclosure provides a zwitterionic polyurethane membrane configured to separate plasma from a blood sample, comprising a porous membrane support having a surface morphology and a pore size distribution; and a zwitterionic polyurethane or pre-polymer thereof, wherein the porous membrane support includes a layer of the zwitterionic polyurethane or pre-polymer thereof on a surface of the porous membrane support to provide a zwitterionic polyurethane membrane, wherein the zwitterionic polyurethane membrane has a pore size distribution in a range of about 20 nm to about 5 μm, about 50 nm to about 4.5 μm, about 75 nm to about 4 μm, about 100 nm to about 3.5 μm, about 250 nm to about 3.0 μm, about 500 nm to about 2.5 μm, about 750 nm to about 2 μm, or about 1 μm.

Another aspect of the disclosure provides a method of separating plasma from whole blood, comprising providing whole blood to a plasma separation device of the disclosure and allowing the plasma from the whole blood to filter from the blood inlet through the membrane to the plasma outlet.

Exemplary devices herein can be configured such that the blood inlet and plasma outlet can collect between 0.01 and 30 ml's or more of a blood sample, if desired. Other configurations wherein smaller or larger sample sizes are processed are contemplated as well.

Exemplary devices herein can comprise a membrane comprising a zwitterionic polyurethane or pre-polymer thereof on a surface of a suitable membrane support, such as a porous cellulose acetate (CA) membrane, for example. In some embodiments, a surface morphology and a pore size distribution of the membrane are substantially similar to that of the membrane support, prior to the introduction of the zwitterionic polyurethane or prepolymer thereof.

Some membranes can comprise a mean pore size (0.421±0.013 μm) similar to that of a pristine CA membrane (0.421±0.021 μm).

An exemplary plasma separation device herein can comprise a zwitterionic polyurethane surface coating disposed on a membrane surface, and configured to combine many water molecules to form a dense hydration shell via electrostatic interactions, wherein the hydration shell serves as an effective barrier to prevent the membrane surface from directly contacting a protein such as fibrinogen, thus inhibiting the adsorption of the fibrinogen and blood cells.

An exemplary method of manufacturing a plasma separation device can comprise the steps of: assembling a device with a blood inlet and plasma outlet; providing a membrane therein between such that plasma collected via the device can filter through the membrane; and, vacuuming a plasma chamber operably connected to the plasma outlet with an external pump, if desired.

Additionally, exemplary membranes configured to separate plasma from a blood sample, wherein the membrane is functionalized to facilitate substantially cell-free filtering of the plasma from the blood sample, are set forth herein.

The membranes can be integrally formed in a blood separation device.

Exemplary membranes can comprise a zwitterionic PCBU surface coating as an anti-fouling layer when filtering plasma from a blood sample.

### BRIEF DESCRIPTION OF THE DRAWINGS

FIG. 1 shows the digital image of zwitterionic polyurethanes of the disclosure and non-zwitterionic polyurethanes not of the disclosure under dry state and after equilibration in water for 2 days. Left to right: PCB-PTHF-0 (not of the disclosure), PCB-PTHF-25, PCB-PTHF-50, PCB-PTHF-75, and PCB-PTHF-100.

FIG. 2a shows the protein adsorption on surfaces of zwitterionic polyurethanes of the disclosure and control materials after incubation in pH-8.5 PBS buffer for different lengths of time. Commercially available API-PU and PEG-PTHFU-50 were used as control materials.

FIG. 2b shows the protein adsorption on surfaces of zwitterionic polyurethanes of the disclosure and control materials after incubation in water for different lengths of time. Commercially available API-PU and PEG-PTHFU-50 were used as control materials.

FIG. 3 shows cell attachment on control polymer (API-PU, PCB-PTHF-0) and zwitterionic polyurethanes of the disclosure (PCB-PTHF-25, PCB-PTHF-50, PCB-PTHF-75, and PCB-PTHF-100); little to no attachment of cells were observed on the surfaces of the zwitterionic polyurethanes of the disclosure after incubation at 37° C. for 24 hours.

FIG. 4. shows the cell density on control polymers (API-PU, PEG-PTHFU-50) and zwitterionic polyurethanes of the disclosure (PCB-PTHF-75, PCB-PTHF-100) during repeated exposure to a high-concentration bacterial suspension and drying.

FIG. 5 shows fluorescence images of biofilm formation of P. aeruginosa PAO1 on hydrolyzed zwitterionic polyurethanes of the disclosure and commercially available API-PU and PEG-PTHFU-50 control polymers.

FIG. 6 shows fluorescence images of biofilm formation of P. aeruginosa PAO1 on unhydrolyzed zwitterionic polyurethane pre-polymers of the disclosure and commercially available API-PU and PEG-PTHFU-50 control polymers.

FIG. 7a shows AFM images and height profile analyses of a pristine cellulose acetate membrane not of the disclosure.

FIG. 7b shows AFM images and height profile analyses of a cellulose acetate porous membrane support coated on surfaces and in pores with a 5 wt % solution of a zwitterionic polyurethane for 15 minutes.

FIG. 7c shows AFM images and height profile analyses of a cellulose acetate porous membrane support coated on surfaces and in pores with a 5 wt % solution of a zwitterionic polyurethane for 10 minutes.

FIG. 7d shows AFM images and height profile analyses of a cellulose acetate porous membrane support coated on surfaces and in pores with a 5 wt % solution of a zwitterionic polyurethane for 5 minutes.

FIG. 7e shows AFM images and height profile analyses of a cellulose acetate porous membrane support coated on surfaces and in pores with a 2.5 wt % solution of a zwitterionic polyurethane for 15 minutes.

FIG. 8a shows a TGA analysis of the membranes of FIG. 7a-7e.

FIG. 8b shows a chart of the coating weight of the coated membranes of FIG. 7b-7e.

FIG. 8c shows PBS buffer solution permeability of the membranes of FIG. 7a-7e.

FIG. 8d shows plasma permeability (porcine blood) of the membranes of FIG. 7a-7e.

FIG. 9a is a schematic drawing of a prototype vacutainer of the disclosure.

FIG. 9b is a photo of a prototype vacutainer of the disclosure.

FIG. 9c is a photo of the prototype vacutainer during porcine blood filter testing, where the bottom chamber shows the collected blood plasma.

FIG. 9d shows a photo and optical microscope image of porcine whole blood including blood cells.

FIG. 9e shows a photo and optical microscope image of the collected plasma showing no blood cells present.

FIG. 10a shows the rate of plasma separation from undiluted blood by a pristine cellulose acetate membrane not of the disclosure and a zwitterionic polyurethane coated cellulose acetate membrane of the disclosure.

FIG. 10b shows virus recovery from spiked blood: including the spiked blood as a reference, using conventional centrifugation, the pristine cellulose acetate membrane (CA0.8), and the coated cellulose acetate membrane of the disclosure (PCBU-CA0.8).

FIG. 10c is pictures of the plate assay analysis of the virus recovery from the coated cellulose acetate membrane of the disclosure with the spiked blood for reference.

FIG. 11 is a schematic drawing of a device of the disclosure for the separation of plasma from whole blood including a blood inlet loaded with whole blood, a plasma outlet including collected plasma separated from the whole blood, and an antifouling membrane of the disclosure therebetween.

FIG. 12a shows a synthetic route of preparing diethyleneamine ethyl acetate.

FIG. 12b shows a synthetic route of preparing poly(diethyleneamine ethyl acetate)-co-poly(1,6-diisocyanatohexane) and its hydrolytic reaction in water.

FIG. 12c is a schematic representation of the coating of poly(diethyleneamine ethyl acetate)-co-poly(1,6-diisocyanatohexane) on cellulose acetate membrane for antifouling membrane surface.

FIG. 13a is an FT-IR spectra of cellulose acetate (CA) membrane, PCBU, hydrolyzed PCBU, PCBU-CA membrane, and hydrolyzed PCBU-CA membrane.

FIG. 13b shows the FT-IR spectra over a narrow scan region, 1400-1700 cm-1, the signature bending at 1540 nm indicates the existence of a PCBU layer on the surface of the PCBU-CA membrane.

FIG. 13c shows the TGA of the CA membrane, PCBU, hydrolyzed PCBU, PCBU-CA membrane, and hydrolyzed PCBU-CA membrane.

FIG. 13d shows the DTG of the CA membrane, PCBU, hydrolyzed PCBU, PCBU-CA membrane, and hydrolyzed PCBU-CA membrane.

FIG. 14a shows the tapping mode AFM of the surface of a pristine CA membrane.

FIG. 14b shows the tapping mode AFM of a PCBU-CA membrane, no substantial difference was found on the surface morphology after membrane coating, relative to the AFM of the surface of the pristine CA membrane in FIG. 14a.

FIG. 14c. shows the pore size comparison of the CA and PCBU-CA membranes.

The pore size of PCBU-CA membrane shows no significant change compared with CA membrane.

FIG. 14d shows fibrinogen adsorption on a neat CA film, PCBU-CA film surface, and PCBU surface. PCBU-CA film shows decreased protein adsorption.

FIG. 15a shows an Illustration of the plasma separation process. Blood cells are rejected by the ultralow fouling membrane while proteins and other biomarkers are allowed to pass.

FIG. 15b shows a sequence of photographs representing the plasma separation process.

FIG. 15c shows the rate of plasma separation from undiluted whole blood by a functionalized membrane at different pressure differences.

FIG. 15d shows the rate of plasma separation from undiluted blood by a pristine CA membrane and PCBU-CA membrane.

FIG. 15e shows the rate of plasma separation from 1:1 diluted blood by a pristine CA membrane and PCBU-CA membrane. The error bars correspond to the separated plasma volume obtained in three different experiments.

FIG. 15f shows optical microscopy images for comparison of the surface of a pristine CA membrane (upper) and PCBU-CA membrane (bottom) after plasma separation. The pristine CA membrane exhibited significant blood cell adsorption while the functionalized membrane showed no cell attachment. (Blood cells are stained and emit green light.

FIG. 16a is a photograph (upper left), optical microscopy image (bottom), and AFM image (upper right) of whole blood before loading.

FIG. 16b is a photograph (upper left), optical microscopy image (bottom), and AFM image (upper right) of collected plasma permeate. The plasma permeate reveals a lack of blood cells.

FIG. 16c is a spectrophotometer scanning of lysed blood, centrifuged plasma, and plasma separated at different vacuum pressures. Hemolysis level is represented by the absorbance at 540 and 574 nm.

FIG. 16d shows the albumin recovery ratio of filtrated plasma from undiluted and 1:1 diluted porcine blood. The albumin recovery from all filtered plasma is higher than 84%, taking centrifuged plasma as a reference.

FIG. 17 is a schematic representation of a plasma filtering device of the disclosure including a blood inlet chamber, two sealing rings, a membrane, and a plasma outlet chamber.

FIG. 18a is a SEM image of a pristine cellulose acetate (CA) membrane with a photo insert of the membrane.

FIG. 18b is a SEM image of a PCBU-CA membrane with a photo insert of the membrane.

FIG. 19a is an AFM image of the surface of a pristine CA membrane after plasma separation, showing substantial cell absorption.

FIG. 19b is an AFM image of the surface of a PCBU-CA membrane after plasma separation, showing a clean surface with limited platelet attachment.

### DETAILED DESCRIPTION

In accordance with the principles herein, an ultralow-fouling membrane based on zwitterionic polyurethane or pre-polymers thereof for the development of a rapid vacutainer plasma separation device with a high yield is set forth. An exemplary zwitterionic polyurethane-coated membrane herein enables low specific adsorption of blood cells and the rapid separation of plasma from whole blood without a significant loss of membrane flux. The stability of the zwitterionic coating on a cellulose acetate membrane surface has now been characterized by thermogravimetric analysis (TGA) and Fourier-transform infrared spectroscopy (FT-IR). The surface fibrinogen adsorption has also measured by a fluorescent method. The low surface fouling observed for this membrane enables rapid, continuous separation of plasma from whole blood.

In accordance with embodiments, a plasma separation device comprising a blood inlet and a plasma outlet, wherein the blood inlet includes an inlet tunnel configured for loading a whole blood sample and a first chamber configured for collecting the whole blood sample, the plasma outlet comprising a second chamber for collecting plasma separated from the whole blood, the device including a membrane disposed between the blood inlet and the plasma outlet configured for separating the plasma from the whole blood, the membrane including a zwitterionic polyurethane or pre-polymer thereof, wherein the zwitterionic polyurethane or pre-polymer thereof comprises a monomeric unit comprising a zwitterion or precursor thereof and optionally a monomeric unit derived from a polyol. As used herein, and as described in detail, below, a zwitterionic polyurethane is a polymer including urethane linkages and also includes zwitterionic monomeric units wherein in each zwitterionic monomeric unit one ion of the zwitterion is in the polymer backbone and the second ion is on a branch. The zwitterionic units in the polyurethane are generally prepared by hydrolyzing a polymer including a zwitterionic precursor monomer unit. This polyurethane including the zwitterionic precursor monomer unit is referred to herein as a “pre-polymer” and is the unhydrolyzed version of the zwitterionic polyurethane. As used herein, the term “zPU” is used as shorthand for the zwitterionic polyurethane and pre-polymers thereof.

The zwitterionic polyurethane polymer having anti-fouling and antimicrobial properties, as well as tunable mechanical properties, can be a polymer having a backbone including a monomeric unit comprising a zwitterion or precursor thereof and optionally a monomeric unit derived from a polyol, a diol, or a combination thereof. As is well understood in the art, a polymer is the reaction product of a plurality of monomers (e.g. diols, polyols, isocyanates, etc.) such that a polymer includes a plurality of monomeric units resulting from the reaction of those monomers. Consistent with this understanding, as used herein, the term “derived from” means that the monomeric unit is formed from the polymerization of the indicated monomer. For example, a monomeric unit derived from glycerol,

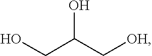

can have a structure in a polymer of

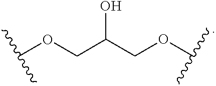 [SMILES: *OCC(O)CO*]

Polymers can include multiple distinct monomeric units resulting from the polymerization of different monomers. In embodiments, the zwitterionic precursor monomeric unit includes a secondary or tertiary amine, wherein the secondary or tertiary amine is within the polymer backbone.

Advantageously, the zwitterionic polyurethane polymers of the membranes of the disclosure provide improved anti-fouling and antimicrobial properties and have tunable mechanical properties. Furthermore, these polymers do not require subsequent, postprocessing functionalization to provide the polymer with the zwitterionic unit. Rather, the pre-polymer including the zwitterionic precursor monomeric unit can be hydrolyzed in an aqueous solution to provide the polymer with its zwitterionic properties, providing cost, time, and processability savings. Moreover, and advantageously, the hydrolysis of the polymers of the disclosure does not require a strong base, such as NaOH, and in some cases, can be carried out in deoionized water. As demonstrated in the examples below, the hydrolysis of the polymers can also advantageously be carried out by an aqueous medium as part of the use of a device including the polymer, forming the anti-fouling layer in situ during use of the device and even in the presence of fouling materials.

The anti-fouling membranes of the disclosure and devices containing same can provide one or more advantages, including, but not limited to (a) high thermal stability relative to commercially available thermoplastic polyurethanes, (b) an ultra-low fouling of less than 5 ng/cm² of fibrinogen adsorption on the surface of the membrane, (c) a high plasma flux of greater than 0.1 mL/min of plasma flux without the use of an external driving force, (d) mechanical stability of the membrane, including the ability to prepare free-standing membranes that have structural stability to handle and assemble into a device, while maintaining flexibility, and combinations thereof.

### Membrane

### Membrane Support

In general, the membrane of the devices of the disclosure include a porous membrane support and a zPU. In some embodiments, the membrane will not include a membrane support and will consist of only the zPU, for example, as a self-supporting porous film or hydrogel, or as a woven or nonwoven material prepared from fibers of the zPU.

The membrane can be provided in any shape or configuration suitable for the device and end use. In general, the membrane is a three dimensional material that has at least one surface. The membrane can have multiple distinct surfaces (e.g., a sheet or disc shape having two opposing co-planar faces, or a cube having six facial surfaces) or a single continuous surface (e.g., a sphere). The membrane is a porous membrane that can allow the diffusion of gases, liquids, or combinations thereof into and through the membrane, wherein the pore size can be selected to allow or prevent materials present in the gases and liquids to pass through the membrane.

In embodiments, the porous membrane support has a pore size in a range of about 20 nm to about 5 μm, about 50 nm to about 4.5 μm, about 75 nm to about 4 μm, about 100 nm to about 3.5 μm, about 250 nm to about 3.0 μm, about 500 nm to about 2.5 μm, about 750 nm to about 2 μm, or about 1 μm. In embodiments, at least 90% of the pores of the porous membrane support have a size in a range of about 100 nm to about 1 μm. In general, the porous membrane support has a surface morphology. In embodiments, the membrane has a surface morphology and a pore size distribution and the surface morphology and pore size distribution of the membrane is substantially similar to a surface morphology and a pore size distribution of the porous membrane support prior to the addition of the zwitterionic polyurethane or pre-polymer thereof. As used herein and unless specified otherwise, the membrane has a “substantially similar” morphology as the porous membrane support when the surface of the membrane appears to have the same porosity and pore size as the porous membrane support by AFM. As used herein and unless specified otherwise, the pore size distribution of the membrane is “substantially similar” to the pore size distribution of the porous membrane support when the pore size distribution of the membrane is within 20% of the pore size distribution of the porous membrane support prior to application of the zwitterionic polyurethane or prepolymer thereof. In embodiments, the difference of the pore size distribution of the membrane relative to the porous membrane support prior to application of the zwitterionic polyurethane or pre-polymer thereof, is 20% or less, 15% or less, 10% or less, 5% or less, 3% or less, or 1% or less. In embodiments, the membrane has a pore size distribution in a range of a range of about 20 nm to about 5 μm, about 50 nm to about 4.5 μm, about 75 nm to about 4 μm, about 100 nm to about 3.5 μm, about 250 nm to about 3.0 μm, about 500 nm to about 2.5 μm, about 750 nm to about 2 μm, or about 1 μm. In embodiments, at least 90% of the pores of the membrane have a size in a range of about 100 nm to about 1 μm. The pore size of the membrane can generally be selected to allow some materials to pass through the membrane, while preventing other materials from passing through. For example, for a plasma separation device of the disclosure, the pore size should be small enough to prevent blood cells from passing through the membrane, but large enough to have a high plasma flux through the membrane without the need to apply an external driving force.

In general, the porous membrane support can be any material suitable for supporting the zwitterionic polyurethane. In embodiments, the porous membrane support comprises a thermoplastic polymer, a glassy polymer, or a combination thereof. In embodiments, the porous membrane support comprises cellulose, cellulose acetate, polysulfone, polycarbonate, polyethersulfone, polypropylene, polylactic acid, polyvinylidene fluoride, nylon, glass fiber, mixed cellulose esters, polyacrylonitrile, polyether ether ketone, polyester, polytetrafluoroethylene, or a combination thereof. In embodiments, the porous membrane support comprises a cellulose acetate.

In some embodiments, the zwitterionic polyurethane can be provided on a surface of the porous membrane support, for example, as a layer on one or more surfaces of the porous membrane support. In some embodiments, the zwitterionic polyurethane covers substantially all surfaces and pore walls of the porous membrane support. As used herein, and unless specified otherwise, the zwitterionic polyurethane covers “substantially all” surfaces and pore walls of the porous membrane support when the zwitterionic polyurethane covers at least 75% of the surfaces and pore walls of the porous membrane support. In embodiments, the zwitterionic polyurethane covers at least 80% to about 100% of the surfaces and pore walls of the porous membrane support. In embodiments, the zwitterionic polyurethane covers at least 80%, at least 85%, at least 90%, at least 95%, at least 98%, or at least 99% of the surfaces and pore walls of the porous membrane support.

### Zwitterionic Polyurethane

In general, the zwitterionic polyurethane and pre-polymer thereof (zPUs) are polymers comprising soft segments that provide elasticity to the polymer and hard segments that provide mechanical stability to the polymer. The zPUs of the disclosure comprise a monomeric unit comprising a zwitterion or precursor thereof and optionally a monomeric unit derived from a polyol, diol, or combination thereof. In embodiments, the zPU further includes a monomeric unit derived from an isocyanate.

In general, the zwitterionic polyurethane has a molecular weight of about 1000 Da to about 10,000,000 Da. In embodiments, the polymer has a molecular weight of about 1000 Da to about 10,000,000 Da, about 5000 Da to about 5,000,000 Da, about 5000 Da to about 1,000,000 Da, about 10,000 Da to about 1,000,000 Da, about 10,000 Da to about 500,000 Da, about 50,000 Da to about 500,000 Da, or about 100,000 Da to about 250,000 Da, for example about 1000, 2000, 3000, 4000, 5000, 6000, 7000, 8000, 9000, 10,000, 15,000, 20,000, 25,000, 30,000, 35,000, 40,000, 45,000, 50,000, 60,000, 70,000, 80,000, 90,000, 100,000, 120,000, 140,000, 160,000, 180,000, 200,000, 250,000, 300,000, 350,000, 400,000, 450,000, 500,000, 600,000, 700,000, 800,000, 900,000, 1,000,000, 1,500,000, 2,000,000, 2,500,000, 3,000,000, 4,000,000, 5,000,000, 6,000,000, 7,000,000, 8,000,000, 9,000,000, or 10,000,000 Da.

In embodiments, the polymer includes a hydrogel. In embodiments, the polyurethane composition includes an elastomer.

In embodiments, the polymer is non-degradable. In embodiments, the polymer is biodegradable. As used herein, the term “non-degradable” should be understood, as it is conventionally used, to mean that under the typical conditions to which the polymer is subjected to in use or by natural processes, the polymer does not degrade or does not substantially degrade over time. For example, a non-degradable polymer can be used to form a medical device, such as a plasma filter, that, when inserted into a plasma filter device, will not degrade or will not substantially degrade over the lifetime of the device. As used herein, “biodegradable,” should be understood, as it is conventionally used, to mean that the polymer is capable of being degraded under the typical conditions to which the polymer is subjected and broken down into natural material. The rate of degradation will depend on the various tunable properties of the polymer, such as, but not limited to, the monomeric units and the molecular weight.

Suitable zwitterionic polyurethanes and pre-polymers thereof are disclosed in US Patent Application Publication No. 2021/0163657, the entire disclosure of which is hereby incorporated by reference.

In embodiments, the zwitterionic polyurethane comprises a polycarboxylbetaine urethane (PCBU). In embodiments, the zwitterionic polyurethane can include one or more zwitterionic units or zwitterionic precursor units and one or more monomeric units derived from a polyol and/or diol. In embodiments, The zwitterionic polyurethane can include one or more zwitterionic units or zwitterionic precursor units and one or more monomeric units derived from a polyol.

In embodiments, the zPU includes a monomeric unit is derived from an isocyanate. The isocyanate can include a diisocyanate and/or a polyisocyanate. Examples of suitable isocyanates include, but are not limited to, isocyanate, isocyanate PEG, 4,4-methylenebis(phenyl isocyanate), 4,4-methylenebis(cyclohexyl isocyanate), 4,4′-oxybis(phenyl isocyanate), 3arm-PEG-isocyanate, 4arm-PEG-isocyanate, bis(4-isocyanatophenyl) methane, 4,4′-methylenebis(2-chlorophenyl isocyanate), 3,3′-dichloro-4,4′-diisocyanato-1,1′-biphenyl, hexamethylene diisocyanate (HDI), 1,4-phenylene diisocyanate, 1,3-phenylene diisocyanate, m-xylylene diisocyanate, tolylene-2,4-diisocyanate, tolylene-2,6-diisocyanate, poly(hexamethylene diisocyanate), trans-1,4-cyclohexylene diisocyanate, 4-chloro-6-methyl-1,3-phenylene diisocyanate, 1,4-diisocyanatobutane, 1,8-diisocyanatooctane, 1,3-bis(1-isocyanato-I-methylethyl)benzene, 3,3′-dimethyl-4,4′-biphenylene diisocyanate, 1,12-diisocyanatododecane, polyisocyanate, or any combination thereof. In some cases, the isocyanate includes hexamethylene diisocyanate (HDI).

In embodiments, the zPU includes a monomeric unit is derived from a diol. In embodiments, the zPU includes a derived from a polyol. The monomeric unit derived from a diol or a polyol can be selected to provide elasticity to the zPU. Examples of suitable diols or polyols include, but are not limited to, poly(ethylene glycol) (PEG), ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, trimethylolpropane, 1,2,6-hexanetriol, triethanolamine, pentaerythritol, glycerol, N,N,N′,N′-tetrakis(2-hydroxypropyl)ethylenediamine, polytetrahydrofuran (PTHF)diol, polytetrahydrofuran (PTHF) triol, polycaprolactone (PCL) diol, polycaprolactone (PCL) triol, polycaprolactone (PCL) polyol, polydimethylsiloxane (PDMS) diol, polydimethylsiloxane (PDMS) triol, polydimethylsiloxane (PDMS) polyol, polyester diol, polyester triol, polylactide (PLA) diol, polylactide (PLA) triol, polypeptides, polyester, polyether, polyamide, octanediol, fluoroalkane polyol, fluoroalkene polyol, fluoroalkyne polyol, alkane polyol, alkene polyol, alkyne polyol, aromatic polyol, poly(vinyl alcohol), polysaccharide, poly(2-hydroxyethyl methacrylate) (pHEMA), poly(2-hydroxyethyl acrylate), poly(N-Hydroxyethyl acrylamide), poly(N-(Hydroxymethyl) acrylamide), poly(N-tris (hydroxymethyl)methylacrylamide), poly((methyl) acrylate) polyol, poly((methyl) acrylamide) polyol, poly(polytetrahydrofuran carbonate) diol, polycarbonate diol, polycarbonate polyol, or any combination thereof. Further, the molecular weight of diol or polyol can be selected to impart improved elasticity to the polymer. For example, as demonstrated in the examples, PTHF 1000 includes longer soft segments that impart elasticity to the polymer. However, if the diol or polyol soft segments are too long, the mechanical strength of the polymer can be compromised.

In embodiments, the polyol monomeric unit is derived from poly(ethylene glycol). The poly(ethylene glycol) can have a molecular weight ranging from about 800 Da to about 10,000 Da, about 800 to about 5000 Da, or about 1000 to about 5000 Da, for example, about 800, 900, 1000, 1250, 1500, 1750, 2000, 2500, 3000, 3500, 4000, 4500, 5000, 6000, 7000, 8000, 9000, or 10,000 Da. The molecular weight of PEG can be selected to impart improved elasticity to the polymer. For example, PEG 2000 includes longer soft segments that impart elasticity to the polymer. However, if the PEG soft segments are too long, the mechanical strength of the polymer can be compromised.

In embodiments, the polyol monomeric unit is derived from polytetrahydrofuran. The polytetrahydrofuran can have a molecular weight ranging from about 500 Da to about 10,000 Da, about 500 to about 5000 Da, or about 1000 to about 5000 Da, for example, about 500, 600, 700, 800, 900, 1000, 1250, 1500, 1750, 2000, 2500, 3000, 3500, 4000, 4500, 5000, 6000, 7000, 8000, 9000, or 10,000 Da. The molecular weight of PTHF can be selected to impart improved elasticity to the polymer. For example, PTHF 1000 includes longer soft segments that impart elasticity to the polymer. However, if the PTHF soft segments are too long, the mechanical strength of the polymer can be compromised.

In embodiments, the zwitterionic polyurethane can include monomers selected from polytetrahydrofuran, 1,6-diisocyanatohexane, and a combination thereof.

The polymers of the disclosure include one or zwitterionic monomeric units or zwitterionic precursor monomeric units. The one or more zwitterionic monomeric units or zwitterionic precursor monomeric unit include at least one ion or ionizable functional group incorporated into the backbone of the polymer. In embodiments, the zwitterionic precursor compound includes a secondary or tertiary amine and the secondary or tertiary amine is within the polymer backbone.

As used herein, the term “zwitterionic precursor monomeric unit” refers to a monomeric unit that is capable of becoming zwitterionic. That is, the monomeric unit includes both a functional group that is capable of holding a positive charge, and a functional group that is capable of holding a negative charge, simultaneously. For example, the polymer having the zwitterionic precursor unit can be hydrolyzed to provide a zwitterionic polymer having a balance of positive and negative charges on various atoms and/or functional groups of the zwitterionic precursor monomeric unit.

In embodiments, the zwitterionic precursor monomeric unit has a structure according to one or more of Formula (A1), (B1), (C1), (D1), and (E1):

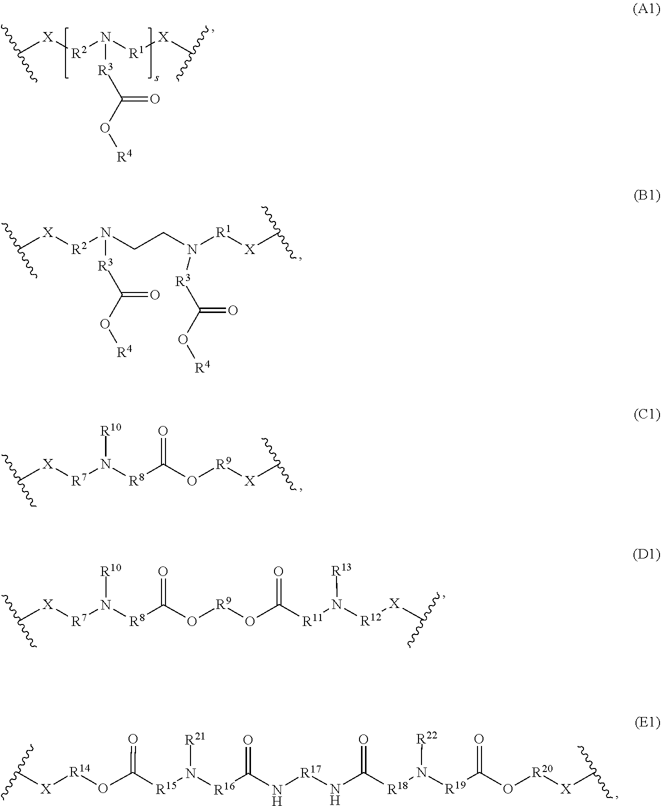

and the zwitterionic monomeric unit can be the hydrolyzed version of one or more of Formula (A1), (B1), (C1), (D1), and (E1).

In embodiments, each X is independently O, NR^{a}, S or Se. In some cases, each X is O. In some cases, each X is NR^{a}. In some cases, each X is S. In some cases, each X is Se. Each X in the zwitterionic precursor unit does not have to be the same as the other X, for example, one X can be O, while the other X is NR^{a}.

In embodiments, each R¹, R², and R³ is independently selected from—(CH₂)ₙ—, —(CH₂)ₙO(CH₂)ₘ—, —(CH₂CH₂OCH₂CH₂)ₙ—, —(CH₂CH₂O)ₙCH₂CH₂—, —((CH₂)₁₋₈C(O)O)ₙ(CH₂)ₘ—, ((CH₂)₁₋₈C(O)O)ₙ(CH₂CH₂O)ₘ(OC(O)(CH₂)₁₋₈)ₚ—, —(CH₂)₁₋₈C(O)O)ₘ(CH₂CH₂)ₘ(OC(O)(CH₂)₁₋₈)ₚ—, —(CH₂C(O)O)ₘ(CH₂CH₂)ₙ(OC(O)CH₂)ₘ—, —(CH(CH₃)C(O)O)ₘ(CH₂CH₂)ₙ(OC(O)CH(CH₃))ₘ—, —(CH(CH₃)C(O)O)ₘ(CH₂CH₂)ₙ(OC(O)CH(CH₃))ₘ—; —((CH₂)ₙOC(O)O)(CH₂CH₂)ₘ, —(CH₂)ₙNHC(O)(CH₂)ₘ—, and —(CH₂)ₙC(O)NH(CH₂)ₘ—.

In embodiments, each R^{a} and R⁴ is independently selected from—H, —(CH₂CH₂O)ₙCH₃, —(CH₂CH₂O), (CH₂)ₘCH₃, —(CH₂CH₂O)ₙ(CH₂)ₘOH, —((CH₂)ₙO)ₘ((CH₂)PO)_{q}(CH₂)ᵣOH, —(CH₂CH₂O)ₙH, —(CH₂)ₙOH, —(CH₂)ₙO(CH₂)ₘOH, —(CH₂CH₂OCH₂CH₂)ₙOH, —(CH₂CH₂O)ₙCH₂CH₂OH, —((CH₂)₁₋₈C(O)O)ₙ(CH₂)ₘOH, —((CH₂)₁₋₈C(O)O)ₙ(CH₂CH₂O)ₘ(OC(O)(CH₂)₁₋₈)pOH, —(CH₂)₁₋₈C(O)O)ₙ(CH₂CH₂)ₘ(OC(O)(CH₂)₁₋₈)ₘOH, —(CH₂C(O)O)ₙ(CH₂CH₂)ₘ(OC(O)CH₂)ₚOH, —(CH(CH₃) C(O)O)ₙ(CH₂CH₂)ₘ(OC(O)CH(CH₃))pOH, —((CH₂)ₙOC(O)O)(CH₂CH₂)ₘOH, —(CH₂)ₙNHC(O)(CH₂)ₘOH, and —(CH₂)ₙC(O)NH(CH₂)ₘ OH, C₁₋ₙ alkyl, C₁₋ₙ alkenyl, C₁₋ₙ alkynyl, C₆₋₁₀ aryl, and succinimidyl, wherein any one or more H atoms of R^{a} or R⁴ can optionally be replaced with an F atom.

In embodiments, each n, m, p, q, r, and s is independently 1 to 10,000, 1 to 5000, 1 to 2500, 1 to 1000, 1 to 500, 1 to 100, or 1 to 10, for example, 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, 200, 300, 400, 500, 600, 700, 800, 900, 1000, 1250, 1500, 1750, 2000, 2500, 3000, 3500, 4000, 4500, 5000, 6000, 7000, 8000, 9000, or 10,000.

In embodiments, each R⁷, R⁸, R⁹, R¹¹, R¹², R¹⁴, R¹⁵, R¹⁶, R¹⁷, R¹⁸, R¹⁹ and R²⁰ is independently selected from—(CH₂)ₙ—, —((CH₂)ₙO)ₘ((CH₂)PO)_{q}(CH₂)ᵣ—, —(CH₂)ₙO(CH₂)ₘ—, —(CH₂CH₂OCH₂CH₂)ₙ—, —(CH₂CH₂O), CH₂CH₂—, —((CH₂)₁₋₈C(O)O)ₘ(CH₂)ₙ—, —((CH₂)₁₋₈C(O)O)ₘ(CH₂CH₂O), (OC(O)(CH₂)₁₋₈)ₚ—, —(CH₂)₁₋₈C(O)O)ₘ(CH₂CH₂)ₙ(OC(O)(CH₂)₁₋₈)ₚ—, —(CH₂C(O)O)ₘ(CH₂CH₂)ₙ(OC(O)CH₂)ₚ—, —(CH(CH₃) C(O)O)ₘ(CH₂CH₂)ₙ(OC(O)CH(CH₃))ₚ—, —(CH(CH₃) C(O)O)ₘ(CH₂CH₂)ₙ(OC(O)CH(CH₃))ₚ—, —((CH₂)ₙOC(O)O)(CH₂CH₂)ₘ, —(CH₂)ₙNHC(O)(CH₂)ₘ—, and—(CH₂)ₙC(O)NH(CH₂)ₘ.

In embodiments, each R^{a}, R¹⁰, R¹³, R²¹, and R²² is independently-H, —(CH₂CH₂O)ₙCH₃, —(CH₂CH₂O)ₙ(CH₂)ₘCH₃, —(CH₂CH₂O), (CH₂)ₘOH, —((CH₂)ₙO)ₘ((CH₂)PO)_{q}(CH₂)ₙOH, —(CH₂CH₂O)ₙH, —(CH₂)ₙOH, —(CH₂)ₙO(CH₂)ₘOH, —(CH₂CH₂OCH₂CH₂)ₙOH, —(CH₂CH₂O)ₙCH₂CH₂OH, —(CH₂CH₂OCH₂CH₂)ₙOH, —((CH₂)₁₋₈C(O)O)ₙ(CH₂)ₘOH, —((CH₂)₁₋₈C(O)O)ₙ(CH₂CH₂O)ₘ(OC(O)(CH₂)₁₋₈)ₚOH, —((CH₂)₁₋₈C(O)O)ₙ(CH₂CH₂)ₘ(OC(O)(CH₂)₁₋₈)ₚOH, —(CH₂C(O)O)ₙ(CH₂CH₂)ₘ(OC(O)CH₂)ₚOH, —(CH(CH₃) C(O)O)ₙ(CH₂CH₂)ₘ(OC(O)CH(CH₃))ₚOH, —(CH(CH₃) C(O)O)ₙ(CH₂CH₂)ₘ(OC(O)CH(CH₃)ₚOH, —((CH₂)ₙOC(O)O)(CH₂CH₂)ₘOH, —(CH₂)ₙNHC(O)(CH₂)ₘOH, —(CH₂)ₙC(O)NH(CH₂)ₘ OH, C₁₋ₙ alkyl, C₁₋ₙ alkenyl, C₁₋ₙ alkynyl, or C₆₋₁₀ aryl, wherein any one or more H atoms of R^{a}, R¹⁰, R¹³, R²¹, or R²² can optionally be replaced with an F atom.

In embodiments, the polymer backbone includes two or more zwitterionic monomeric units or zwitterionic precursor monomeric units, each of the zwitterionic monomeric units or precursors thereof being independently selected from Formulas (A1), (B1), (C1), (D1), and (E1). For example, a polymer can include a zwitterionic precursor monomeric unit having a structure of Formula (A1) and a zwitterionic precursor monomeric unit having a structure of (B1). The same polymer can also include one or more additional zwitterionic monomeric units or zwitterionic precursor monomeric units selected from any one of Formula (A1), (B1), (C1), (D1), and (E1). Alternatively, or additionally, a polymer can include two or more zwitterionic precursor monomeric units wherein at least two of the zwitterionic precursor monomeric units have a structure of Formula (A1), for example, but include a different selection of X, R¹, R², R³, and R⁴ substituents.

In embodiments, the zwitterionic precursor monomeric unit has a structure:

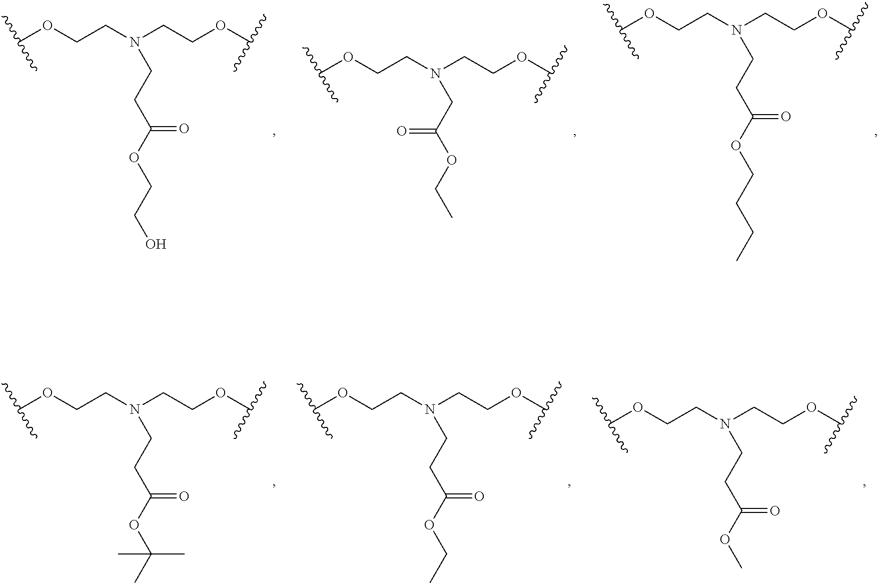 [SMILES: *OCCN(CCO*)CCC(=O)OCCO ; *OCCN(CCO*)CC(=O)OCC ; *OCCN(CCO*)CCC(=O)OCCCC ; *OCCN(CCO*)CCC(=O)OC(C)(C)C ; *OCCN(CCO*)CCC(=O)OCC ; *OCCN(CCO*)CCC(=O)OC]

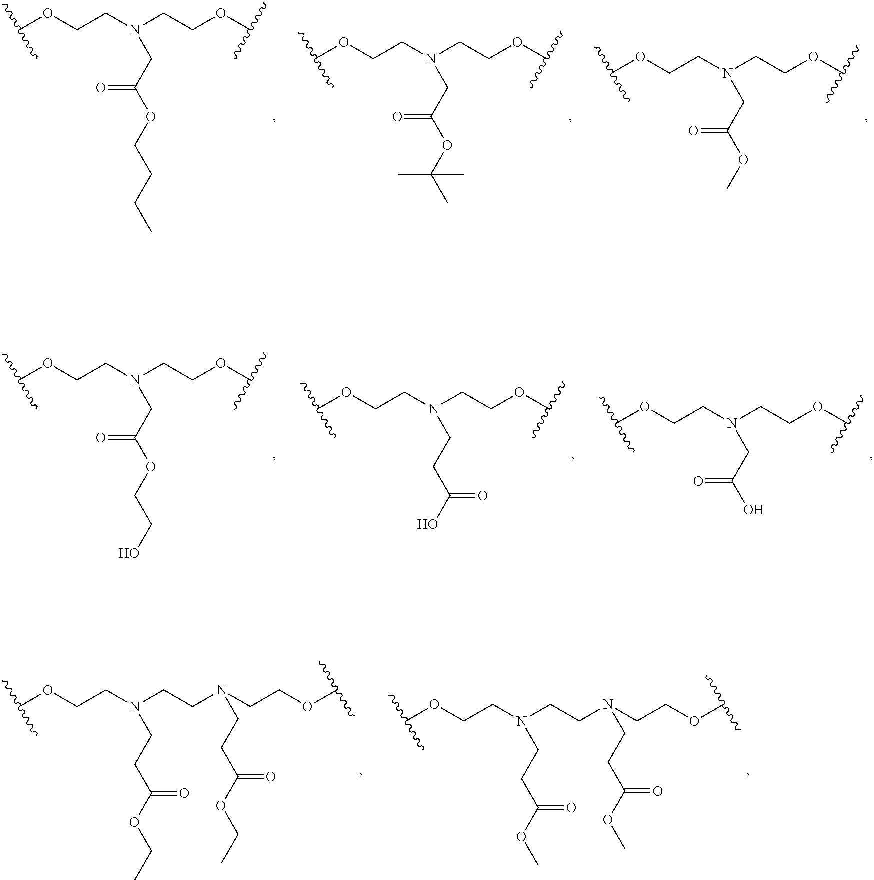

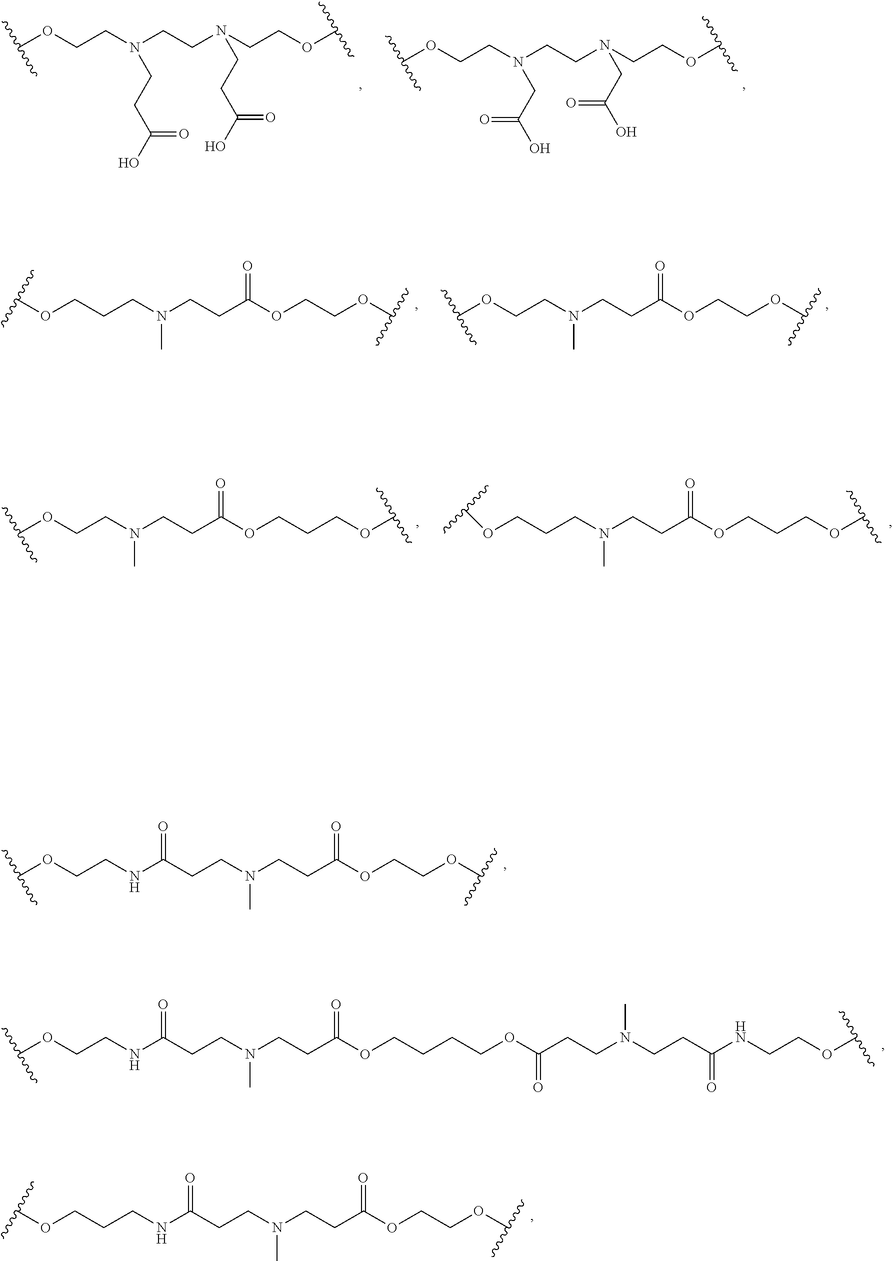

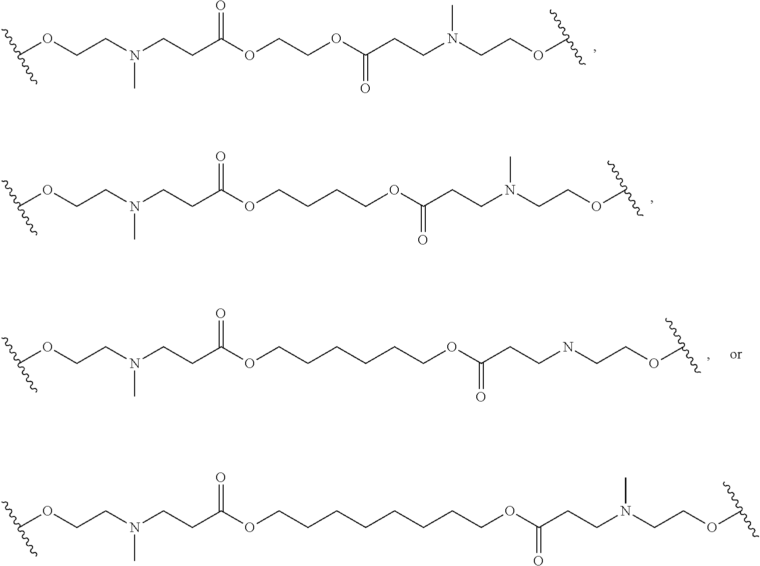 [SMILES: *OCCN(C)CCC(=O)OCCOC(=O)CCN(C)CCO* ; *OCCN(C)CCC(=O)OCCCCOC(=O)CCN(C)CCO* ; *OCCNCCC(=O)OCCCCCCOC(=O)CCN(C)CCO* ; *OCCN(C)CCC(=O)OCCCCCCCCOC(=O)CCN(C)CCO*]

or the zwitterionic polymeric unit can be a hydrolyzed version of any one of the foregoing.

In some cases, the zwitterionic precursor monomeric unit can include crosslinking within a particular monomeric unit and/or between one zwitterionic monomeric unit and other monomeric units of the polymer. For example, in some cases, the zwitterionic precursor monomeric unit has a structure:

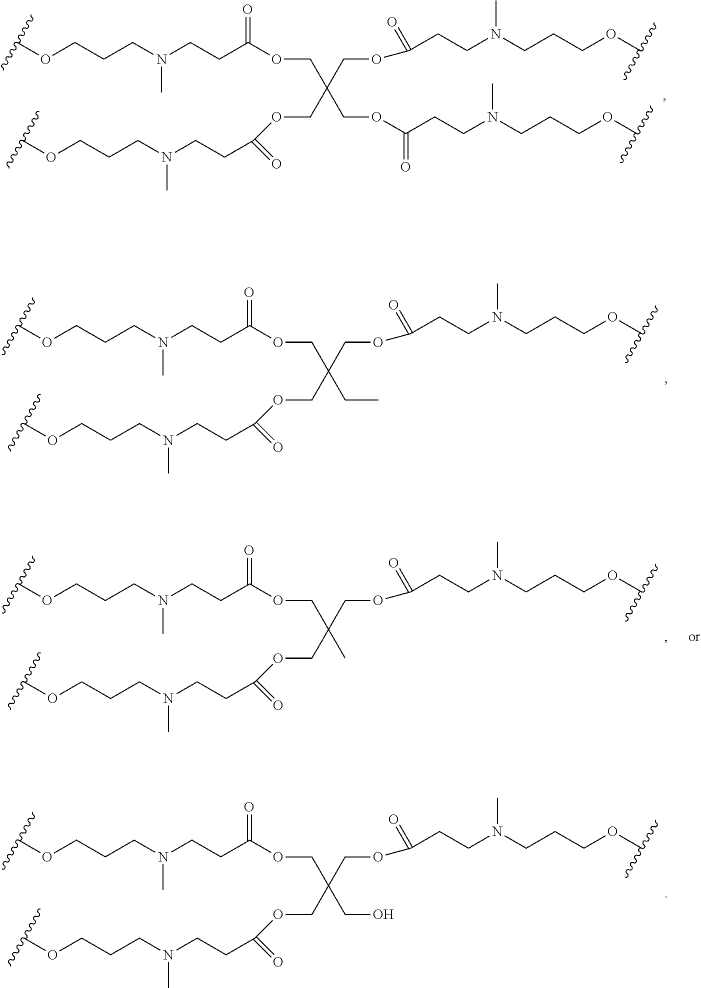 [SMILES: *OCCCN(C)CCC(=O)OCC(COC(=O)CCN(C)CCCO*)(COC(=O)CCN(C)CCCO*)COC(=O)CCN(C)CCCO* ; *OCCCN(C)CCC(=O)OCC(CC)(COC(=O)CCN(C)CCCO*)COC(=O)CCN(C)CCCO* ; *OCCCN(C)CCC(=O)OCC(C)(COC(=O)CCN(C)CCCO*)COC(=O)CCN(C)CCCO* ; *OCCCN(C)CCC(=O)OCC(CO)(COC(=O)CCN(C)CCCO*)COC(=O)CCN(C)CCCO*]

In some cases, the zwitterionic monomeric unit includes a structure of:

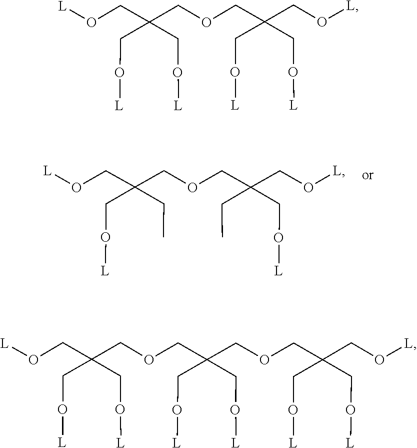

wherein each L has a structure:

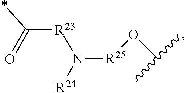

each of R²³ and R²⁵ is independently-(CH₂)ₙ—, —(CH₂)ₙO(CH₂)ₘ—, —(CH₂CH₂OCH₂CH₂)ₙ—, —(CH₂CH₂O)ₙCH₂CH₂—, —((CH₂)₁₋₈C(O)O)ₙ(CH₂)ₘ—, —((CH₂)₁₋₈C(O)O)ₙ(CH₂CH₂O)ₘ(OC(O)(CH₂)₁₋₈)ₚ—; —((CH₂)₁₋₈C(O)O)ₙ(CH₂CH₂)ₘ(OC(O) (CH₂)₁₋₈)ₚ—, —(CH₂C(O)O)ₙ(CH₂CH₂)ₘ(OC(O)CH₂)ₚ—, —(CH(CH₃) C(O)O)ₙ(CH₂CH₂)ₘ(OC(O)CH(CH₃)ₚ—, —(CH(CH₃) C(O)O), (CH₂CH₂)ₘ(OC(O)CH(CH₃)ₚ—, —((CH₂)ₙOC(O)O)(CH₂CH₂)ₘ, —(CH₂)ₙNHC(O)(CH₂)ₘ—, or —(CH₂)ₙC(O)NH(CH₂)ₘ—; and R²⁴ is —H, —(CH₂CH₂O)ₙCH₃, —(CH₂CH₂O)ₙ(CH₂)ₘCH₃, —(CH₂CH₂O)ₙ(CH₂)ₘOH, —((CH₂)ₙO)ₘ((CH₂)PO)_{q}(CH₂)ₙOH, —(CH₂CH₂O)ₙH, —(CH₂)ₙOH, —(CH₂)ₙO(CH₂)ₘOH, —(CH₂CH₂OCH₂CH₂)ₙOH, —(CH₂CH₂O)ₙCH₂CH₂OH, —(CH₂CH₂OCH₂CH₂)ₙOH, —((CH₂)₁₋₈C(O)O)ₙ(CH₂)ₘOH, —(CH₂)₁₋₈C(O)O)ₙ(CH₂CH₂O)ₘ(OC(O)(CH₂)₁₋₈)ₚOH, —((CH₂)₁₋₈C(O)O)ₙ(CH₂CH₂)ₘ(OC(O)(CH₂)₁₋₈)ₚOH, —(CH₂C(O)O)ₙ(CH₂CH₂)ₘ(OC(O)CH₂)ₚOH, —(CH(CH₃) C(O)O)ₙ(CH₂CH₂)ₘ(OC(O)CH(CH₃)ₚOH, —(CH(CH₃) C(O)O)ₙ(CH₂CH₂)ₘ(OC(O)CH(CH₃)ₚOH, —((CH₂)ₙOC(O)O)(CH₂CH₂)ₘOH, —(CH₂)ₙNHC(O)(CH₂)ₘOH, —(CH₂)ₙC(O)NH(CH₂)ₘ OH, C₁₋ₙ alkyl, C₁₋ₙ alkenyl, C₁₋ₙ alkynyl, or C₆₋₁₀ aryl, wherein any one or more H atoms of R²⁴ can optionally be replaced with an F atom; and each n, m, p, q, and r is independently 1 to 10,000.

For example, in embodiments, the zwitterionic monomeric unit includes a structure of

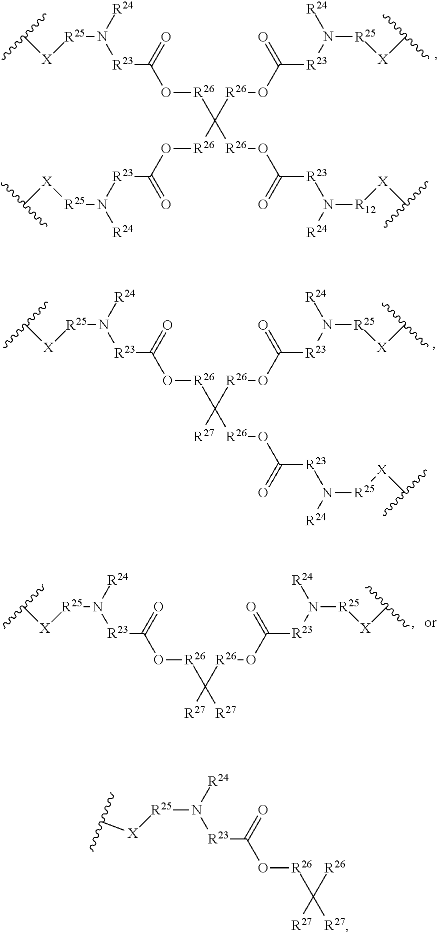

wherein each of X, R²³, R²⁴, and R²⁵ are provided as described above, each R²⁶ is independently-(CH₂)ₙ—, —(CH₂) NO(CH₂)ₘ—, —(CH₂CH₂OCH₂CH₂)ₙ—, —(CH₂CH₂O)ₙCH₂CH₂—, —((CH₂)₁₋₈C(O)O)ₙ(CH₂)ₘ—, —((CH₂)₁₋₈C(O)O)ₙ(CH₂CH₂O)ₘ(OC(O)(CH₂)₁₋₈)ₚ—, —(CH₂)₁₋₈C(O)O)ₙ(CH₂CH₂)ₘ(OC(O)(CH₂)₁₋₈)ₚ—, —(CH₂C(O)O)ₙ(CH₂CH₂)ₘ(OC(O)CH₂)ₚ—, —(CH(CH₃) C(O)O)ₙ(CH₂CH₂)ₘ(OC(O)CH(CH₃))ₚ—, —(CH(CH₃) C(O)O)ₙ(CH₂CH₂)ₘ(OC(O)CH(CH₃))ₚ—, —((CH₂)ₙOC(O)O)(CH₂CH₂)ₘ, —(CH₂)ₙNHC(O)(CH₂)ₘ—, or —(CH₂)ₙC(O)NH(CH₂)ₘ—; and each R²⁷ is —H, —(CH₂CH₂O)ₘCHₚ, —(CH₂CH₂O)ₙ(CH₂)ₘCH₃, —(CH₂CH₂O)ₙ(CH₂)ₘOH, —((CH₂)ₙO)ₘ((CH₂)PO)_{q}(CH₂)ₘOH, —(CH₂CH₂O)ₙH, —(CH₂)ₙOH, —(CH₂)ₙO(CH₂)ₘOH, —(CH₂CH₂OCH₂CH₂)ₙOH, —(CH₂CH₂O)ₙCH₂CH₂OH, —(CH₂CH₂OCH₂CH₂)ₙOH, —((CH₂)₁₋₈C(O)O)ₙ(CH₂)ₘOH, —((CH₂)₁₋₈C(O)O)ₙ(CH₂CH₂O)ₘ(OC(O)(CH₂)₁₋₈)ₚOH, —((CH₂)₁₋₈C(O)O)ₙ(CH₂CH₂)ₘ(OC(O)(CH₂)₁₋₈)ₚOH, —(CH₂C(O)O)ₙ(CH₂CH₂)ₘ(OC(O)CH₂)ₚOH, —(CH(CH₃) C(O)O)ₙ(CH₂CH₂)ₘ(OC(O)CH(CH₃))ₚOH, —(CH(CH₃) C(O)O)ₙ(CH₂CH₂)ₘ(OC(O)CH(CH₃))ₚOH, —((CH₂)ₙOC(O)O)(CH₂CH₂)ₘOH, —(CH₂)ₙNHC(O)(CH₂)ₘOH, —(CH₂)ₙC(O)NH(CH₂)ₘ OH, C₁₋ₙ alkyl, C₁₋ₙ alkenyl, C₁₋ₙ alkynyl, or C₆₋₁₀ aryl, wherein any one or more H atoms of R²⁷ can optionally be replaced with an F atom; and each n, m, p, q, and r is independently 1 to 10,000.

In general, the polyol and/or diol monomeric units can serve as an elastic component that provides the final polymer with elasticity. Thus, as the relative amount of polyol/diol monomer(s) increases, the elasticity of the final polymer generally increases. In general, the zwitterionic monomer(s) can form a strong hydration layer that can provide an effective barrier to prevent foulants from interacting with the polymer surfaces. Without intending to be bound by theory, it is believed that the ionic solvation between the zwitterionic moiety and water molecules can form a hydration layer that strongly resists bacterial attachments on the polymer. Thus as the relative density of the zwitterionic monomer(s) increases, the anti-fouling properties of the final polymer generally increases. When the monomeric unit derived from a polyol and/or diol is included in the zPU, the monomeric unit derived from the polyol and/or diol can be present in a molar ratio of 0, 0.1, 0.15, 0.20, 0.25, 0.30, 0.35, 0.40, 0.45, 0.50, 0.55, 0.60, 0.65, 0.70, 0.75, or 0.80 relative to the combined amount of monomeric unit derived from a polyol and the monomeric unit comprising a zwitterion or precursor thereof. In embodiments, the monomeric unit derived from the polyol and/or diol can be present in a molar ratio of 0, 0.1, 0.15, 0.20, 0.25, 0.30. 0.35, 0.40, 0.45, or 0.50 relative to the combined amount of monomeric unit derived from a polyol and the monomeric unit comprising a zwitterion or precursor thereof. In embodiments, the monomeric unit derived from the polyol and/or diol can be present in a molar ratio of 0, 0.25, or 0.50 relative to the combined amount of monomeric unit derived from a polyol and the monomeric unit comprising a zwitterion or precursor thereof.

As shown in the examples below, the main function of DEAEA is to provide anti-fouling property after the hydrolysis of ester bond that lead to the formation zwitterionic carboxybetaine at the material/solution interface. Thus, because each of the second, zwitterionic precursor monomers, have a similar structure to DEAEA in that, when provided in a copolymer, they can be hydrolyzed to form a zwitterionic group, it is expected that each of the second, zwitterionic precursor monomers will have the same function as DEAEA of providing an anti-fouling property to the polymer. The relative amount of zwitterionic precursor monomer(s) to elastic monomer(s) can be in a range of about 100% (no elastic monomer) to about 25% (i.e., 25 mol % zwitterionic/precursor monomer and 75 mol % elastic monomer).

In embodiments, the zwitterionic polyurethane or pre-polymer thereof comprises a polycarboxybetaine urethane, polycarboxybetaine methacrylate, polycarboxybetaine acrylate, polycarboxybetaine acrylamide, polycarboxybetain methacrylamide, or a combination thereof. In embodiments, the zwitterionic polyurethane or pre-polymer thereof comprises a polycarboxybetaine urethane.

In embodiments, the zwitterionic precursor monomeric unit comprises diethanolamine ethyl acetate, diethanoamino-N-hydroxyl ethyl acetate, or a combination thereof. In embodiments, the zwitterionic polyurethane comprises a zwitterionic monomeric unit derived from diethanolamine ethyl acetate, diethanoamino-N-hydroxyl ethyl acetate, or a combination thereof.

In embodiments the zwitterionic polyurethane is derived from a first monomeric unit comprising polytetrahydrofuran, 1,6-diisocyanatohexane, or a combination thereof, and a second monomeric unit comprising diethanolamine ethyl acetate, diethanoamino-N-Hydroxyl ethyl acetate, or a combination thereof.

In embodiments, the zwitterionic polyurethane comprises hydrolyzed poly((diethanolamine ethyl acetate)-co-poly(1,6-diisocyanatohexane)), hydrolyzed poly((diethanolamine ethyl acetate)-co-poly(tetrahydrofuran)-co-poly( 1,6-diisocyanatohexane)), hydrolyzed poly((diethanoamino-N-hydroxyl ethyl acetate)-co-poly(1,6-diisocyanatohexane)), hydrolyzed poly((diethanoamino-N-hydroxyl ethyl acetate)-co-poly(tetrahydrofuran)-co-poly( 1,6-diisocyanatohexane)), hydrolyzed poly((diethanolamine ethyl acetate)-co-poly(diethanoamino-N-hydroxyl ethyl acetate)-co-poly(1,6-diisocyanatohexane)), hydrolyzed poly((diethanolamine ethyl acetate)-co-poly(diethanoamino-N-hydroxyl ethyl acetate)-co-poly(tetrahydrofuran)-co-poly( 1,6-diisocyanatohexane)), or a combination thereof. In embodiments, the zwitterionic polyurethane pre-polymer comprises poly((diethanolamine ethyl acetate)-co-poly(1,6-diisocyanatohexane)), poly((diethanolamine ethyl acetate)-co-poly(tetrahydrofuran)-co-poly( 1,6-diisocyanatohexane)), poly((diethanoamino-N-hydroxyl ethyl acetate)-co-poly(1,6-diisocyanatohexane)), poly((diethanoamino-N-hydroxyl ethyl acetate)-co-poly(tetrahydrofuran)-co-poly( 1,6-diisocyanatohexane)), poly((diethanolamine ethyl acetate)-co-poly(diethanoamino-N-hydroxyl ethyl acetate)-co-poly(1,6-diisocyanatohexane)), poly((diethanolamine ethyl acetate)-co-poly(diethanoamino-N-hydroxyl ethyl acetate)-co-poly(tetrahydrofuran)-co-poly( 1,6-diisocyanatohexane)), or a combination thereof.

### Additional Monomeric Units

Any of the polymers described herein can be further polymerized with one or more additional monomers and/or polymers to provide copolymers and/or hybrid polymers.

As described above, in embodiments, the polymer backbone further includes one or more additional monomeric units. In some cases, the one or more additional monomeric units are independently selected from Formulas (A1), (B1), (C1), (D1), and (E1), and are different than the second monomeric unit.

In embodiments, the polymer backbone further includes a third monomeric unit derived from one or more of a urethane, urea, amide, ester, imide, and carbonate. That is, the polymer of the disclosure can be copolymerized with any other suitable monomer to provide a copolymer or hybrid polymer. For example, in some cases, the polymer of the disclosure can be copolymerized with an ester monomer and/or a polyester polymer, to provide a copolymer including a first monomeric unit and second monomeric unit, as provided herein, and one or more additional monomeric units derived from the ester or polyester.

In embodiments, the polymer can include a polyurethane. As used herein, “polyurethane” means a polymer composed of, or inclusive of, organic units joined by carbamate (—OC(O)NH—) links.

### Methods of Making

Suitable methods of preparing zwitterionic polyurethanes and pre-polymers thereof are disclosed in US Patent Application Publication No. 2021/0163657, the entire disclosure of which is hereby incorporated by reference.

In embodiments, the methods include admixing an isocyante with polyol/diol monomers followed by admixing the resulting solution with one or more smonomeric unit precursors that includes one or more zwitterionic precursor compounds to form a pre-polymer solution. The method further includes, in embodiments, exposing the pre-polymer solution to conditions sufficient to initiate polymerization, thereby forming a polymer having a polymer backbone, wherein at least one functional group of the zwitterionic precursor compound is incorporated into the polymer backbone.

In embodiments, the method includes admixing an isocyanate monomer with a zwitterionic precursor monomer to form a pre-polymer solution; and, exposing the pre-polymer solution to conditions sufficient to initiate polymerization, thereby forming a polymer having a polymer backbone, wherein the zwitterionic precursor compound incorporated into the polymer backbone.

The isocyanate can be selected as described in detail, above. In some cases, the isocyanate includes hexamethylene diisocyanate (HDI).

The diol or polyol can be selected as described in detail, above. In embodiments, the diol or polyol includes polytetrahydrofuran (PTHF), and the isocyanate includes HDI.

In embodiments, the diol or polyol, the isocyanate, and the zwitterionic precursor compound are provided in amounts sufficient to provide a polymer having a molar ratio of zwitterionic monomeric unit: diol or polyol: isocyanate ranging from about 0.5:10:1 to about 10:0:1, or about 0.5:5:1 to about 5:0:1 for example, 1:0:1, 0.75:0.25:1, 0.50:0.50:1, or 0.25:75:1. In some cases, the compounds are provided in amounts sufficient to provide a molar ratio selected from 1:0:1, 0.75:0.25:1, 0.50:0.50:1. In some cases, the compounds are provided in amounts sufficient to provide a molar ratio selected from 1:0:1, 0.75:0.25:1.

In embodiments, the zwitterionic precursor compound has a structure according to Formula (A2) or (B2):

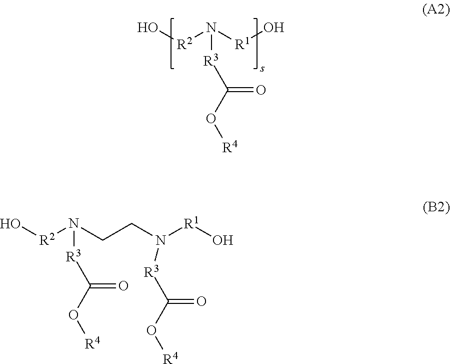

wherein each of R¹, R², R³, R⁴, and s can be independently selected as described, above.

In embodiments, the zwitterionic precursor compound is selected from:

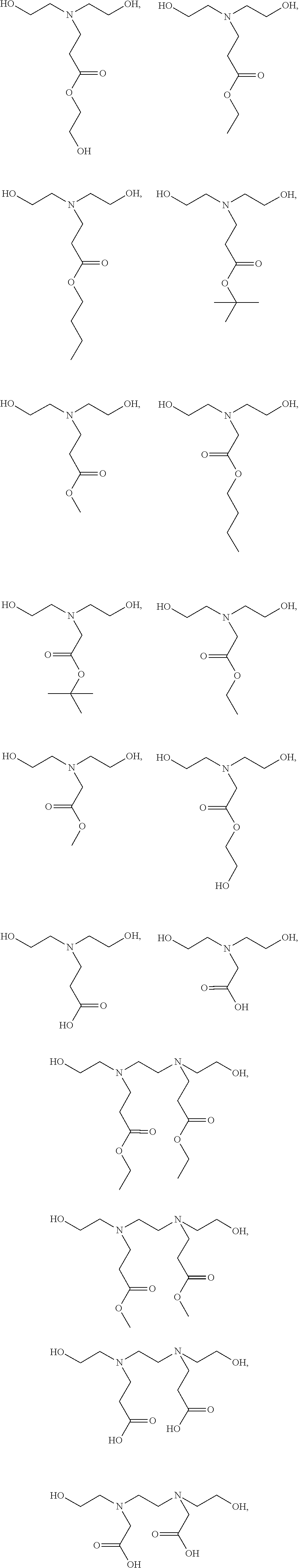

or any combination thereof.

In embodiments, each admixing step can occur at a temperature ranging from about 50° C. to about 100° C., about 60° C. to about 90° C., or about 70° C. to about 80° C., for example about 50, 55, 60, 65, 70, 75, 80, 85, 90, 95 or 100° C.

In some embodiments, each admixing step is substantially free of organic solvent. As used herein, the term “substantially free” means that the solutions suitably contains less than 5%, 4%, 3%, 2%, 1%, 0.5%, 0.1%, or 0.01% of organic solvent, and/or up to about 0.01%, 0.1%, 0.5%, 1%, 2%, 2%, 4%, or 5% organic solvent.

In some embodiments, the admixing steps include an organic solvent. Suitable organic solvents include but are not limited to DMF, DMSO, DCM, chloroform, THF, and/or any combination thereof.

In embodiments wherein two admixing steps occur, both admixing steps can occur in the same reaction vessel.

The exposing step can occur at a temperature ranging from about 20° C. to about 200° C., about 50° C. to about 150° C., or about 75° C. to about 100° C., for example about 20, 30, 40, 50, 60, 70, 80, 90, 100, 110, 120, 130, 140, 150, 160, 170, 180, 190, or 200° C.

In embodiments, the exposing step can occur in the presence of a tertiary amine initiator. One example of a suitable tertiary amine initiator is 1,4-diazabicyclo[2.2.2]octane (DABCO).

In embodiments, the exposing step can occur in the presence of a metallic compound. Examples of suitable metallic compounds include, but are not limited to, dibutyltin dilaurate or bismuth octanoate.

In embodiments, the exposing step can occur in the presence of ultraviolet (UV) light.

The methods described herein can further include hydrolyzing the pre-polymer in an aqueous solution. In embodiments, the aqueous solution includes deionized water. In embodiments, the hydrolyzing occurs at a temperature ranging from about 4° C. to about 99° C., about 5° C. to about 95° C., about 15° C. to about 75° C., about 40° C. to about 60° C., or about 45° C. to about 55° C., for example about 4, 5, 6, 7, 8, 9, 10, 15, 20, 25, 30, 35, 40, 45, 50, 55, 60, 65, 70, 75, 80, 85, 90, 91, 92, 93, 94, 95, 96, 97, 98, or 99° C.

In embodiments, the hydrolyzing can occur at a pH value ranging from about 6 to about 14, about 7 to about 12, or about 9 to about 11, for example about 6, 6.5, 7, 7.5, 8, 8.5, 9, 9.5, 10, 10.5, 11, 11.5, 12, 12.5, 13, 13.5, or 14.

In embodiments, the aqueous solution is substantially free of added base. As used herein, the term “substantially free of added base” means that the aqueous solution suitably contains less than 5%, 4%, 3%, 2%, 1%, 0.5%, 0.1%, or 0.01% of added, and/or up to 0.01%, 0.1%, 0.5%, 1%, 2%, 2%, 4%, or 5% added base. In some cases, the aqueous solution is substantially free of NaOH and/or KOH. Advantageously, hydrolysis of the polymers disclosed herein does not require the use of a strong base, such as NaOH.

In some embodiments, the aqueous solution includes an inorganic or tertiary amine organic base. Bases can optionally be added to the aqueous solution in order to increase the rate of hydrolysis of the pre-polymer.

### Medical Devices

Provided herein are medical devices including the anti-fouling membrane of the disclosure. The polymer can be applied (e.g., coated, covalently coupled, ionically associated, hydrophobically associated) to one or more surfaces of the membrane.

Representative devices that may be advantageously prepared include, but are not limited to: devices for bioprocesses or bioseparations, such as membranes for microbial suspension, hormone separation, protein fractionation, cell separation, waste water treatment, plasma/pathogen separation, hemodialysis, wound dressings, and respiratory/face masks (i.e., filter devices).

### Plasma/Pathogen Separation

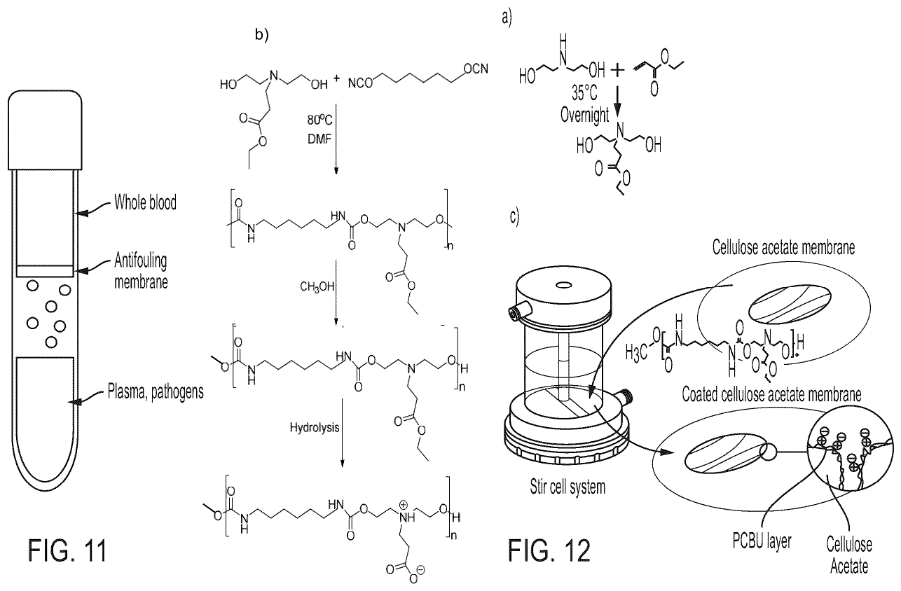

Many clinical tests and diagnostic procedures of infectious diseases require the separation of plasma from whole blood. Currently, nearly all blood samples worldwide are first processed by multi-stage centrifugation, which involves costly large-scale instrumentation, stable high wattage power supply, and experienced operators. In addition, the diagnosis-to-treatment interval is an essential clinical factor for the survival of patients with infectious diseases. Thus, rapid, simple, accurate pathogen diagnostics at the clinic/bedside are critical to effective patient care because they can reduce the cost of care, vastly improve quality of care and enable far better management of antibiotic/antiviral use. zPU membranes with engineered pore size for a rapid plasma separation can make the centrifugation process skipped and allow rapid diagnostic blood tests. Besides, zPU membrane can be directly integrated into the commercial blood collection tube (FIG. 11), including a blood inlet comprising a first chamber for collecting a whole blood sample, a plasma out comprising a second chamber for collecting plasma separated from the whole blood, and a membrane of the disclosure provided therebetween. By using the blood collection tube integrated with zPU membrane, the interval between diagnosis and treatment will decrease from 12 to 48 hours to less than one hours and faster diagnosis and treatment will promote a better prognosis among patients with infectious diseases.

In embodiments, the plasma separation device of the disclosure comprises a blood inlet and a plasma outlet, the blood inlet comprising an inlet tunnel configured for loading a whole blood sample and a first chamber configured for collecting the whole blood sample, the plasma outlet comprising a second chamber for collecting plasma separated from the whole blood, the device comprising an anti-fouling membrane of the disclosure disposed between the blood inlet and the plasma outlet configured for separating the plasma from the whole blood.

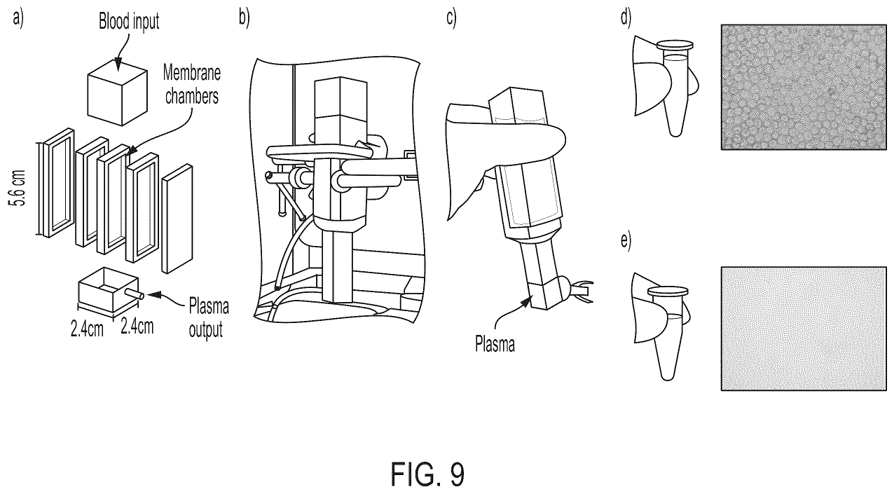

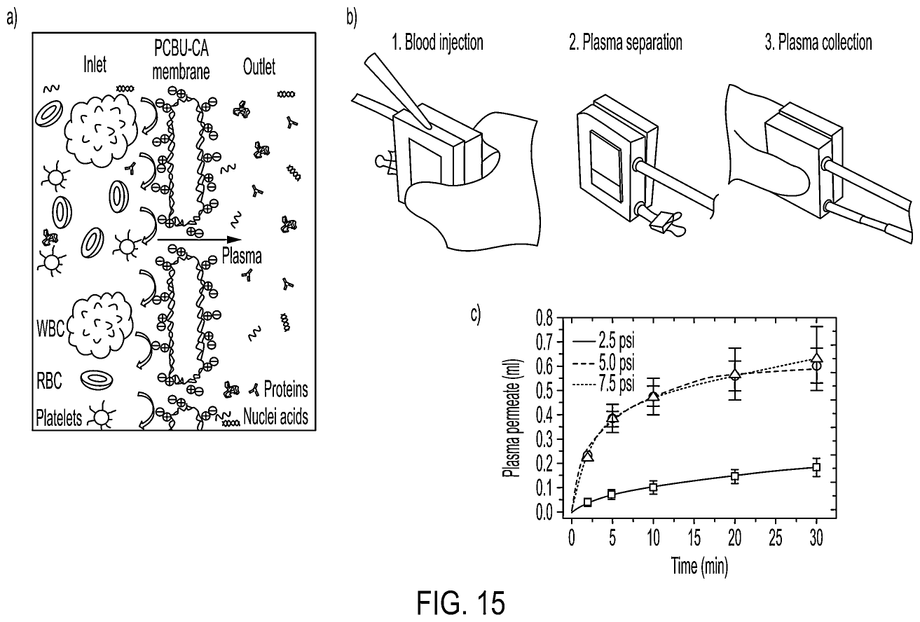

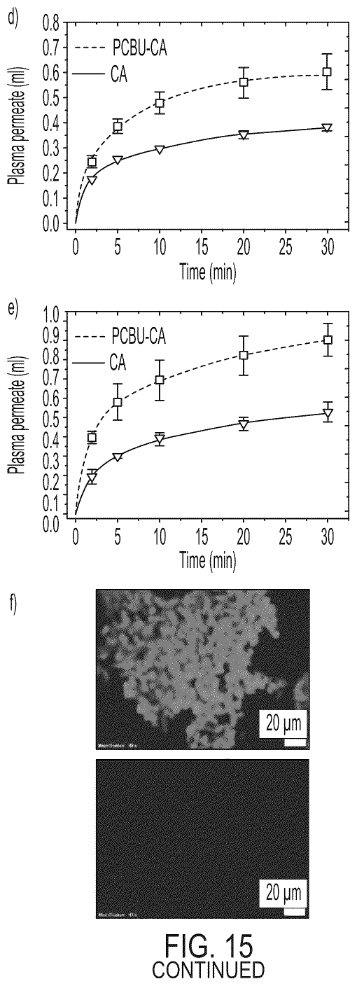

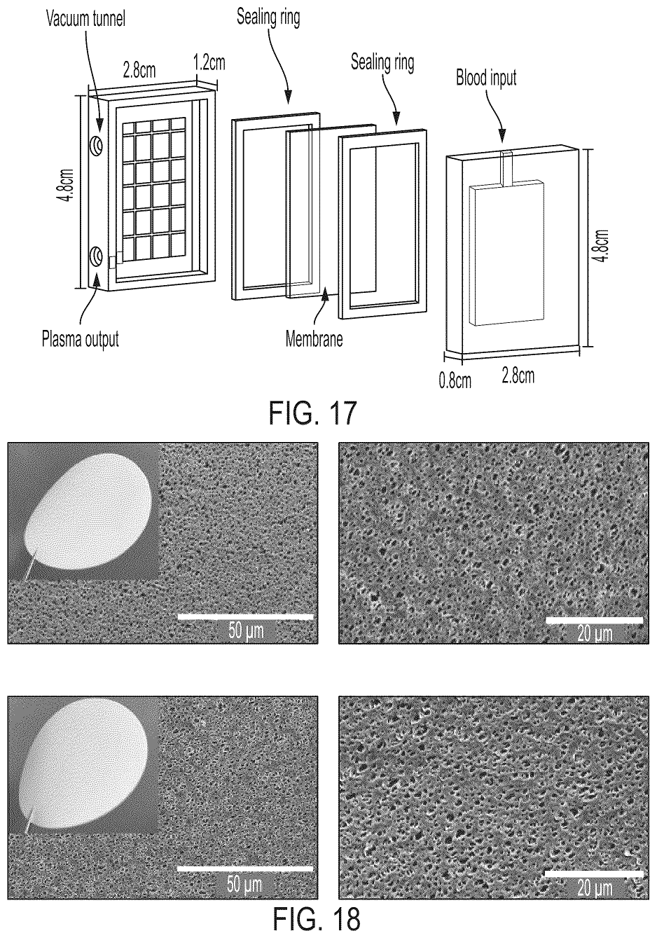

In general the blood inlet can be any structure comprising an inlet tunnel and chamber for holding the whole blood sample. The inlet tunnel can be any opening configured to introduce whole blood into the first chamber. As shown in FIGS. 15 and 17, the inlet tunnel can have a tube like configuration. Alternatively, as shown in FIGS. 9 and 11 the inlet tunnel can simply be a hole that can be used to provide blood into the first chamber, for example, by injecting, transferring, and the like. The first chamber can have any configuration provided it is in fluid communication with the anti-fouling membrane and will hold the whole blood sample as well as what is left of the whole blood after the plasma passes through the membrane.

In general, the volume of the first chamber for loading/holding the whole blood is not particularly limiting. From a practical standpoint, the first chamber should have a sufficient volume to load a volume of whole blood sufficient to provide a meaningful amount of plasma. The size of the first chamber may be selected based on whether the plasma separation device is for use where a sample may need to be filtered while being transported from a collection site to a testing site. Alternatively, where the testing site and collecting site are the same, the plasma separation device may be considered a stationary device that can collect and filter larger volumes of whole blood. In embodiments, the first chamber can have a capacity for a volume of the whole blood sample in a range of about 0.001 to about 1000 mL, about 0.001 to about 750 mL, about 0.01 to about 500 mL, about 0.01 to about 250 mL, about 0.01 to about 100 mL, about 0.01 to about 75 mL, about 0.01 to about 50 mL, about 0.01 to about 25 mL, about 0.01 to about 20 mL, about 0.05 to about 20 mL, about 0.10 to about 18 mL, about 0.25 to about 16 mL, about 0.5 to about 15 mL, about 0.75 to about 10 mL, or about 1 to about 5 mL. In embodiments, the first chamber can have a capacity for a volume of the whole blood sample in a range of about 0.01 to about 75 mL, about 0.01 to about 50 mL, about 0.01 to about 25 mL, about 0.01 to about 20 mL, about 0.05 to about 20 mL, about 0.10 to about 18 mL, about 0.25 to about 16 mL, about 0.5 to about 15 mL, about 0.75 to about 10 mL, or about 1 to about 5 mL. In embodiments, the first chamber can have a capacity for a volume of the whole blood sample in a range of about 0.01 to about 20 mL, about 0.05 to about 20 mL, about 0.10 to about 18 mL, about 0.25 to about 16 mL, about 0.5 to about 15 mL, about 0.75 to about 10 mL, or about 1 to about 5 mL.

In general, the plasma outlet can have any structure comprising a second chamber for collecting plasma separated from the whole blood. For example, as shown in FIG. 11, the plasma outlet can take the form of the bottom portion of a vile, test tube, or the like. Optionally, the plasma outlet can be configured to be removed from the device once the plasma is tested such that the plasma in the plasma outlet can be transported as needed, without transporting the entire device. Optionally, the plasma outlet can include an outlet tunnel to allow the plasma to be removed from the device. The second chamber can have any configuration provided it is in fluid communication with the anti-fouling membrane.

Optionally, the plasma separation device can further include a vacuuming plasma chamber operably associated with the plasma outlet. The vacuuming plasma chamber allows the separation of plasma under negative pressure. Negative pressure can be applied in any suitable range, for example in a range of about −0.1 psi to about −10 psi. In embodiments, negative pressure can be applied in a range of about −0.01 to about −5 psi. Without intending to be bound by theory, it is believed that there is a critical threshold pressure at which, beyond the critical pressure, the pressure becomes sufficient to produce a gel layer of blood cells on the membrane surface, which can limit the plasma flux through the membrane. As demonstrated in the examples below, for the exemplified membrane, the threshold pressure was around-5 psi.

The anti-fouling membrane can be any of the membranes of the disclosure. In embodiments, the membrane has a biofilm surface coverage of less than 50%, less than 40%, less than 30%, less than 20%, less than 10%, less than 5%, or less than 1%, after exposure to P. aeruginosa for three weeks when tested in accordance with the Biofilm Formation Test. In embodiments, the membrane has a biofilm surface coverage of less than 25%, less than 20%, less than 10%, less than 5%, or less than 1%, after exposure to P. aeruginosa for three weeks when tested in accordance with the Biofilm Formation Test. In embodiments, the membrane has a biofilm surface coverage of less than 10%, less than 5%, or less than 1%, after exposure to P. aeruginosa for three weeks when tested in accordance with the Biofilm Formation Test.

In embodiments, the membrane comprises less than 5 ng/cm², for example, less than 4 ng/cm², or less than 3 ng/cm² of fibrinogen adsorbed on the membrane surface, when tested in accordance with the Protein Adsorption Test. In embodiments, the membrane comprises less than 3 ng/cm² of fibrinogen adsorbed on the membrane surface, when tested in accordance with the Protein Adsorption Test. In embodiments, the membrane has a biofilm surface coverage of less than 10%, less than 5%, or less than 1%, after exposure to P. aeruginosa for three weeks when tested in accordance with the Biofilm Formation Test and less than 5 ng/cm², for example, less than 4 ng/cm², or less than 3 ng/cm² of fibrinogen adsorbed on the membrane surface, when tested in accordance with the Protein Adsorption Test.

In embodiments, the membrane has a flux of at least about 0.05 mL/min, at least about 0.075 mL/min, at least about 0.1 mL/min, at least about 0.25 mL/min, or at least about 0.40 mL/min without application of an external driving force. In embodiments, the membrane has a flux of at least about 0.1 mL/min, at least about 0.25 mL/min, or at least about 0.40 mL/min without application of an external driving force. In embodiments, the membrane has a biofilm surface coverage of less than 10%, less than 5%, or less than 1%, after exposure to P. aeruginosa for three weeks when tested in accordance with the Biofilm Formation Test, less than 5 ng/cm², for example, less than 4 ng/cm², or less than 3 ng/cm² of fibrinogen adsorbed on the membrane surface, when tested in accordance with the Protein Adsorption Test, and the membrane has a flux of at least about 0.1 mL/min without application of an external driving force.

In embodiments, less than about 2%, less than about 1%, or less than about 0.05% by volume of non-plasma components of the whole blood pass through the membrane. In embodiments, less than about 1% or less than about 0.05% by volume of non-plasma components of the whole blood pass through the membrane.

The plasma separation device of the disclosure can generally be prepared by assembling a device with a blood inlet and a plasma outlet, providing a membrane disposed between the blood inlet and the plasma outlet, wherein the membrane comprising any of the anti-fouling membranes of the disclosure. In embodiments, the method further comprises preparing the membrane comprising applying a zwitterionic polyurethane pre-polymer to a porous membrane. Applying the zwitterionic polyurethane pre-polymer to the porous membrane support comprises dip coating, spray coating, grafting, spin coating, surface coating, immersion precipitation, or a combination thereof. Optionally, the method can further comprise hydrolyzing the zwitterionic polyurethane pre-polymer to form the zwitterionic polyurethane.

The disclosure further provides a zwitterionic polyurethane membrane configured to separate plasma from a blood sample comprising any of the anti-fouling membranes provided herein, wherein the zwitterionic polyurethane membrane is porous and the size of the pores is selected to be small enough to prevent blood cells from permeating the membrane but large enough to provide a plasma flux of at least about 0.1 mL/min without the application of an external driving force such as a vacuum.

The disclosure further provides a method of separating plasma from whole blood, comprising providing whole blood to the plasma separation device of the disclosure and allowing the plasma from the whole blood to filter from the blood inlet through the membrane to the plasma outlet. Optionally, the method can include applying negative pressure in the plasma outlet. In embodiments, the negative pressure can be applied in a range of about −0.1 to −10 psi, for example, about −0.1 to about −0.5 psi.

### Protective Fabric/Mask Material

zPU membrane can serve as a multifunctional respirator filter or protective fabrics with high breathability, capturing and killing viral particles, and self-cleaning capabilities, a combination of features that current respirator and medical mask filters (e.g., N95) cannot provide. Although the electrostatic attraction between the oppositely charged N95 filter and viral particles is strong enough to effectively exclude the particles, the conventional respirator filters lose their breathability and dislodge the captured viral particles over high loading of viral particles and exposure to water. The zPU membrane with antimicrobial functionality can not only catch and kill the negatively charged pathogens but also the filter can be regenerated using the mild basic solution, so the mask can be easily regenerated and be reused.

Thus, the disclosure provides a filter device comprising a filter, the filter having a surface morphology and a pore size distribution, the filter comprising a porous membrane support having a surface morphology and a pore size distribution and a zwitterionic polyurethane or pre-polymer thereof, wherein the porous membrane support includes a layer of the zwitterionic polyurethane or pre-polymer thereof on a surface of the porous membrane support; and wherein the surface morphology and pore size distribution of the filter is substantially similar to the surface morphology and the pore size distribution of the porous membrane support prior to the addition of the zwitterionic polyurethane or pre-polymer thereof.

The porous membrane support can be selected from any porous membrane supports disclosed herein. The zwitterionic polyurethane or pre-polymer thereof can include any zPU disclosed herein. In embodiments, the zPU can cover substantially all surfaces and pore walls of the porous membrane support. In embodiments, the porous membrane support comprises an N95 filter.

### Hemodialysis

The fouling issue caused by the deposition of proteins on the membrane surface is a critical and long-standing challenge with the current hemodialyzers. Ultralow fouling properties of zPU membrane can advance the performance of hemodialysis membranes with greatly enhanced blood compatibility and antifouling performance against the adsorption of blood cells.

### Wound Dressing

Skin and soft tissue infections caused by microbial invasion can be treated by maintaining an antimicrobial environment over the wounded tissue. The zPU membrane with antimicrobial functionality can be used in wound dressing applications because it can provide antimicrobial properties, anti-fouling, adequate mechanical strength, high flexibility properties, cell viability, good barrier properties, and oxygen permeability. These excellent properties of zPU can be employed in fabricating PU membranes for tissue protection, prevention of water loss from a wound during the healing process, and easy detachment from the wounded site without further damage to newly formed tissue.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compounds, compositions, articles, methods, and processes are described as including components, steps, or materials, it is contemplated that the compositions, processes, or apparatus can also comprise, consist essentially of, or consist of, any combination of the recited components or materials, unless described otherwise. Combinations of components are contemplated to include homogeneous and/or heterogeneous mixtures, as would be understood by a person of ordinary skill in the art in view of the foregoing disclosure, and following examples.

### EXAMPLES

### Materials

Diethanolamine, 2-hydroxyethyl acrylate, ethyl acrylate and fluorescein isothiocyanate isomer 1 were purchase from Alfa Aeser (Haverhill, MA). Polyethylene glycol (PEG) 2000, glycerol, bovine serum albumin (BSA) was purchase from Sigma Aldrich (St. Louis, MO, USA). 1,6-Diisocyanatohexane (HDI) was purchased from Acros Organics (Pittsburgh, PA, USA). Dimethylformamide (DMF) was purchased from EMD Millipore (Burlington, MA, USA). Viability/cytotoxicity assay kit for bacteria live and dead cells was purchased from Biotium (Fremont, CA, USA). Commercial biomedical polyurethane materials were obtained from API company. (Mussolente, VI, Italy).

### Instrumentation and Methods

### Fourier Transform Infrared Spectroscopy (FTIR)

Fourier transform infrared spectroscopy (FTIR) analysis was recorded on a Nexus 870 spectrometer (Thermo Nicolet, USA) with an attenuated total reflection (ATR) mode. The wavenumber ranges from 400 to 4000 cm-1 with between 32 and 64 total scans, at a spectral resolution of 4 cm⁻¹.

### Thermogravimetric Analysis (TGA)

Thermogravimetric analysis (TGA) (PerkinElmer, USA) was used to study the thermal stability of the materials. The temperature ranges from 50 to 800° C. with a heating rate of 5° C./min with continuous in an air atmosphere. The temperature was held at 110° C. for 180 minutes to remove any moisture.

### Differential Scanning Calorimetry (DSC)

Differential scanning calorimetry (DSC) (TA Instruments, USA) was performed for all the materials to measure the phase transition. 7 mg of sample was loaded into a Tzero aluminum pan or equivalent. The heating and cooling rates were 10° C./min° C. was employed with continuous N₂ flow of 50 ml/min. The samples were heated from room temperature (about 20-25° C.) to 180° C. and then cooled to −90° C. The heating/cooling behavior was analyzed from −90 C to 180° C.

### Hydrolysis Process Monitoring by pH Change

Each sample (8 mm in diameter and 2 mm in thickness) were immerged into DI water. The pH value was recorded every 5 min in first 30 min, every hour in the first day, and then every day for 10-15 days.

### Swelling Ratio Measurement

For swelling ratio studies, samples with different compositions were made 8 mm in diameter and 2 mm in height. After swelling equilibrium in ultrapure water for two weeks. After the samples were taken out of the DI water, the surface water was removed entirely by a paper towel (Kimwipres). The samples were weighed and lyophilized prior, and the dried samples were weighed again. The swelling ratio, Q, was calculated using the following equation.

$$Q = ( {M}_{S} - {M}_{D} ) / {M}_{D}$$

where M_{S} is the mass after swelling, M_{D} is the mass after lyophilizing.

### Mechanical Testing

The Stress-Strain curves of samples were evaluated with a Shimadzu EZ-Test Compact Bench Testing Machine (Shimadzu Corporation, Nakagyo-ku, Kyoto, Japan). Each kind of material (about 8 mm in diameter and 2 mm in thickness for both before and after hydrolysis sample) were compressed to failure at rate of 1 mm/min with a 5000 N load cell. The Young's modulus was obtained from the linear portion of the compression strain-stress curve. For the tensile test, each material was cut to a dumbbell-shaped specimen with a gauze length of 55 mm and a guage width of 5 mm. The specimen was stretched to breakage at a 500 mm min⁻¹ stretching speed.

### Protein Adsorption

The adsorption of protein hydrogels was determined by Enzyme-Linked Immunosorbent Assay (ELISA). Samples were cut into discs with a biophysical punch (8 mm in diameter and 2 mm thick), washed thoroughly with DI water, equilibrated in PBS buffer for 20 min, and transferred into a sterile 24-well flat-bottom polystyrene plate. 1 mL FITC-labeled human fibrinogen (FITC-Fg)_solution (1 mg/mL) was added into each well. All samples were immersed in the solution for 30 minutes to allow protein adsorption. To remove loosely adsorbed proteins/excess dye solution on sample surfaces, hydrogel samples were rinsed with PBS three times. The samples were then transferred to a glass slide and visualized with an Olympus IX81 fluorescent microscope (Olympus, Japan) with 20× objective lens through FITC filter at a fixed exposure time (200 ms) for all samples, so the different protein adsorption will lead to different fluorescent intensity on images. Ten images at different spots were taken for the surface of each sample. ImageJ software was used to quantify the fluorescent intensity of each sample.

### Mammalian Cell Attachment

After samples were equilibrated in deionized water for 14 days, stearilized by ultraviolet radiation for 30 minutes, and placed in a 24-well tissue-culture coated flat-bottomed polystyrene plate, NIH-3T3 cells were seeded on different hydrogel substrates at 10×10⁵ cells/well with serum medium consisting of 89% Dulbecco's Modified Eagle's Medium (DMEM), 10% fetal bovine serum (FBS), and 1% penicillin-streptomycin. The samples were kept in an incubator with 5% CO₂ at 37° C. for 24 hours to allow cell attachment. Samples were then transferred to a glass slide by a sterile tweezer. The surface cell coverage was visualized with the same fluorescence microscope with 10× to 60× objective lens through FITC filters. Ten images at different spots were taken for the surface of each sample. The surface cell density was calculated by ImageJ software.

### Bacterial Attachment

Samples were fully hydrolyzed by equilibrating in DI water for 14 days, dried at room temperature for 24 h, and sterilized by UV radiation for 30 min. The dry sample discs were then soaked in DI water for 30 min. Pseudomonas aeruginosa PAO1 was washed and dispersed in sterile PBS buffer at a concentration of 5×10⁸ cells per mL. Next, 1 mL of cell suspension was transferred to each well of a 24-well tissue-culture coated flat-bottomed polystyrene plate. In each well, one sample disc was placed at the bottom. Plates were incubated at 37° C. without agitation (static culture) for 3 h. After, the samples were removed by a sterile tweezer and gently rinsed in DI water three times. The sample surface was treated with DMAO dyes and incubated for 30 min at room temperature. After staining, the samples were lifted by a sterile tweezer and gently rinsed in DI water three times. The samples were transferred to a glass slide and analyzed by the Olympus IX91 fluorescent microscope (Olympus, Japan). Ten images at different spots were taken for the surface of each sample, The surface cell density was calculated by the ImageJ software. After these measurements, the same samples were soaked in DI water for 1 h and then dried at room temperature for 24 h. The samples were evaluated seven times by the same cell attachment method described above.

### Biofilm Formation Test

P. aeruginosa PAO1 was washed with sterile PBS and subsequently dispersed in sterile lysogeny broth media at a concentration of 10⁶ cells/ml. Discs of wet hydrolyzed and dry unhydrolyzed polymer samples were sterilized by UV radiation for 30 min and then transferred to a 24-well tissue-culture coated flat-bottomed polystyrene plate with the bacteria suspension. Half of the media was replaced by fresh Luria-Bertani (LB) media each day. The temperature of the system was maintained at 25° C. After a varying length of time, one disc of each material was lifted by a sterile tweezer and gently washed with 0.85 wt % NaCl solution to remove loosely bonded cells. The sample was then treated with DMAO dyes and incubated for 30 min at room temperature. After staining, the sample was lifted by a sterile tweezer and gently rinsed in DI water three times to remove excess dye solution. The samples were then transferred to a glass slide and analyzed with the Olympus IX81 fluorescent microscope (Olympus, Japan). Ten images at different spots were taken for the surface of each sample. The surface biofilm coverage was calculated by ImageJ software.

### Example 1—Synthesis and Evaluation of Zwitterionic Polymer

### Overview

A series of novel zwitterionic polycarboxybetaine urethanes (PCBU) with tunable mechanical swelling properties was synthesized and characterized.

### Synthesis of Diethanolamine Ethyl Acetate (DEAEA)

DEAEA (structure provided below) was synthesized using a Michael-type reaction.

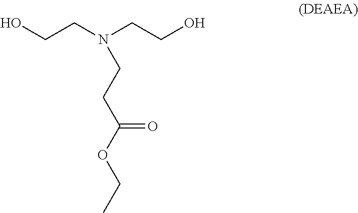

Ethyl acrylate (30.3 g, 0.299 mmol) was added to a round flask in a water bath at 35° C. Diethanolamine (28.6 g, 0.272 mmol) was added to the flask dropwise with stirring. After being allowed to react for about 12 hours, the resulting DEAEA was concentrated in a rotary evaporator at 50° C. for 2 h. The concentrated DEAEA was further purified by flash chromatography using a dichloromethane and methanol mixture (4:1 v/v) as the eluent. The resulting DEAEA was a colorless oil with a 94% yield. The chemical structure of DEAEA was measured by ¹H NMR (400 MHZ, CDCl₃, ppm): 1.17 (t, 3H), 2.39 (t, 2H), 2.54 (t, 4H), 2.76 (t, 2H), 3.510 (t, 4H), 4.04 (m, 2H).

### Synthesis of Diethanoamino-N-Hydroxyl Ethyl Acetate (DEAHA)

DEAHA (structure provided below) was synthesized using a Michael-type reaction.

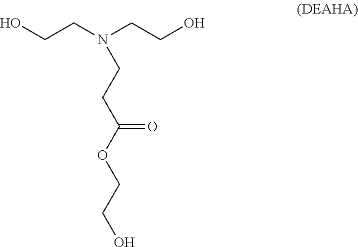 [SMILES: O=C(CCN(CCO)CCO)OCCO]

Diethanolamine (30 g, 0.28 mol) was added into 2-hydroxyethyl acrylate (36.4 g, 0.31 mol). The resulting solution was stirred overnight under 35° C., and kept away from the light during the reaction. The reaction mixture was concentrated in a rotovap and then purified by flash chromatography using a dichloromethanoe and methanol mixture (5:1) as the mobile phase to yield DEAHA. ¹H NMR (400 MHZ, CDCl₃, ppm): 4.03 (t, 2H), 3.59 (t, 2H), 2.67 (t, 2H), 2.35 (t, 2H), 3.42 (m, 4H), 2.44 (m, 4H).

### Synthesis of Polymer

Five polymers with different molar ratios of DEAEA, polytetrahydrofuran (PTHF1000) (Mw 1000 Da), and 1,6-diisocyanatohexane (HDI) ((N_{DEAEA}+N_{PTHF1000}): N_{HDI}=1:1), PCB-PTHF-0, PCB-PTHF-25, PCB-PTHF-50, PCB-PTHF-75, PCB-PTHF-100 were prepared with DEAEA to HDI ratios of 0, 0.25, 0.50, 0.75, and 1, respectively. The polymers were synthesized via a one-pot reaction. The synthesis of the polymers followed the general reaction scheme, below:

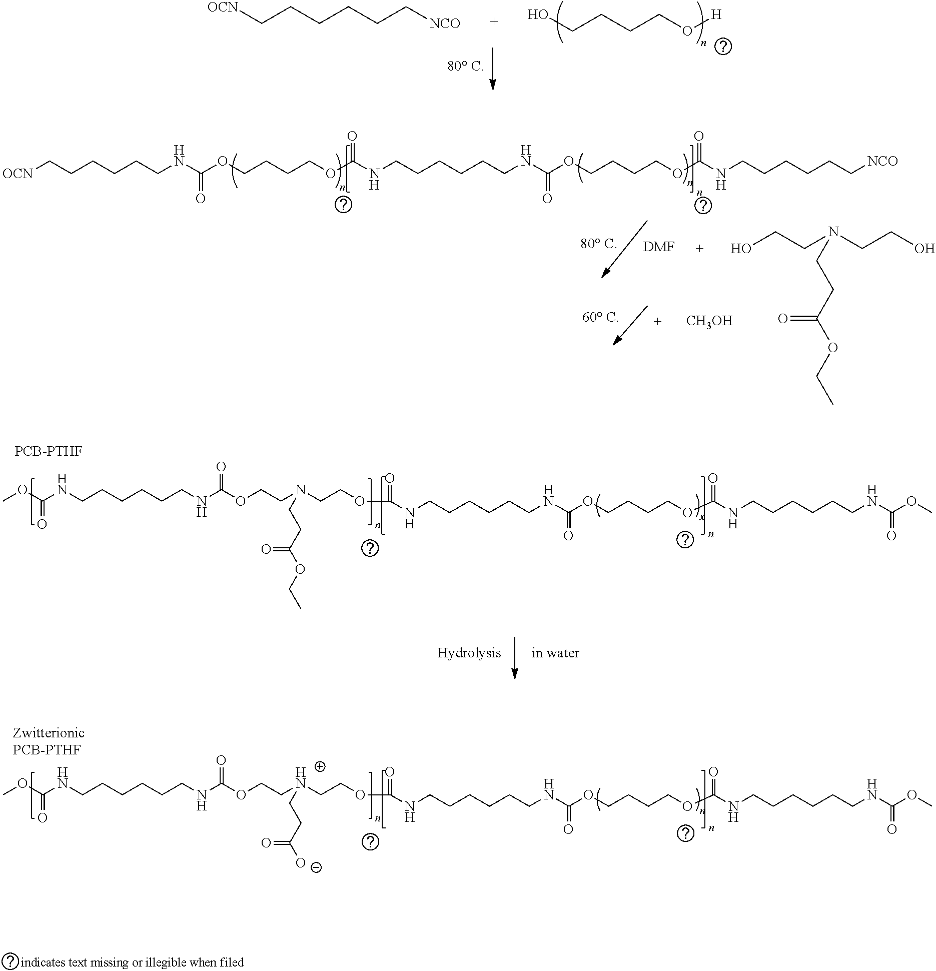

Before the reaction, the PTHF 1000 was placed into vacuum oven at 100° C. for 2 hours for removing moisture. The PTHF 1000 was transferred to a three-necked round bottom flask equipped with a mechanical stirrer and a nitrogen line. When the flask temperature reached a constant 80° C. in an oil bath, HDI was added to the flask dropwise. The mixture reacted at 80° C. under stirring at 400 rpm for 2 h. DEAEA as an extender of the polymer backbone/cross-linker was added dropwise and the mixture reacted at 80° C. under stirring at 400 rpm for 4-24 h, depending on the DEAEA ratios. DMF was added once the viscosity increased. The temperature was then lowered to 60 C and methanol was added as a quencher. After the system reacted at 60° C. for another 0.5 h, the resulting polymers were precipitated in diethyl ether to remove oligomers and unreacted monomers. The purified polymers were transferred to PTFE dishes and dried in a vacuum oven at 100° C. to remove the residual solvent. After drying, flat films could be peeled off from the PTFE dishes. The prepared polymers were submerged into DI water for two days and then dried to prepare hydrolyzed polymers. Poly(PEG-co-PTHF-co-HDI)-50 (PEG-PTHF-50) was also synthesized by the same method with PEG300, PTHF 1000 and HDI (N_{PEG300}: N_{PTHF1000}: N_{HDI}=0.5:0.5:1).

### Analysis

### Synthesis of Polyurethane

PEG has been extensively studied and widely used as the soft segment in PUs to enhance their anti-fouling properties, however, the fouling issues remain unsolved. To address these long-standing fouling issues, DEAEA was designed, which combines crosslinker, hard segment and antifouling functions. The chemical structure of DEAEA was characterized and confirmed by 1H NMR spectroscopy.

The structure and molecular weight of the soft segment, such as a polyol, used in polyurethane synthesis significantly affect the mobility and mechanical properties of a polymer. PTHF 1000 with an average molecular weight of 1000 Da is favorable for preparing polymers with typical rubber elasticity. To develop a highly elastic zwitterionic thermoplastic polyurethane, a thermoplastic polyurethane (TPU) with PTHF1000, DEAEA, and HDI was designed and synthesized. The PTHF1000 serves as an elastic component that provides the material with high elasticity. DEAEA is a multiple-purpose component that acts as a chain extender and an antifouling precursor. DEAEA undergoes self-catalyzed hydrolysis in the aqueous environment. The hydrolyzed DEAEA segment generates a zwitterionic carboxybetaine (CB) group that can provide critical antifouling properties. DEAEA can be synthesized via a simple Michael addition reaction with a high yield.

This study designed five different DEAEA/PTHF1000 (PCB-PTHF-0, PCB-PTHF-25, PCB-PTHF-50, PCB-PTHF-75) and (PCB-PTHF-100) to tune the mechanical properties of the PCB-PTHFs and to study their antifouling properties. As a reference, PEG-PTHF-50 was prepared to compare the behavior of PEG-based material and zwitterionic materials. The number average molecular weight (Mn) is 21, 18, 12, 11, and 3 kDa for PCB-PTHF-0, PCB-PTHF-25, PCB-PTHF-50, PCB-PTHF-75, and PCB-PTHF-100, respectively.

### Fourier Transform Infrared Spectroscopy (FT-IR)

The chemical composition of the PCB-PTHFs and PEG-PTHF-50 was characterized by FT-IR analysis. In the PCB-PTHFs, the—NCO stretching absorbance at 2250-2270 cm⁻¹ is absent, indicating the completion of the reaction and the depletion of all isocyanate groups. Absorption bands for N—H stretching vibrations are observed at 3340 cm-1, and C—H stretching, C═O stretching, C—O—C stretching, and N—H bending are observed at 2920-2860, 1700, 1040-1110, and 1540 cm-1, respectively. The DEAEA to PTHF 1000 ratio was adjusted within PCB-PTHFs. As the DEAEA ratio increased, more C═O, N—H, and C—N bonds occurred in the PCB-PTHF. Meanwhile, PCB-PTHFs with higher PTHF1000 contents show higher C—H bond densities. Thus, the integration of the C—H stretches increases with higher PTHF1000 content, with PCB-PTHF-0 exhibiting the highest level of integration and PCB-PTHF-100 showing the lowest. At the same time, PCB-PTHF-0 displays the weakest signal of the N—H stretch, C═O stretch, N—H bend, and C—N stretch, while PCB-PTHF-100 shows the highest values. The signal change of the N—H stretch, C—O stretch, N—H bend and C—N stretch is consistent with the ratio of DEAEA and PTHF1000 in PCB-PTHFs.

### Thermal Stability and Thermal Transition

The thermostability of TPU is an important factor to consider in a material, as it is closely related to the processing and service temperature window. However, the application of TPU can be limited by the relatively low thermal decomposition temperature of urethane bonds. The thermal decomposition temperature is strongly related to the isocyanate and polyol groups used to synthesize TPU. In this study, PCB-PTHFs were designed with alkyl isocyanate and alkyl polyol, which were found to possess a relatively high degradation temperature among different kinds of TPUs. The thermal stability of PCB-PTHFs was investigated by TGA. The weight loss at 110° C. corresponds to the evaporation of adsorbed water in the samples. Starting from 170° C., PCB-PTHFs follow the typical three-step decomposition process observed for TPU. In the first stage, mass loss occurs as the urethane bonds decompose and form alcohol and isocyanate groups. Subsequently, the isocyanates dimerize and form carbodiimides. Then, relatively stable N-substituted urea is formed by the reaction between alcohol hydroxyl groups and carbodiimides, which prevents complete volatilization of the resulting chain fragments. In the final stage, the N-substituted urea becomes volatile at higher temperatures, resulting in the loss of the remaining mass. PCB-PTHF-0, PCB-PTHF-25, PCB-PTHF-50, PCB-PTHF-75, and PCB-PTHF-100 showed an average weight loss of 30.2% between 170° C. and 300° C. in the first stage, combined with a 69.8% weight loss in the second and third stage from 300° C. to 580° C. PCB-PTHF-0 showed the lowest decomposition temperature among the PCB-PTHFs, presumably due to the absence of DEAEA and thus weaker intermolecular hydrogen bonding. For PCB-PTHF-25, PCB-PTHF-50, PCB-PTHF-75, and PCB-PTHF-100, the temperature at which weight loss begins increased with the PTHF1000 ratio in the polymer. This trend in degradation temperature change has been previously reported, as TPU with a higher soft segment concentration is more thermally stable and exhibits a higher degradation temperature. Overall, the PCB-PTHFs showed high thermal stability comparable to that of commercially available TPUs, which is advantageous for the fabrication and application of the material.

The thermal transition behavior of PCB-PTHFs was analyzed by DSC. Before hydrolyzation, the glass transition temperatures of PCB-PTHF-0, PCB-PTH-25, PCB-PTHF-50, PCB-PTHF-75, and PCB-PTHF-100 were −73.4° C., −67.6° C., −57.3° C., −44.5° C., and −8.0° C., respectively. The glass transition temperature primarily depends on the chain stiffness of the PCB-PTHF. PTHF1000 is a long soft segment in PCB-PTHFs, which increases chain mobility and softness. In comparison, the DEAEA segment is relatively short and stiff. Consequently, the glass transition temperature increases with increasing DEAEA content. The DSC curves of PCB-PTHFs after hydrolyzation are similar to those before hydrolyzation. The glass transition temperature (T_{g}), crystallization temperature (T_{c}), and melting temperature (Tₘ) of hydrolyzed and unhydrolyzed PCB-PTHFUs are summarized in Table 1. There is no significant difference in the T_{g}, T_{c}, and Tₘ values before and after hydrolyzation. As hydrolyzation removes only the end ethanol on the DEAEA side chain, the chain stiffness, regularity, symmetry, and the ability to form hydrogen bonding show slight variation; thus, the T_{g}, T_{c}, and Tₘ values remain unchanged.

TABLE 1

| | Unhydrolyzed | | | Hydrolyzed | | |
|---|---|---|---|---|---|---|
| | T_{g} (° C.) | T_{c} (° C.) | Tₘ (° C.) | T_{g} (° C.) | T_{c} (° C.) | Tₘ (° C.) |
| PCB-PTHF-0 | −73.4 | 8.7 | 40.5 | −70.7 | 6.6 | 41.7 |
| PCB-PTHF-25 | −67.6 | −10.9 | 28.9 | −68.9 | −11.8 | 29.9 |
| PCB-PTHF-50 | −57.3 | | 89.6 | | −57.9 | |
| PCB-PTHF-75 | −44.5 | | 142.6 | | −45.7 | |
| PCB-PTHF-100 | −8.0 | | | | −1.3 | |

The T_{c} of unhydrolyzed PCB-PTHF-0 and PCB-PTHF-25 are 8.7° C. and −10.9° C., respectively, and their Tₘ is 40.5° C. and 28.9° C., respectively. For both hydrolyzed and unhydrolyzed samples, PCB-PTHF-0 crystallized during the cooling process. In contrast, PCB-PTHF-25 did not crystalize during cooling but crystalize during heating. The well-known fact can explain this difference that cold crystallization is more likely to occur than melt crystallization because nucleation is dampened at higher temperatures. The different behaviors observed for the melt crystallization in PCB-PTHF-0 and PCB-PTHF-25 indicate that nucleation is less likely to occur in PCB-PTHF-25. PCB-PTHF-50, PCB-PTHF-75, and PCB-PTHFU-100 show typical DSC curves of amorphous polymers, with no crystallization temperatures or melting temperatures. The above comparison shows that the crystallization capacity decreases with increasing DEAEA content because the DEAEA segment has a lower regularity, symmetry, and softness than the PTHF segment.

### Rheology Testing

The evolution of the storage modulus (G′) and loss modulus (G″) during heating was studied to evaluate the viscoelastic properties of the PCB-PTHFs. PCB-PTHF-0 and PCB-PTHF-25 show corresponding to a semicrystalline thermoplastic polymer. G′ was greater than G″ at low temperature, at which the polymer is solid and in a rubbery state. As the temperature increases above the melting temperature of PCB-PTHF-0 (40.5° C.) and PCB-PTHF-25 (28.9° C.), G′ and G″ undergo a dramatic reduction. After a crossover of G′ and G″, the polymer became a viscoelastic fluid. PCB-PTHF-50 and PCB-PTHF-75 exhibit behavior corresponding to an amorphous thermoplastic polymer. These polymers are in a rubbery state at low temperatures, where G′ is higher than G″. As the temperature increases, both G′ and G″ gradually decrease. However, G′ drops faster than G″. When the temperature exceeds 89.6° C. for PCB-PTHF-50 and 142.6° C. for PCB-PTHF-75, the polymer becomes viscoelastic fluid. A frequency rheological study was conducted at 37° C. to confirm the behavior of the PCB-PTHFUs at the human body temperature. Except for PCB-PTHF-25, whose melting temperature was below 37° C., all PCB-PTHFUs show G′ value higher than G″ within the tested frequency range. The rheological study of PCB-PTHF-50 and PCB-PTHF-75 justifies their application in the fabrication of biomedical devices. Under human body temperature (<37° C.), both polymers are in a rubbery state as a highly elastic stable solid. At higher temperatures that are still below the decomposition temperature, the polymers are a viscoelastic fluid; thus, multiple types of devices can be fabricated by extrusion molding or injection molding.

### Swelling Study

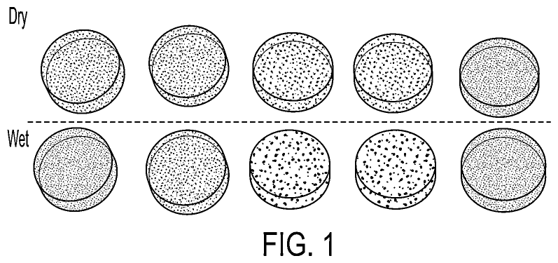

Swelling experiments were also utilized to characterize the water uptake of the polymers incorporating distinct compositions. The swelling ratios of PCB-PTHFs vary with the ratio of DEAEA to PTHF. The water uptake of a material depends on its hydrophilicity, intermolecular interaction, and crosslinking density, including its chemical and physical crosslinking. Without intending to be bound by theory, it is believed that higher hydrophilicity, weaker intermolecular interactions, and lower crosslinking density result in higher water absorption. As shown in Table 2, the swelling ratio of the PCB-PTHFs rises as the ratio of hydrophilic DEAEA increases and the ratio of hydrophobic PTHF decreases. PCB-PTHFU-0, PCB-PTHF-25, PCB-PTHF-50, PCB-PTHF-75, and PCB-PTHF-100 exhibit swelling ratios of 4.7%, 4.8%, 8.5%, 14.2%, and 20.6%, respectively. Compared with the PCB-PTHFs, PEG-PTHF-50 shows a much higher swelling ratio of 23.6%. Although the CB in DEAEA strongly binds water via ionic solvation, the urethane bond density of one DEAEA/HDI repeating unit is much higher than that of PEG/HDI due to the lower molecular weight of DEAEA. The higher urethane bond density leads to stronger overall intermolecular interaction via the hydrogen bond. In addition to the influence of hydrophilicity, the physical crosslinking formed by the crystal region limits the water penetration and swelling. As PCB-PTHF-0 and PCB-PTHF-25 are semicrystalline polymers, both show a low swelling ratio of 5%. Although the PCB-PTHFs have different swelling ratios in water, their dimensions did not change after equilibration in water because, it is believed, the physical crosslinking via the hydrogen bonds among the urethane groups inhibited any swelling or dimensional changes. The optical clarities of PCB-PTHFs are different, as shown in FIG. 1. All PCB-PTHFs with various DEAEA ratios show a translucent color under the dry state. After equilibration in water, the transparency of PCB-PTHFs can change due to the self-segregation of the hydrophobic PTHF domain and the hydrophilic DEAEA domain. As shown in FIG. 1, after two-days equilibration in water, PCB-PTHF-50 and PCB-PTHF-75 become opaque for their comparable ratio of the two domains. For PCB-PTHF-25, although the material contains two domains, the transparency only decreased slightly due to the uneven length of the two domains, the lower water swelling, and the chain movement restriction by the crystalline region. In comparison, PCB-PTHF-0 and PCB-PTHF-100 remain transparent as only one domain exists in the material.

The results of this study demonstrated a significant difference in swelling ratio between polymers with different ratios of soft segments and hard segments.

TABLE 2

| | Young's Modulus | | Breaking Strain | | |
|---|---|---|---|---|---|
| | from Compression | | from Tensile | | |
| | Test (MPa) | | Test (%) | | Swelling |
| | Dry | Wet | Dry | Wet | ratio (%) |
| PEG-PTHF-50 | 6.94 | 1.11 | 10.7 | 6.8 | 23.6 |
| PCB-PTHF-0 | 29.59 | 27.67 | 13.2 | 6.9 | 4.7 |
| PCB-PTHF-25 | 15.7 | 15.04 | 172.8 | 68.8 | 4.8 |
| PCB-PTHF-50 | 0.92 | 0.23 | 722.5 | 379.5 | 8.5 |
| PCB-PTHF-75 | 0.22 | 0.06 | 909.4 | 442.7 | 14.2 |
| PCB-PTHF-100 | 2.74 | 3.09 | 127.3 | 57.7 | 20.6 |

### Mechanical Properties

Tunable mechanical properties for biomaterials are highly desired, since the requirement for mechanical properties of the materials depends on applications. Compression and tensile tests were performed to evaluate the mechanical properties of the PCB-PTHFs. None of the unhydrolyzed dry PCB-PTHFs failed under a maximum 100 MPa stress in the compression study. The final strain at maximum stress increases with increasing DEAEA content. PCB-PTHF-0 and PCB-PTHF-25 show behaviors corresponding to polymers with a stress plateau at approximately 15%-35% strain and strain hardening at higher strains. In comparison, PCB-PTHF-50, PCB-PTHF-75, and PCB-PTHF-100 behave as amorphous polymers at temperatures above the glass transition temperature, and their stress-strain curves do not exhibit a plateau. This difference is consistent with the DSC results, as PCB-PTHF-0 and PCB-PTHF-25 are partly crystallized while the other samples are not. The compression modulus is summarized in Table 2.

Except for PCB-PTHF-100, the modulus decreased with increasing the DEAEA composition. The decreasing modulus may be due to a decrease in crystallinity. PCB-PTHF-0 and PCB-PTHF-25 exhibit relatively higher modulus values (29.59 MPa and 15.70 MPa) as they are semicrystalline polymers. In comparison, PCB-PTHF-50 and PCB-PTHFU-75 are amorphous polymers and thus show relatively low modulus values (0.92 MPa and 0.22 MPa). Additionally, without intending to be bound by theory, it is believed that the low interfacial strength or stronger phase separation between the soft and hard domains could result in a lower modulus. The chain length difference between the DEAEA and PTHF 1000 segments decreases with increasing DEAEA ratio, as PCB-PTHF-75 possesses the most balanced DEAEA and PTHF100 length ratio. Besides, the decreasing molecular weight of PCB-PTHFs with increasing DEAEA segment also contributes to decreasing the modulus. Thus, the lowest modulus is observed for PCB-PTHF-75. PCB-PTHF-100, although with the lowest molecular weight among PCB-PTHFs, shows a higher modulus value (2.74 MPa) than PCB-PTHF-50 and PCB-PTHF-75 due to the absence of the PTHF chain, which results in low phase segregation and high hydrogen bonding density.

Compression strain-stress curves of the PCB-PTHFs after hydrolysis show breakage at a strain of 18% for PCB-PTHF-0, breakage at a strain of 18%, while the remaining PCB-PTHFs did not show any failure at a maximum stress of 100 MPa after hydrolysis. However, all PCB-PTHFs show a decrease in compression modulus after hydrolysis. PCB-PTHF-0, PCB-PTHF-25, PCB-PTHF-50, PCB-PTHF-75, and PCB-PTHF-100 exhibit modulus values of 27.67, 15.04, 0.23, 0.06, and 3.09 MPa, respectively. The breakage of PCB-PTHF-0 and the modulus change can be affected by the swelling of materials and the decrease in hydrogen bonding density. The modulus change after hydrolysis is largely related to the swelling ratio of the PCB-PTHFs. Except for PCB-PTHF-100, the decrease in the PCB-PTHF modulus in water enlarges with increasing DEAEA content. The compression modulus of PCB-PTHF-0 decreases by 6.4% after hydrolysis, whereas that of PCB-PTHF-75 decreases by 72.7%. This large difference in the modulus change is due to the larger swelling ratio of PCB-PTHFs with increasing DEAEA content. PCB-PTHF-100 shows a relatively small modulus variation after hydrolysis, most likely due to a high level of physical crosslinking by the inter- and intramolecular hydrogen bonding.

Except for PCB-PTHF-100, the breaking stress values decrease and the breaking strain values increase with increasing DEAEA ratio. This trend may be due to a decrease in crystallinity and interfacial strength, as discussed above. PCB-PTHF-100 shows a relatively high stiffness, possibly due to the high hydrogen-bonding density. The breaking strains are summarized in Table 2. Tensile tests of PCB-PTHFs after hydrolysis were performed and compared with those before hydrolysis. After hydrolysis, the breaking strains of the PCB-PTHFs decrease by 47%-60% due to the absorption of water and a decrease in hydrogen bonding density. Compression and tensile tests were also performed for PEG-PTHF-50 as a reference. As shown in and Table 2, PEG-PTHF-50 exhibits a modulus of 1.11 MPa after water equilibration, which decreased by 84% compared with the dry state due to the high water uptake of PEG-PTHF-50. In addition, PEG-PTHF-50 shows a breaking strain of 6.8% for the tensile test in the wet state. These compression and tensile tests demonstrate the soft and brittle mechanical properties of PEG-PTHF-50, especially after hydrolysis. Although PEG-PTHF-50 is confirmed to exhibit antifouling properties to some extent, as discussed in a later section, the bio-application of these material may be limited by its mechanical strength.

### Protein Adsorption

Protein adsorption on the surface of filter devices can cause blood coagulation and/or flux through the filter affecting the efficiency of the device. One of the disadvantages for polyurethane biomaterials is their unsatisfactory capability of resisting protein adsorption from the complex media, such as blood and body fluids. To address these biofouling issues, it was hypothesized that zwitterionic CB moieties may reduce nonspecific protein adsorption. Fibrinogen (Fg) has been widely used as a standard in vitro screening tool to assess protein adsorption levels, as it can strongly adsorb onto a variety of surfaces.

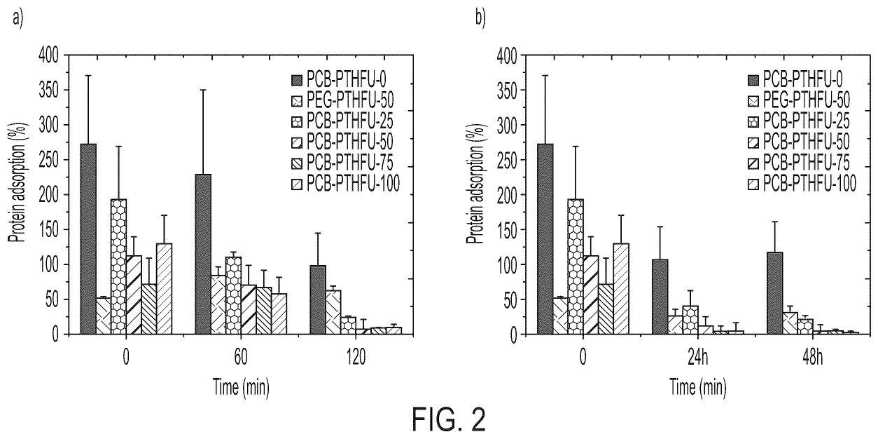

In this study, protein adsorption studies were conducted on the polymer surfaces and quantified by a fluorescent method. In particular, the fluorescence method was used to characterize the fibrinogen adsorption on PCB-PTHF surfaces. A PEG-based material (PEG-PTHF-50) and commercially available medical grade polyurethane (API-PU) were used as references. The API-PU is an aromatic polyether thermoplastic polyurethane with good resistance to microbial. It was reported that the API-PU shows a 98.7% reduction of E. coli growth compared with polyethylene. The antimicrobial performance of API-PU makes it a good reference in studying the anti-fouling property of PCB-PTHFs. Thus, the protein adsorption levels of the materials tested in this study was expressed as a percentage based on the API-PU level (100%). As shown in FIG. 2a, without hydrolysis, PCB-PTHF-0 exhibits the highest protein adsorption level at 270% of API-PU due to the intrinsic hydrophobicity of PTHF1000. In contrast, PCB-PTHF-25, PCB-PTHF-50, PCB-PTHF-75, and PCB-PTHF-100, which contain hydrophilic DEAEA segments, show less protein adsorption than PCB-PTHF-0 (70%-200% relative to API-PU). Overall, without hydrolysis, the PCB-PTHFs show similar protein adsorption compared with API-PU. However, after 120 min of rapid hydrolysis of DEAEA in a PBS buffer at pH 8.5, the protein adsorption of the PCB-PTHFs decreases significantly. The Fg adsorption on PCB-PTHF-50, PCB-PTHF-75, and PCB-PTHF-100 is less than 10% of that on API-PU, indicating that protein adsorption on the material surface is effectively controlled. The Fg adsorption on PCB-PTHF-25 decreases from 193% before hydrolysis to 24.3%. Although PCB-PTHF-25 contains the DEAEA zwitterionic precursor group, the concentration of DEAEA is only 25%. Thus, it is possible that there are not enough CB groups on the surface of PCB-PTHF-25, which can provide sufficient resistance to protein adsorption. In the case of PCB-PTHF-0, there is no hydrolysable zwitterionic precursor. However, PCB-PTHF-0 also shows a decrease in protein adsorption after 120 min of equilibration in a pH-8.5 PBS. buffer (98% relative to API-PU). The decreased protein adsorption on PCB-PTHF-0 may be attributed to the swelling of the material and wetting of the surface during equilibration. In water, a longer time is required for the completion of self-catalyzed hydrolysis because the hydroxide concentration that drives the process can be reduced by the hydrolysis of CB. After 48 h of equilibration in water, the PCB-PTHFs switch to the zwitterionic state with an apparent decrease in fibrinogen adsorption. The Fg adsorption on PCB-PTHF-50, PCB-PTHF-75, and PCB-PTHF-100 is less than 10% of that for API-PU (FIG. 2b). The results of the fluorescence study indicate that PCB-PTHF-50, PCB-PTHF-75, and PCB-PTHF-100 are effective at resisting nonspecific protein adsorption. The PCB-PTHFUs benefit from the zwitterionic CB groups generated via hydrolysis. As PEG-based functionalization has been widely used as a gold standard for improving the antifouling property of materials, PEG-PTHF-50 was also prepared as a reference. PEG-PTHF-50 shows relatively consistent protein adsorption behavior under all conditions, with an average adsorption of 52% compared with API-PU. Although PEG-PTHF-50 shows less protein adsorption than API-PU, the adsorption level is still higher than that of the hydrolyzed zwitterionic PCB-PTHFs. The Fg adsorption study further demonstrates that the CB functional group is more efficient than PEG in resisting nonspecific protein adsorption.

### Cell Attachment

To evaluate the resistance to mammalian cells attachment on PCB-PTHFs, cell adhesion studies were performed with NIH-3T3 fibroblast cells. Before exposing the materials to cells, the PCB-PTHFs were immersed in 100% FBS for 14 days to allow the absorption of serum proteins to mimic a constant exposure to body fluid or blood, mimicking an in vivo environment.

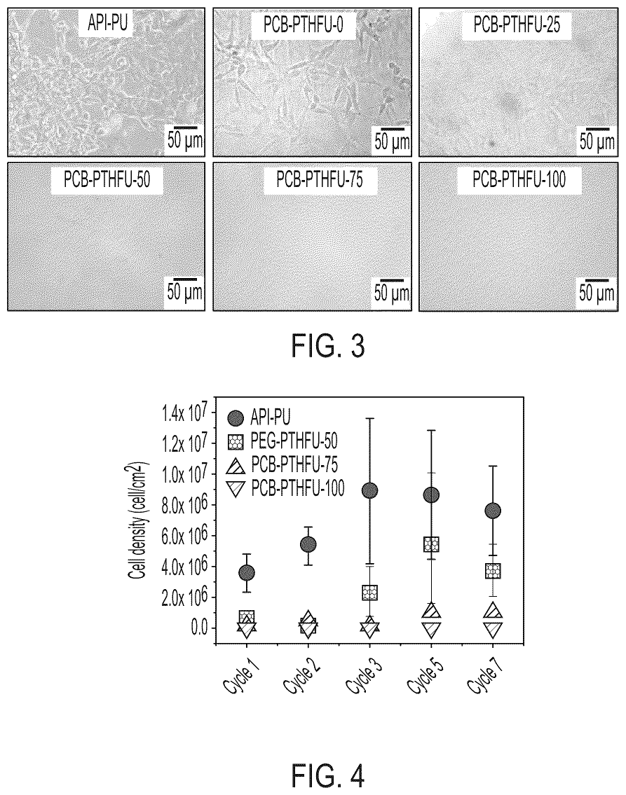

Afterward, PCB-PTHFs were incubated with NIH-3T3 cells at 37° C. for 24 h and examined by bright-field microscopy. FIG. 3 shows that the cell densities on the API-PU, PCB-PTHF-0, and PCB-PTHF-25 surfaces are 9.8×104 cells per cm², 7.8×104 cells per cm², and 7.2×104 cells per cm², respectively. No attached cells were observed on the surfaces of PCB-PTHF-50, PCB-PTHF-75, or PCB-PTHF-100. These test results demonstrate that, even in a complex protein-rich medium, mammalian cell attachments can be effectively prevented by the zwitterionic CB moieties.

### Bacterial Attachment and Biofilm Formation

The presence of zwitterionic CB moieties on a material surface has proven to be critical for resisting mammalian cellular attachment and biofilm formation. As a consequence, it was expected that the PCB-PTHFs would effectively resist the attachment of bacterial cells. Short-term bacterial cell attachment onto the PCB-PTHFs was evaluated using P. aeruginosa PAO1 bacteria, one of the most common pathogens causing infections associated with catheters and foreign body implants. All PCB-PTHFs were repeatedly exposed to a high-concentration bacterial suspension and then dried. The bacterial attachment after each cycle was evaluated. A large number of bacteria were observed in the first exposure for API-PU, PCB-PTHF-0, and PCB-PTHF-25. The bacterial density on the material increased with repetitive exposure to the bacterial suspension. For API-PU, the bacterial density increased to 9.0×10⁶ cells per cm² after three cycles (FIG. 4) and remained at a constant level throughout the remainder of the tests. Meanwhile, PEG-PTHF-50 and PCB-PTHF-50 showed lower bacterial attachment. However, after seven cycles, the cell density on PEG-PTHF-50 increased to 3.7×10⁶ cells per cm². PCB-PTHF-75 showed an attachment below 1.1×106 cells per cm² for P. aeruginosa PAO1 after seven cycles, representing an average decrease of 86.6% compared with API-PU. PCB-PTHF-100 showed minimal bacterial attachment, with almost no cells observed. The ionic solvation between the zwitterionic moiety and water molecules can form a hydration layer that strongly resists to bacterial attachment on PCB-PTHFs, especially for materials with relatively high density zwitterionic components, such as PCB-PTHF-75 and PCB-PTHF-100. Repeated exposure for one week was applied to mimic the use of coatings and devices, such as the reuse of intermittent urine catheters, in real life. A reusable catheter is favorable due to its low cost with less waste. However, the incidence of urethral trauma and urinary tract infection has been reported to reach 70%-80% for reused catheters. The experiment in these studies considered a more challenging situation than the actual application of reusable catheters, as the samples were not sterilized between cycles. Additionally, a higher cell concentration was used in the bacterial suspension (5×108 cells per mL) instead of the concentration observed during short-term urine contact (<105 cells per mL). The results of the bacterial attachment test demonstrate the potential application of PCB-PTHFs for the reusable implanted devices.

The long-term biofilm formation of P. aeruginosa was also studied on PCB-PTHF surfaces. Previous studies demonstrated that polymers with zwitterionic CB moieties can completely prevent biofilm formation for up to six months. However, no highly elastic thermoplastic polymer material has shown critical long-term resistance to biofilm formation in a complex system. In this study, biofilm formation was evaluated under a challenging static environment with a protein-rich complex growth medium that helps bacterial cells attach to the surface and provides nutrients for the rapid growth of biofilms. As shown in FIG. 5, biofilms grew rapidly on the surface of API-PI, PCB-PTHF-0, and PCB-PTHF-25, with over 75% of the material surface covered by biofilm after one day of incubation. In comparison, PEG based PEG-PTHF-50 shows less biofilm formation with a minimal level of biofilm found on the first day. However, after three days of incubation, the PEG-PTHF-50 surface was almost entirely covered by P. aeruginosa, as observed for API-PU. In contrast, PCB-PTHF-50 shows three-day delay in biofilm growth on the surface. After five days in P. aeruginosa PAO1 culture, PCB-PTHF-50 shows a biofilm surface coverage of 8.95%, and the coverage increased to 48.7% after one week. Because PCB-PTHF-50 possesses a higher CB density than PCB-PTHF-25, it is more resistant to biofilm formation than PCB-PTHF-25. However, the density of zwitterionic CB moieties could still be insufficient to provide a longer-term biofilm-free surface. In comparison, almost no P. aeruginosa PAO1 bacterial cells were observed on the PCB-PTHF-75 and PCB-PTHF-100 surfaces, even after three weeks.

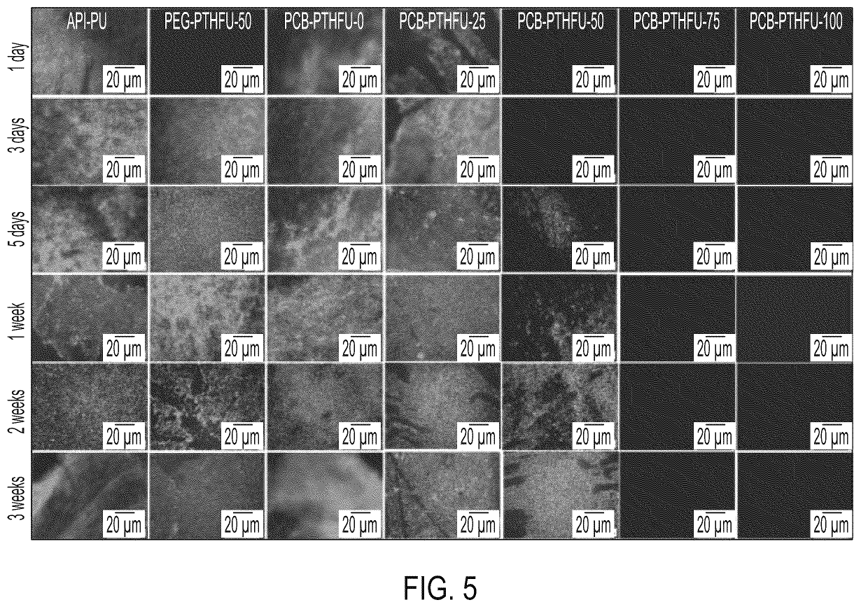

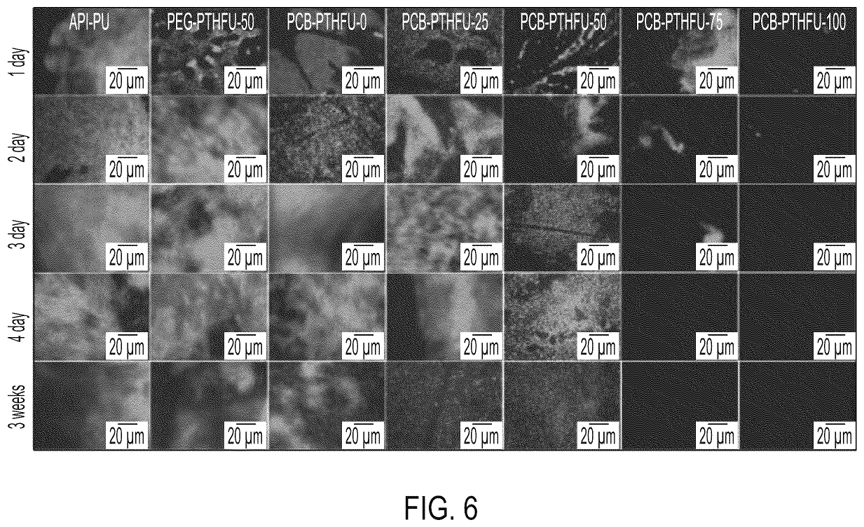

Biofilm adhesion on unhydrolyzed dry PCB-PTHFs was also evaluated with dry PEG-PTHF-50 and API-PU. Of note, dry material samples were placed directly in the protein-rich medium for biofilm growth, without pre-hydrolysis or buffer equilibration. The hydrolysis of PCB-PTHFs and the generation of antifouling zwitterionic CB groups compete with the biofilm growth. As shown in FIG. 6, the biofilm grew rapidly on API-PI, PEG-PTHF-50, PCB-PTHFU-0, and PCB-PTHF-25, with over 80% of the material surface covered by biofilm after one day of incubation and almost complete coverage after three days. Dry PEG-PTHF-50 does not show the same mitigated biofilm formation that occurs when it is equilibrated with water. The pre-equilibrated PEG-PTHF-50 may experience micro-phase segregation in water and expose more hydrophilic PEG segments being exposed on the material surface, thus showing better biofilm resistance than dry PEG-PTHF-50. PCB-PTHF-50 showed less biofilm growth on the surface, with 38.67% biofilm surface coverage on the first day and 58.97% coverage on the second day. After three days of incubation, the surface of PCB-PTHF-50 was almost completely covered by biofilm. PCB-PTHF-75 and PCB-PTHF-100 showed biofilm growth on the first day with 45.20% and 8.27% biofilm coverage on the surface, respectively. However, as hydrolysis of the material occurred in the broth medium, PCB-PTHF-75 and PCB-PTHF-100 showed a release of surface biofilm starting on the second day and found biofilm-free on the third and fourth day, respectively. After three weeks, PCB-PTHF-75 and PCB-PTHF-100 exhibit no P. aeruginosa PAO1 cells. These results show that zwitterionic PCB-PTHFs surfaces possess an excellent ability to resist biofilm formation. The rapid self-catalyzed hydrolysis of DEAEA can provide a high resistance to biofilm formation and can release biofilms, even without pre-hydrolyzation.

Accordingly, Example 1 demonstrates the synthesis of a series of zwitterionic polyurethanes with CBs as part of the polyurethane backbone, and where the CB content in the polymer could be readily tuned by altering the molar ratio of PTHF and DEAEA. These polyurethanes demonstrated enhanced elasticity and superior antifouling properties. Example 1 demonstrates the relationships among structure, function, and stability of zwitterionic materials. PCB-PTHFs with high CB content, such as PCB-PTHF-75 and PCB-PTHF-100, displayed the ability to resist cell attachment for 24 h and to prevent biofilm formation for three weeks. Additionally, the PTHF1000 segment was found to enhance the elasticity of the PCB-PTHFs and provided a 400% breaking strain to PCB-PTHF-75. This example provides fundamental information regarding the structure-function relationships of zwitterionic polymers. This highly elastic thermoplastic PCB-PTHFU platform with critical antifouling properties can be applied for a wide range of applications, including medical devices. The PCB-PTHFs exhibited a breaking strain of more than 400%, high resistance to fibroblast cells for 24 h, and the ability to prevent biofilm formation for up to three weeks.

### Example 2—Zwitterionic Polyurethane Membrane Fabrication

PCB-PTHF-100 was prepared as described in Example 1. Cellulose acetate (CA) membrane filters with a pore size of 0.8 μm (“porous membrane supports”) were plasma-initialized in a plasma cleaner (PDC-001-HP, Harrick Plasma, USA) under 45 W of radio-frequency power for 2 min. The porous membrane supports were then mounted in a stir cell system. To control the PCB-PTHF-100 coating, a different concentration of PCB-PTHF-100 in methanol solution (5, 2.5 wt %) was circulated through the membranes on each side for 5, 10, or 15 min. This procedure ensured that PCB-PTHF-100 covered both the membrane surfaces and the pore walls. After the coating procedure, the membranes were dried in a vacuum oven at 40° C. overnight. When the PCB-PTHF-100 coated CA (PCBU-CA) membrane was hydrolyzed in PBS buffer at a pH of 8.5 for 2 hours, the beta-amino ester of DEAEA underwent rapid hydrolysis, and zwitterionic carboxybetaine functional groups were generated, which provide critical anti-fouling properties. AFM (AFM Workshop, USA) was performed in tapping mode under ambient conditions to investigate the morphology of unfunctionalized CA membranes and PCBU-CA membranes with a typical scan length of 15 μm, a scan rate of 0.1 Hz, an operating frequency of 150-200 kHz, and a resolution of 1024 pixels.

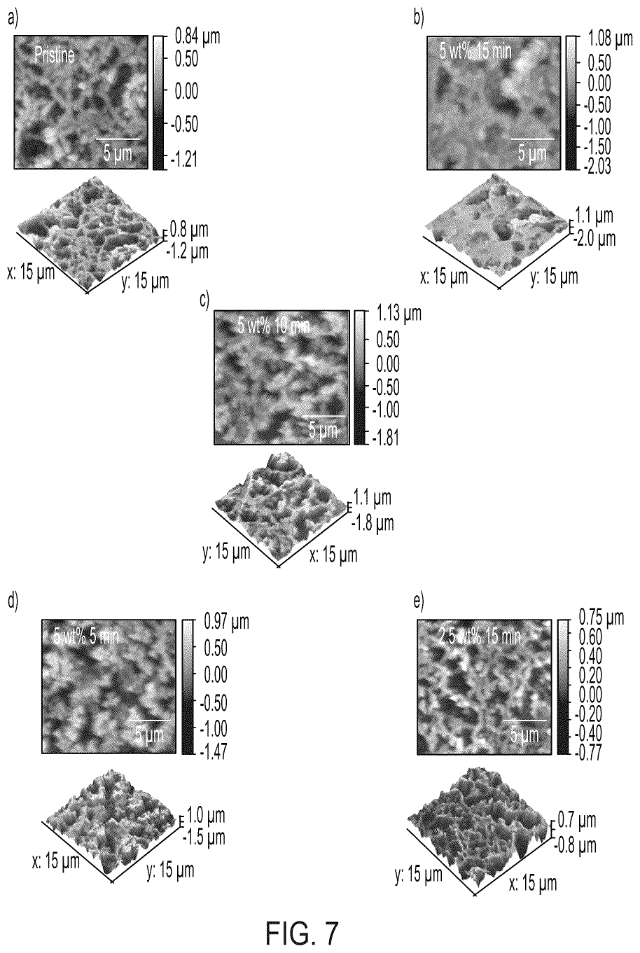

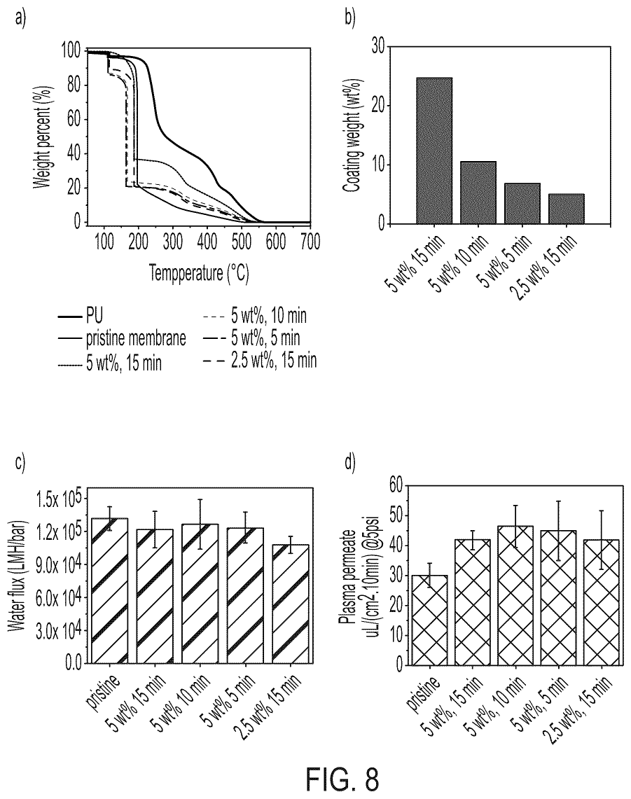

The results of the AFM analysis shown in FIG. 7 indicate that the pores of a CA membrane modified with 5 wt % PCB-PTHF-100 solution for 15 min are clogged by PCB-PTHF-100, and a decrease in coating time can reduce the pore-clogging issue of CA membranes. Such clogging of the pores can reduce plasma flux through the membrane. In particular, FIG. 7a shows an AFM image and height profile analysis of a pristine CA membrane that does not include PCB-PTHF-100, whereas FIG. 7b-FIG. 7d show AFM images and height profile analyses of PCB-PTHF-100 coated membranes. The amount of PCB-PTHF-100 coated on CA membranes was also investigated using TGA analysis. FIGS. 8a and 8b show that the amount of PCB-PTHF-100 coated on CA membrane increases up to ˜25 wt % as polymer solution and coating time increases. The solution of 2.5 wt % polymer, when applied for 15 min of coating time only, coated the membrane with 5 wt % of PCB-PTHF-100. To confirm which coating condition can provide the best performance, the permeation of PBS buffer and whole blood was measured with a standard membrane filtration test cell under stirring (FIGS. 8c and 8d). PBS buffer permeability of all PCB-PTHF-100 membranes including the pristine CA membrane showed similar values. However, in the whole blood test, the membrane prepared with 5 wt % polymer solution and 10 min coating time provided the highest plasma permeability through the membrane, and this coated membrane was chosen for device fabrication.

### Example 3—Vacutainer Blood Collection Tube Assembly

A prototype vacutainer for plasma separation that is targeted to be employed at a clinic/bedside was designed and fabricated by using a 3D printer (FIGS. 9a and 9b). The device is composed of two primary components: a blood inlet and a plasma outlet. The blood inlet (top component) has an inlet tunnel on the top for blood sample loading and a chamber for the injected blood (10-mL capacity). The plasma outlet (bottom component) has a chamber for filtrated plasma (5-mL capacity). The top and bottom chambers are separated by four zwitterionic functionalized membranes (8 cm²) as prepared in Example 2 with 5 wt % polymer solution and 10 min coating time. During the filtration test, the plasma outlet chamber was vacuumed to simulate a commercial vacutainer blood collection tube.

As shown in Fib. 9c, plasma was immediately collected in the bottom chamber, and more than 1 mL plasma was collected in 10 min. In addition, optical microscopy analysis clearly indicates that no blood cells are observed in the collected plasma solution (FIGS. 9d and 9e). Thus, Example 3 demonstrates the efficient separation of plasma from whole blood using a zwitterionic polyurethane membrane of the disclosure in a device of the disclosure. Notably, a significant amount of plasma was collected from the whole blood in only 10 min.

### Example 4—Evaluation of Plasma and Viral Particle Separation Performance

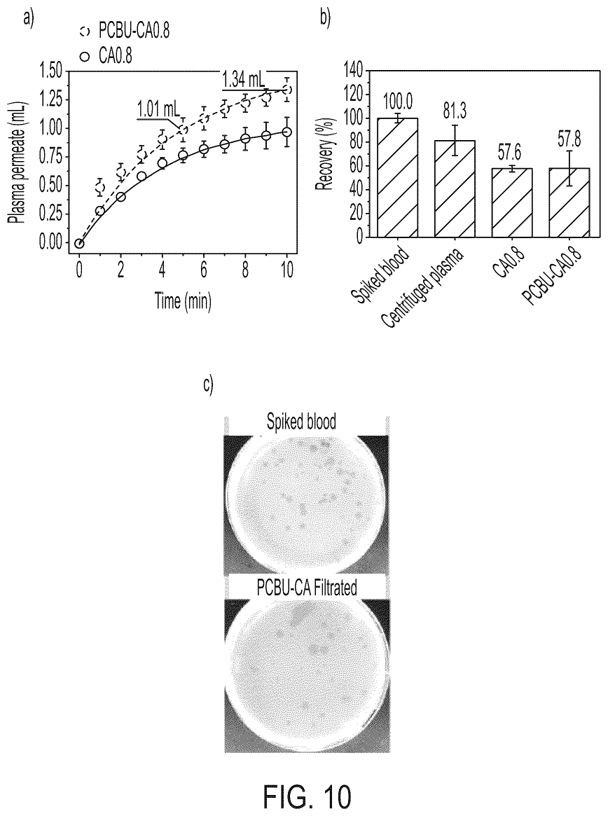

Three prototype devices were assembled for the evaluation of PCBU-CA membrane filtration efficiency. The PCBU-CA membranes were prepared as described in Example 2 with 5 wt % polymer solution and 10 min coating time. The PCBU-CA membrane performance was also compared with pristine CA membranes. In addition to plasma permeability measurement, the devices were tested with phage spiked undiluted porcine whole blood with 1×105pfu/mL concentration. The permeated plasma was immediately collected in the bottom chamber right after the blood was loaded in the inlet chamber. As shown in FIG. 10a the devices with PCBU-CA membrane collected ≈1.34 mL of plasma permeate after 10 mins of filtration under −5 psi vacuum while the device with pristine CA membrane collected ≈0.90 mL of plasma permeate after 10 mins of filtration under-5 psi vacuum, which indicates that the plasma permeability of PCBU-CA membranes is ˜40% higher than the pristine CA membrane. These results clearly show that the PCBU coating can significantly improve the anti-fouling properties of the membrane.

The virus recovery was studied using the plate assay (FIGS. 10b and 10c). As shown in FIG. 10b, the device with PCBU-CA membrane achieved up to 72% plasma recovery (avg. 57.8±14.2%) compared with the spiked blood, which is similar to the pristine CA membrane (57.6%±2.94). The membrane-based plasma separation shows virus recovery lower than the centrifugation process, without intending to be bound by theory, it is believed that the lower recover may be due to the virus loss retained by the blood cake layer deposited on the membrane surface and absorption on the device surface.

### Example 5—Zwitterionic Polyurethane Membrane Fabrication

### Electrospinning

To produce continuous ultrafine polyurethane fibers, an electrospinning apparatus was designed and built. The electrospinning apparatus has a high voltage power supply unit (Gamma High Voltage, USA), a syringe pump (New Era Pump Systems, USA), a set of electrodes, and a collector. The microclimate of the electrospinning apparatus was continuously measured and controlled within 20-25° C. and 30-45% RH. A mini-sized fan was used in the chamber for airflow. To produce various spinning solutions with zwitterionic polyurethanes or pre-polymers thereof (zPUs), having PU concentrations ranging from 15% to 25% (weight/volume), PUs were dissolved in an organic solvent (e.g., a mixture of tetrahydrofuran (THF) and N, N-dimethylformamide (DMF)). A syringe pump was used to control the flow rate of the polymer solution from the syringe, and copper plates were used as the zPU membrane collector. Applied voltage for electrospinning was customized from 25 kV to 30 kV. Fiber diameters, pore sizes, and thickness of the zPU membranes could be tailored depending operating parameters of the electrospinning condition.

### Phase Inversion Method

zPU membranes were be fabricated using the direct immersion-precipitation method. The zPU solutions were prepared by adding zPU in an organic solvent (e.g., DMF, THF). Then, the zPU solution was cast directly on a membrane backing layer (e.g., non-woven fabric, woven fabric, mesh fabric), and the cast composite membranes were immersed into a coagulant bath (e.g., water) to complete the formation of the asymmetric membrane structure.

### Direct Coating Method

In this method, a thin zPU coating is directly coated on the surface of a porous membrane support fiber. The zPU solution is prepared by adding zPU in an organic solvent (e.g., DMF, THF). A micro- or nanoporous membrane filter (e.g., cellulose acetate membrane, polysulfone membrane) was used as porous membrane support. The membrane filter surface can be activated by plasma or chemical etching. The thin layer of zPU coating was deposited on the membrane surface by a dip coating or spray coating method. After the coating, the membrane was dried in a vacuum oven or air overnight. The fabricated zPU membrane can be is hydrolyzed in pH=8.5 PBS buffer for 2 hours before use.

### Characterization

The morphological structure of the fabricated zPU membranes, such as porosity, fiber diameter, and pore size of the membranes, were evaluated by scanning electron microscopy (SEM) and atomic force microscopy (AFM).

Contact angle measurements were performed to evaluate the wetting properties of the membrane. Briefly, a droplet of DI water was dispensed onto the surface of the membrane and allowed to rest for two minutes to reach an equilibrium shape before using the software to capture an image of the droplet and measure the contact angle. At least three such measurements are made for each sample.

For membrane filtration experiments, a dead-end cell filtration test was carried out to characterize the protein, blood cells, and virus filtration performance and water flux recovery ratio of the prepared membranes. Before the filtration tests, the membranes were pre-wetted in water. After the first pure water flow rate measurement, the fouling test was performed using a solution containing bovine serum albumin (BSA), bacteria, virus, or whole blood. Then, the protein filtration-tested membranes were washed with pure water under stirring for 1 hr, followed by a second pure water permeance measurement.

For evaluation of plasma separation performance of the fabricated zPU membranes, the plasma permeation across the membranes was assessed by using a 3D-printed prototype device. The feed side chamber was initially filled with whole blood containing a specific concentration of EDTA anticoagulant. The plasma permeation was measured by measuring cylinder or electronic weight with time. Separated plasma was collected to measure the hemoglobin level using UV-2600 spectrophotometer (Shimadzu, USA). To confirm the absence of blood cells in the plasma, extracted plasma was evaluated using Olympus IX81 microscope (Olympus, Japan) and AFM (AFM workshop, USA).

Fabricated zPU membranes can be further tuned and developed for viral sample preparation application where the performance of virus separation is evaluated by virus recovery test. A feed porcine blood was mixed with a specific concentration of virus solution, and the number of virus in the feed and permeate plasma was calculated and compared by plaque assay.

### Example 6—Synthesis and Evaluation of Zwitterionic Polymer

Diethanolamine ethyl acrylate (DEAEA) synthesized as described in Example 1 (FIG. 12a).

PCBU can be synthesized, such as via a one-pot reaction with a 1:1 ratio of DEAEA: 1,6-Diisocyanatohexane (HDI) using the standard procedure for polyurethane synthesis. The antifouling carboxybetaine groups can be directly incorporated into the PU backbone via DEAEA, which served as both an extender of the PU backbone and an antifouling unit. An exemplary synthetic route is shown in FIG. 12b.

HDI (13.30 g, 79.12 mM) was added drop by drop to a nitrogen-purged, three-neck round bottom flask filled with the DEAEA (16.22 g, 79.12 mM). The flask was equipped with a temperature sensor and a mechanical stirrer. After the viscosity increased approximately half an hour later, anhydrous DMF (60.00 mL) was added. The solution was reacted for 9 h at a constant temperature of 80° C. with stirring at 450 rpm, and then, CH₃OH as a quencher (10.00 mL) was injected. After another 4 h of reaction at 60° C., the polymer was precipitated in diethyl ether and centrifuged under 8000 rpm for 10 min. Part of the precipitated PCBU was dissolved in methanol, resulting in a 5 wt % solution. The remainder of the precipitated PCBU was dissolved in methanol and transferred into a poly(tetrafluoroethylene) dish. The dish was placed in a vacuum oven at a constant temperature of 110° C. for 12 h to dry the PCBU. After drying, the residual solvent was removed and a homogeneous thin film was formed in the dish. The PCBU film was then peeled off from the dish and then cut into disks (4 mm in radius and 2 mm in thickness) for protein adsorption measurements. The chemical structure and high purity of DEAEA were confirmed by 1H NMR spectroscopy.

### PCBU-CA Membrane Fabrication

In accordance with the principles herein, an exemplary PCBU with 1:1 ratio of DEAEA: HDI was chosen because it can provide the significant antifouling property in view of its highest zwitterionic group ratio. A schematic illustration is shown in FIG. 12c. A cellulose acetate (CA) membrane filter with a pore size of 0.8 μm was plasma-initialized in a plasma cleaner (PDC-001-HP, Harrick Plasma, USA) under 45 W of radio-frequency power for 2 min. The membrane was then mounted in a stir cell system. PCBU (5 wt %) in methanol solution was circulated through the membranes for 15 min on each side to ensure that the PCBU covered both the membrane surface and the pore walls. After the coating procedure, the membrane was dried in a vacuum oven at 40° C. overnight. When the PCBU-CA membrane was hydrolyzed in PBS buffer at a pH of 8.5 for 2 h, the beta-amino ester of DEAEA underwent rapid hydrolysis, and zwitterionic carboxybetaine functional groups were generated, which provide critical antifouling properties.

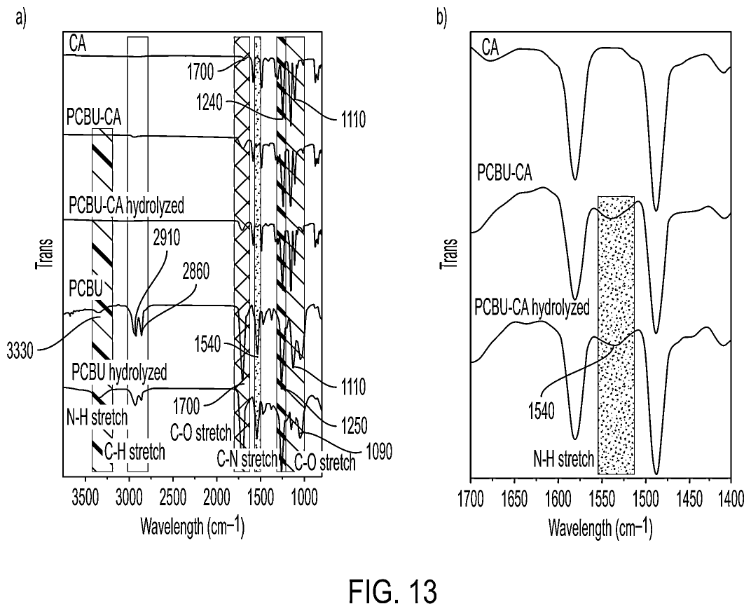

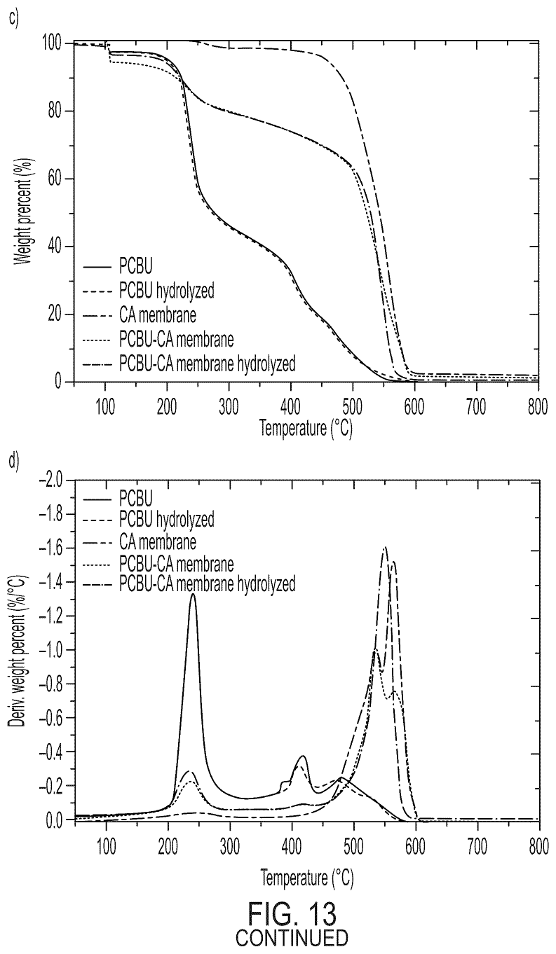

FT-IR analysis was applied to characterize the chemical composition of the CA membrane, PCBU, and PCBU-CA membrane, and the spectra are shown in FIGS. 13a and 13b. In PCBU, the—NCO stretching absorbance at 2250-2270 cm⁻¹ is absent, indicating the completion of the reaction and the depletion of all isocyanate groups. Absorption bands for N—H stretching vibrations are observed at 3330 cm-1, and C—H stretching, C═O stretching, C—O—C stretching, and N—H bending are observed at 2910-2869, 1700, 1110, and 1540 cm⁻¹, respectively. These signature bands indicate that the reaction proceeded to the formation of PCBU and the depletion of the reactants. In comparison, the hydrolyzed PCBU shows weaker absorption at 1110 cm⁻¹ due to hydrolysis of the ester bond and loss of the C—O—C group on the DEAEA side chain. The absorption band of C—O stretching on the generated alcohol appears at 1090 cm⁻¹. These differences verify the effective hydrolysis of the DEAEA side chain and the generation of zwitterionic groups. For the CA membrane, the absorption peak of the acetyl group is observed at 1700 cm⁻¹, while peaks for C—O stretching and C—O—C stretching occur at 1240 and 1110 cm⁻¹, respectively. After the coating procedure, N—H bending bands at 1540 cm⁻¹ appear for the PCBU-CA membrane and the hydrolyzed PCBU-CA membrane. This signature bending band indicates the existence of a PCBU layer on the surface of the PCBU-CA membrane. Thus, the FT-IR study confirms that PCBU can form a stable layer on the CA surface before hydrolysis, which remains intact after hydrolysis.

### TGA Analysis of PCBU-CA Membrane

A quantitative analysis of the exemplary PCBU coating layer on the exemplary membrane and the thermal stability of the CA membrane, PCBU, and PCBU-CA membrane was determined by TGA, as shown in FIGS. 13c and 13d. The weight loss at 110° C. corresponds to the evaporation of adsorbed water on the membranes. For the pristine CA membrane, significant weight loss (˜98%) starts at 400° C., corresponding to the decomposition of D-glucose units of the cellulose chains. PCBU follows the typical three-step decomposition process observed in polyurethane. In the first stage, between 200° C. and 350° C., a mass loss of 55% occurs as the urethane bonds decompose and form alcohol and isocyanate groups. Subsequently, the isocyanates dimerize and form carbodiimides. Then, relatively stable N-substituted urea is formed by the reaction between alcohol hydroxyl groups and carbodiimides, which prevents complete volatilization of the resulting chain fragments. In the final stage, at higher temperatures between 350° C. and 600° C., the N-substituted urea becomes volatile, which causes a mass loss of 40%. The hydrolyzed PCBU does not show a notable difference from the unhydrolyzed PCBU, although the hydrolysis procedure hydrolyzes the ester group on the side chain, generating carboxylic acid. The ester group can also generate carboxylic acid through ester pyrolysis. However, this reaction generally occurs above 500° C. At this temperature, the relative reactants are already gasified. Therefore, the difference between hydrolyzed and unhydrolyzed materials is negligible in the TGA study.

For the PCBU-CA membrane, apparent weight loss peaks occur at 220° C. and 400° C., which correspond to the PCBU layer on the membrane. A comparison of these TGA curves verifies the existence of a PCBU layer on the membrane. The amount of PCBU on the surface of the PCBU-CA membrane was quantified as 9.4 wt % by comparing the weight loss peak at 220° C. between PCBU-CA and PCBU. The specific surface area of a porous CA membrane with a pore size similar to that of our membrane (0.42 μm) has been reported at 5-20 m2/g. The thickness of the PCBU coating on the CA membrane can then be calculated as 5.22-20.88 nm, which is typical for coatings prepared by immersion methods utilizing hydrogen bonding and electrostatic interactions. After hydrolysis, the weight loss at 220° C. and 400° C. of the PCBU-coated CA membrane did not decrease, indicating that the hydrolysis procedure does not compromise the PCBU layer. This result suggests that the PCBU coating will be stable on the membrane surface in an aqueous blood separation application.

### AFM Analysis of Membranes

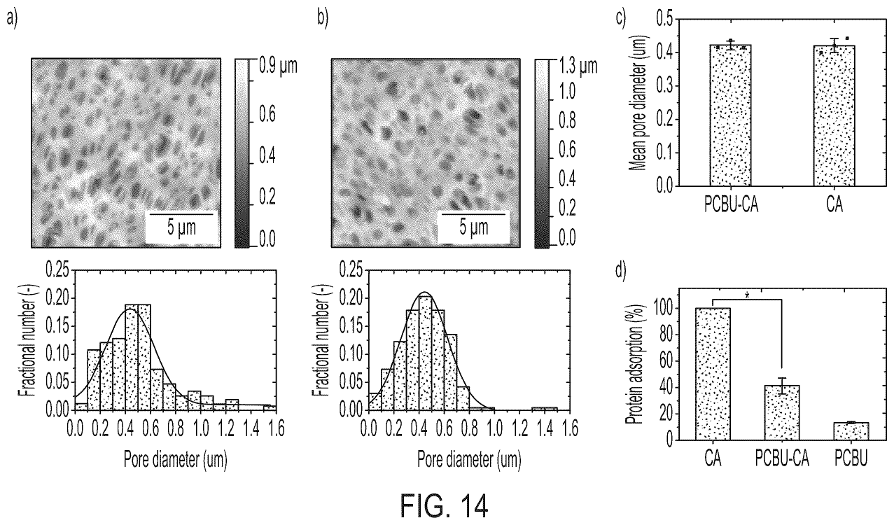

SEM and AFM analysis were employed to investigate the surface morphology and pore structure of the membranes (i.e., pristine CA and PCBU-CA membranes) tested in accordance with the principles herein. The pristine CA membrane showed a porous surface morphology with a 3D interconnected porous network and an average pore size of ˜0.4 μm (FIG. 14a), which is a typical morphology for a microporous CA membrane prepared by phase inversion. As shown in FIG. 14b, the surface morphology and pore size distribution of the PCBU-CA membrane are not substantially different from that of the pristine CA membrane. In addition, the PCBU-CA membrane shows a mean pore size (0.421±0.013 μm) similar to that of the CA membrane (0.421±0.021 μm) (FIG. 3c). Top-view SEM images of pristine CA and PCBU-CA membranes also confirm no significant changes in surface morphology of the membranes (FIGS. 18a and 18b). After the PCBU coating, the PCBU-CA membrane exhibits a homogeneous surface morphology without any structural defects, which is similar to a pristine CA membrane. The AFM and SEM results indicate a thin homogeneous coating of PCBU on the CA membrane surface without any agglomeration or localization of the PCBU, consistent with our calculations for the coating layer (˜5-20 nm) described above. Thus, the surface morphology of CA was not affected by the PCBU layer coating process, and the microporous structure of the CA membrane was retained after the membrane modification.

### Protein Adsorption Test on Membranes

Protein adsorption on the exemplary membrane surface can be considered the initial step of undesired biofouling, significantly reducing the membrane flux. To assess the antifouling properties of the membranes, the adsorbed foulant on the membrane surface was quantitatively analyzed by using a FITC-labeled fibrinogen adsorption test. CA and PCBU films were also examined as references for comparison. Fibrinogen is a major blood protein with high stickiness (stronger binding strength compared with albumin and immunoglobulin), which can be adsorbed onto various surfaces; thus, fibrinogen is widely employed as a standard in vitro screening tool for determining the antifouling properties of various materials. As shown in FIG. 14d, compared with the unmodified CA film, the exemplary PCBU film shows only 13.7% relative protein adsorption, proving its superior antifouling property. After the CA film was modified with the PCBU coating, the fibrinogen adsorption on the CA membrane surface decreased sharply by ˜58.5%. The exemplary zwitterionic PCBU surface coating can combine many water molecules to form a dense hydration shell via electrostatic interactions. The hydration shell serves as an effective barrier to prevent the membrane surface from directly contacting the fibrinogen, thus inhibiting adsorption.

### Plasma Separation Performance Evaluation

The exemplary PCBU-CA membrane was tested in plasma separation and compared with the pristine CA membrane. The separation of plasma from cellular components was accomplished by filtration through the porous PCBU-CA membrane, as shown in FIG. 15a.

The configuration of a slams separator device is shown in FIG. 17. A semi-transparent acrylic device 4.8 cm long×2.8 cm wide x 2.0 cm thick was fabricated by a 3D printer (Elegoo Mars UV photocuring 3D printer). The exemplary device was composed of two primary components: a blood inlet and a plasma outlet. The blood inlet (right component) has an inlet tunnel on the top for blood sample loading and a chamber for the injected blood (10-mL capacity). The plasma outlet (left component) has a chamber for filtrated plasma (5-mL capacity). During the filtration test, the plasma outlet channel was vacuumed to simulate a commercial vacutainer blood collection tube, and an exit port was connected to the chamber to collect plasma. Both chambers have a 4.0-cm-long×2.0-cm-wide window for an effective filtration area of 8 cm². To support the plasma separation membrane, mesh support was included in the plasma outlet chamber.

Whole blood was loaded into the separation device and sieved through a membrane that effectively retains large blood cells (RBCs, WBCs, and platelets) but allows plasma, along with other biomarkers such as proteins and nucleic acids, to pass. FIG. 15b shows images of the plasma separation process based on a separation device configured with an exemplary PCBU-CA membrane constructed in accordance with the principles herein.

The exemplary device was designed with an easy-to-use process that does not require specific training or specialized equipment. First, the device was assembled with the pristine CA membrane or PCBU-CA membrane, and the plasma chamber was pre-vacuumed with an external pump. Then, blood was loaded into the blood chamber with an injection syringe or pipette (Step 1). Once the blood was injected, plasma started to permeate through the membrane and fill the plasma chamber (Step 2). Then, the device was left until the permeated plasma reached the desired volume (Step 3). The permeated plasma was then collected by a pipette or syringe for further analysis.

A vacuum (negative pressure in the plasma outlet chamber) was applied as a driving force, as employed in commercial vacutainer blood collection tubes, which provides a higher separation efficiency. The stronger vacuum increases the transmembrane pressure, enhancing the plasma flux through the membrane toward the plasma outlet chamber. However, excessive negative pressure can increase concentration polarization (CP) and cause more severe fouling on the membrane surface. In general, the fouling of blood cells in whole blood can be worsened because the constituents at higher concentrations can more strongly interact and deposit onto the membrane surface. The fouling of whole blood can significantly reduce the membrane flux, especially because the solution carries larger and less-diffusive molecules, such as proteins and blood cells. In addition, a relatively higher vacuum operation can cause hemolysis, and the released intracellular components of blood cells can substantially affect clinical tests. Therefore appropriate transmembrane pressure should be chosen when utilizing the plasma separation device for point-of-care applications.

The device was tested at several different pressures, (e.g., −2.5, −5.0, −7.5 psi), as shown in FIG. 15c. As the differential pressure increased from −2.5 to −5 psi, the extracted plasma volume also increased from 0.10 to 0.48 mL. However, as the differential pressure increased further from −5 to −7.5 psi, the plasma permeation volumes at the two vacuum levels appeared to be similar. This result indicates that the transmembrane pressure reaches a critical value at a vacuum level of −5 psi. Without intending to be bound by theory, it is believed that beyond this critical pressure, CP becomes sufficient to produce a gel layer of blood cells on the membrane surface, especially the plasma filtration test was operated in a challenging static condition. After forming a gel layer, a further increase in differential pressure increases the thickness of the gel layer as well as the density of the retained blood cells on the membrane surface, limiting the permeate flux through the membrane.

FIGS. 15d and 15e show the separated plasma volume as a function of time for undiluted and diluted blood (1:1 ratio of PBS buffer and EDTA anticoagulated blood), respectively. The permeated plasma was observed immediately after the blood was loaded in the inlet chamber, with a rapid yield observed for the first 10 min. After 10 min, the blood plasma continuously underwent separation at a reduced flux rate due to the condensed blood cell layer on the membrane surface. The collected plasma volume of the device with the PCBU-CA membrane for whole blood reached 0.48±0.04 mL in 10 min. Compared with the unfunctionalized CA membrane (0.30±0.01 mL), the PCBU-CA membrane showed a 60% improvement in performance (FIG. 15d). For 1:1 PBS-diluted blood, the plasma volume of the device with the PCBU-CA membrane was 0.69±0.10 mL, which is 77% higher than that for the pristine CA membrane (0.39±0.01 mL) (FIG. 15e). These results indicate that the PCBU coating can significantly improve the antifouling properties of the CA membrane.

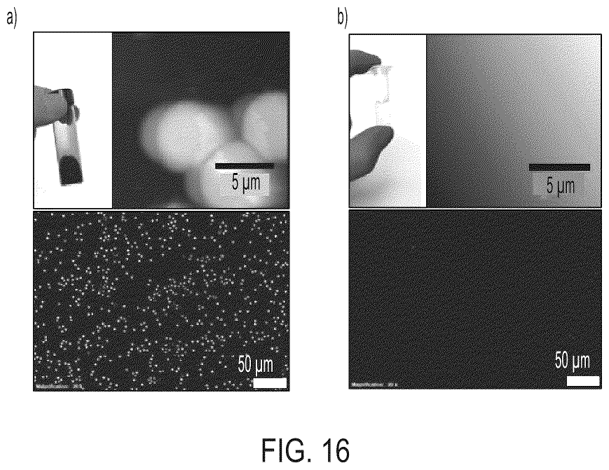

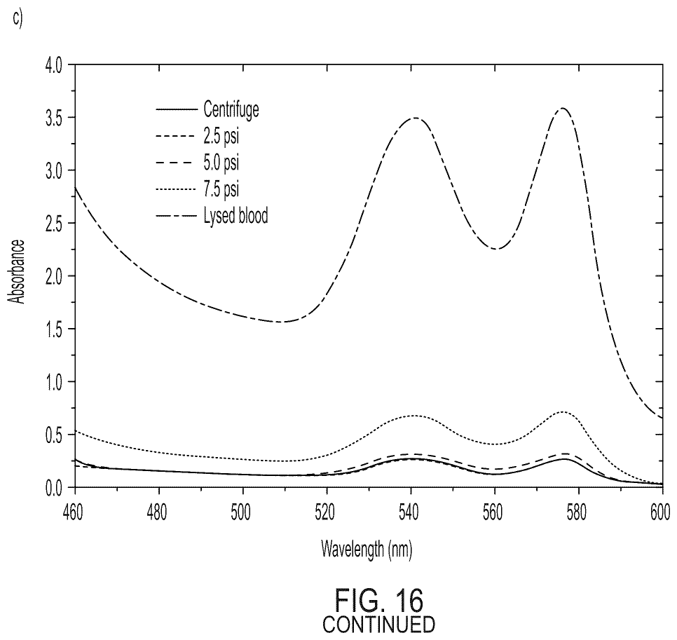

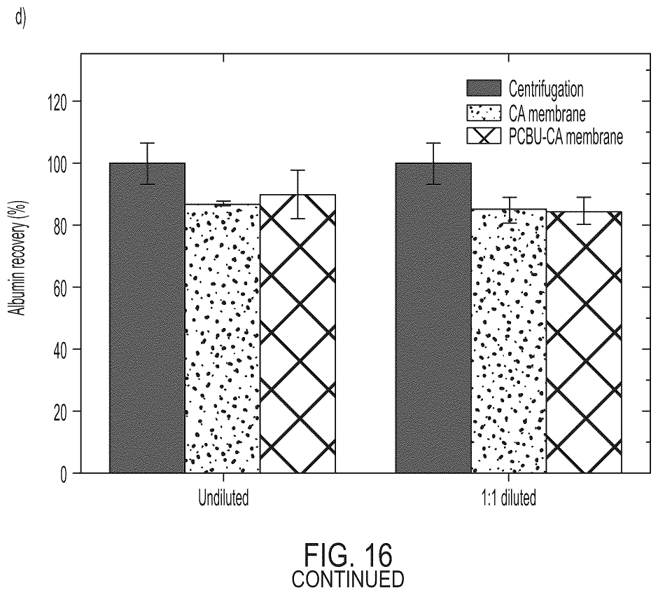

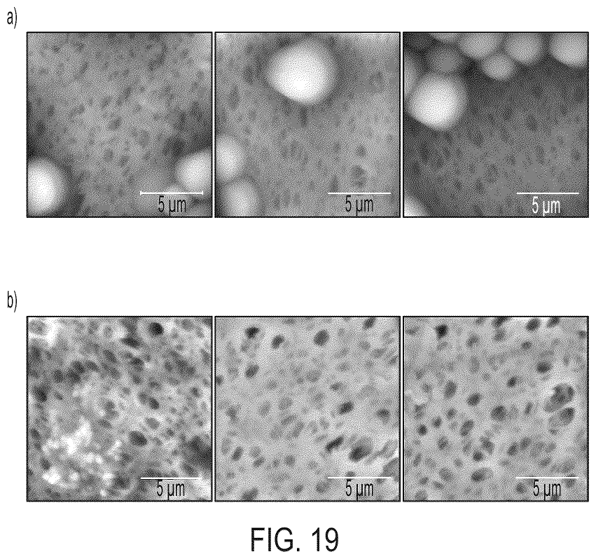

Moreover, as shown in FIG. 15e, the dilution of whole blood with PBS buffer can increase the permeated plasma yield. Of note, the plasma yield in FIG. 15e is the neat plasma volume, which excludes the PBS buffer volume. Diluting the blood feed solution can decrease the concentration of proteins and blood cells and reduce the gel layer thickness during filtration, thus enabling the device to achieve a higher plasma flow rate. Current virus loading assays generally require 250 μL to 1 mL plasma, while the sample volumes for a single run of a clinical biochemistry panel range from 100 to 500 μL. Thus, the yields of ˜0.5 mL undiluted plasma or ˜0.7 mL 1:1 diluted plasma obtained by our device in 10 min can satisfy most clinical requirements. Although undiluted plasma is preferable for most clinical applications, diluted plasma can also be used for several biochemistry analytes when the concentration of the target substance is above the detection limit. Optical microscopy and AFM were used to assess the degree of cellular adsorption on the membrane surface, which is the primary cause of a reduced filtration flux. FIG. 15f depicts the pristine CA membrane (upper) and the coated PCBU-CA membrane (bottom) after the filtration of plasma from whole blood. After exposure to undiluted porcine whole blood, the pristine CA membrane exhibited significant blood cell adsorption. In contrast, the functionalized membrane showed no cell attachment. AFM images also show a clear difference between the surface of the pristine CA membrane and PCBU-CA membrane after blood exposure. As shown in FIG. 19, the pristine CA membrane has substantial cell absorption on the surface while the PCBU-CA membrane shows a clean surface with a slight platelet attachment (FIGS. 19a and 19b). The adhesion of platelets and macrophages on a biomaterial surface is a complex process that starts with plasma protein deposition. The attached protein serves as a conditioning layer to catch fibroblast or other types of cells, which eventually results in blood coagulation and thrombosis. As the PCBU-CA membrane showed a significant decrease in fibrinogen adsorption, the subsequent cell attachment also dropped accordingly. Our previous study also demonstrated that PCBU shows a high resistance to fibroblasts under a mimicked in vivo environment. Thus, PCBU coating layer could improve the biocompatibility of CA membrane. A comparison of surfaces after filtration for these two membranes, along with the plasma separation rate results, demonstrates a notable improvement in blood separation performance for the PCBU-CA membrane. FIGS. 16a and b show photographs, optical microscopy images, and AFM images of the whole blood input and the plasma permeate separated by the PCBU-CA membrane-loaded device. After the filtration process, 10 mL of whole blood input with an opaque dark red color yielded ˜2 mL translucent (slightly pink) plasma solution. Optical microscopy and AFM images show blood cells with a size range of 3-8 μm in the whole blood. In comparison, images of the plasma permeate reveal a lack of blood cells. These results confirm that the PCBU-CA membrane effectively filtered the blood cell components and allowed only plasma to pass through, without a significant loss of flux due to the excellent antifouling performance of the PCBU.

The hemolysis of RBCs is another undesired effect in most membrane-based blood plasma separation devices. Due to the high shear stress in membrane filtration and poor biocompatibility of the membrane material, RBCs often break, resulting in hemolysis. To determine whether hemolysis occurred in the device, the absorbance spectra of plasma extracted by our device with that of centrifuged plasma and lysed blood were compared (FIG. 16c). Typical absorbance peaks for hemoglobin in a blood plasma sample appear at 540 and 574 nm. The plasma solution filtered at the high differential pressure, −7.5 psi, showed two clear peaks, indicating that hemolysis occurred during filtration. However, there is no notable difference between the plasma solutions processed at low differential pressures (−2.5 and −5 psi) and the centrifuged plasma solution. The small absorbance peaks at 540 and 574 nm primarily correspond to the natural hemolysis of RBCs during blood storage. The comparable hemolysis level with centrifuged plasma under a low differential pressure indicates that the PCBU-CA membrane has good biocompatibility without any significant hemolysis during the plasma separation process. The hemoglobin release test results demonstrate that when operated at the optimum vacuum level (e.g., −5 psi), our plasma separation device can provide a low level of hemolysis and high quality of separated plasma along with a high filtration efficiency.

In a blood-plasma separation device, it is required to reduce the loss of protein from the blood. The protein level in human plasma has been widely used to monitor cancer, liver functions, and inflammatory response. However, many plasma separation devices have low protein recovery due to a high surface-to-volume design. To evaluate the protein recovery efficiency of our device, the quantitative albumin level was measured by a BCG albumin assay kit. Here, we used the plasma sample prepared by the centrifugation method as a reference (set as 100% albumin recovery). As shown in FIG. 16d, the filtered plasma with CA membrane from whole blood allows 86.7±0.7% of albumin recovery, while filtered plasma from PCB-CA membrane shows 90.1±7.9% of albumin recovery. The albumin recovery from the diluted blood filtered with pristine CA membrane and PCB-CA membrane is 85.0±4.1% and 84.8±4.3%, respectively, indicating that the use of 1:1 diluted blood did not change the albumin recovery compared to the results of undiluted blood. Although the PCB-CA membrane was proved to have lower protein adsorption than the CA membrane, the albumin recovery of plasma from the two membranes shows no significant difference. The similar albumin recovery efficiency is probably because albumin loss was not only caused by absorption on the membrane but also by the absorption on the device surface wall and the sedimented blood cell cake layer on the membrane surface. Nonetheless, the performance of our device is in a similar range of reported membrane-based plasma separation devices, which generally allow 77% to 89% of protein recovery.

The PCBU-modified membrane exhibits a stable, high-density layer on the membrane surface, based on the excellent adherence ability of polyurethane due to its strong intermolecular interactions with the membrane materials. The urethane group in PCBU serves as a hydrogen bond donor and receptor, which allows the PCBU to firmly attach to the CA membrane surface via hydrogen bonding without additional anchoring blocks. Thus, PCBU enables a practical and straightforward coating approach for introducing zwitterion groups onto the membrane surface while maintaining the excellent antifouling properties of DEAEA. As most studies on zwitterionic membrane coatings have focused on hydrophobic membrane surfaces such as poly(vinylidene fluoride) and polypropylene, few approaches have been reported for utilizing zwitterionic coatings on membranes that are widely used for filtering biological media, such as CA membranes. A practical approach that further improves the antifouling behavior in current low-protein-binding filters is needed to achieve a breakthrough in bioseparation. The PCBU-based membrane modification demonstrated in this work can effectively reduce the fibrinogen adsorption of the CA membrane by 58.5%, which has great potential for the development of membrane-based blood filtration processes in bioseparation and life science fields. We also demonstrated that the permeated plasma has a high quality, with low hemolysis levels and no blood cells. In future work, we will directly fabricate membranes with zwitterionic polyurethane as bulk materials to further reduce fibrinogen adsorption on the membrane surface and to deliver a higher plasma volume in less than 10 min. The device design can also be modified to yield a higher plasma volume by loading a larger membrane. Furthermore, we will also spike whole blood samples with pathogens (e.g., virus, bacteria) and investigate the suitability of the PCBU-membrane device for practical diagnosis applications.

Thus, in accordance with the principles herein, an exemplary facile and simple one-step antifouling coating process for whole blood separation that incorporates the excellent antifouling properties of zwitterionic polyurethane is set forth. The exemplary PCBU coating layer was shown to be stable in an aqueous environment, with a decrease of approximately 60% in fibrinogen adsorption compared with a commercial CA membrane and an undisturbed pore structure. Further, an exemplary portable, easy-to-use plasma separator is set forth and configured for real-time isolation of plasma from whole blood, which takes advantage of the low specific adsorption of blood cells on the PCBU-CA membrane to enable a high flux separation of plasma. Within 10 min, the separator can yield 0.48 mL plasma from undiluted whole blood or 0.69 mL plasma from 1:1 diluted blood. The coated PCBU membrane showed a significant decrease in blood cell attachment after blood filtration. The extracted plasma was proven to be cell-free with a low hemoglobin level and a high protein recovery. Plasma separators constructed in accordance with the principles herein can be used as a disposable stand-alone separation device with minimal lab-scale medical diagnostic instruments, enabling rapid, simple, and accurate pathogen diagnostics at the clinic/bedside in resource-restricted settings.

1. A plasma separation device comprising:
a blood inlet and a plasma outlet,
the blood inlet comprising an inlet tunnel configured for loading a whole blood sample and a first chamber configured for collecting the whole blood sample;
the plasma outlet comprising a second chamber for collecting plasma separated from the whole blood;
the device comprising a membrane disposed between the blood inlet and the plasma outlet configured for separating the plasma from the whole blood, the membrane comprising a zwitterionic polyurethane or pre-polymer thereof, wherein the zwitterionic polyurethane or pre-polymer thereof comprises a monomeric unit comprising a zwitterion or precursor thereof and optionally a monomeric unit derived from a polyol, wherein the monomeric unit derived from a polyol is present in a molar ratio of 0, 0.1, 0.15, 0.20, 0.25, 0.30, 0.35, 0.40, 0.45, 0.50, 0.55, 0.60, 0.65, 0.70, 0.75, or 0.80 relative to the combined amount of monomeric unit derived from a polyol and the monomeric unit comprising a zwitterion or precursor thereof.

2. The plasma separation device of claim 1, wherein the membrane has a biofilm surface coverage of less than 50%, less than 40%, less than 30%, less than 20%, less than 10%, less than 5%, or less than 1%, after exposure to P. aeruginosa for three weeks when tested in accordance with the Biofilm Formation Test.

3. The plasma separation device of claim 1, wherein the membrane comprises less than 5 ng/cm² of fibrinogen adsorbed on the membrane surface, when tested in accordance with the Protein Adsorption Test.

4. The plasma separation device of claim 1, wherein the membrane has a flux of at least about 0.05 mL/min, at least about 0.075 mL/min, at least about 0.1 mL/min, at least about 0.25 mL/min, or at least about 0.40 mL/min without application of an external driving force.

5. The plasma separation device of claim 1, wherein less than about 2%, less than about 1%, or less than about 0.05% by volume of non-plasma components of the whole blood pass through the membrane.

6. The plasma separation device of claim 1, wherein the membrane is disposed between the first and second chamber.

7. The plasma separation device of claim 1, further comprising a vacuuming plasma chamber operably associated with the plasma outlet.

8. The plasma separation device of claim 1, wherein the first chamber has a capacity for a volume of the whole blood sample in a range of about 0.001 to about 1000 mL, about 0.001 to about 750 mL, about 0.01 to about 500 mL, about 0.01 to about 250 mL, about 0.01 to about 100 mL, about 0.01 to about 75 mL, about 0.01 to about 50 mL, about 0.01 to about 25 mL, about 0.01 to about 20 mL, about 0.05 to about 20 mL, about 0.10 to about 18 mL, about 0.25 to about 16 mL, about 0.5 to about 15 mL, about 0.75 to about 10 mL, or about 1 to about 5 mL.

9. The plasma separation device of claim 1, wherein the zwitterionic polyurethane or pre-polymer thereof comprises a polycarboxybetaine urethane (PCBU), polycarboxybetaine methacrylate, polycarboxybetaine acrylate, polycarboxybetaine acrylamide, polycarboxybetain methacrylamide, or a combination thereof.

10. The plasma separation device of claim 1, wherein the zwitterionic polyurethane comprises hydrolyzed poly((diethanolamine ethyl acetate)-co-poly(1,6-diisocyanatohexane)), hydrolyzed poly((diethanolamine ethyl acetate)-co-poly(tetrahydrofuran)-co-poly( 1,6-diisocyanatohexane)), hydrolyzed poly((diethanoamino-N-hydroxyl ethyl acetate)-co-poly(1,6-diisocyanatohexane)), hydrolyzed poly((diethanoamino-N-hydroxyl ethyl acetate)-co-poly(tetrahydrofuran)-co-poly( 1,6-diisocyanatohexane)), hydrolyzed poly((diethanolamine ethyl acetate)-co-poly(diethanoamino-N-hydroxyl ethyl acetate)-co-poly(1,6-diisocyanatohexane)), hydrolyzed poly((diethanolamine ethyl acetate)-co-poly(diethanoamino-N-hydroxyl ethyl acetate)-co-poly(tetrahydrofuran)-co-poly( 1,6-diisocyanatohexane)), and a combination thereof.

11. The plasma separation device of claim 1, wherein the membrane comprises a porous membrane support having at least one surface and at least one pore, and the porous membrane support includes a layer of the zwitterionic polyurethane or pre-polymer thereof on a surface of the porous membrane support.

12. The plasma separation device of claim 11, wherein the zwitterionic polyurethane or pre-polymer thereof covers substantially all surfaces and pore walls of the porous membrane support.

13. The plasma separation device of claim 11, wherein the membrane has a surface morphology and a pore size distribution and the surface morphology and pore size distribution is substantially similar to a surface morphology and a pore size distribution of the porous membrane support prior to the addition of the zwitterionic polyurethane.

14. The plasma separation device of claim 11, wherein the porous membrane support comprises a thermoplastic polymer, a glassy polymer, of a combination thereof.

15. The plasma separation device of claim 7, wherein the porous membrane support comprises cellulose, cellulose acetate, polysulfone, polycarbonate, polyethersulfone, polypropylene, polylactic acid, polyvinylidene fluoride, nylon, glass fiber, mixed cellulose esters, polyacrylonitrile, polyether ether ketone, polyester, polytetrafluoroethylene, or a combination thereof.

16. The plasma separation device of claim 1, wherein the membrane has a pore size in a range of about 20 nm to about 5 μm, about 50 nm to about 4.5 μm, about 75 nm to about 4 μm, about 100 nm to about 3.5 μm, about 250 nm to about 3.0 μm, about 500 nm to about 2.5 μm, about 750 nm to about 2 μm, or about 1 μm.

17. A filter device comprising:
a filter, the filter having a surface morphology and a pore size distribution, the filter comprising:
a porous membrane support having a surface morphology and a pore size distribution; and
a zwitterionic polyurethane or pre-polymer thereof,
wherein the porous membrane support includes a layer of the zwitterionic polyurethane or pre-polymer thereof on a surface of the porous membrane support; and wherein the surface morphology and pore size distribution of the filter is substantially similar to the surface morphology and the pore size distribution of the porous membrane support prior to the addition of the zwitterionic polyurethane or pre-polymer thereof.

18. (canceled)

19. (canceled)

20. (canceled)

21. (canceled)

22. (canceled)

23. (canceled)

24. (canceled)

25. A method of preparing a plasma separation device comprising the steps of:
assembling a device with a blood inlet and a plasma outlet,
providing a membrane disposed between the blood inlet and the plasma outlet;
wherein the membrane comprises a zwitterionic polyurethane or pre-polymer thereof.

26. (canceled)

27. (canceled)

28. (canceled)

29. (canceled)

30. A zwitterionic polyurethane membrane configured to separate plasma from a blood sample, comprising
a porous membrane support having a surface morphology and a pore size distribution; and
a zwitterionic polyurethane or pre-polymer thereof,
wherein the porous membrane support includes a layer of the zwitterionic polyurethane or pre-polymer thereof on a surface of the porous membrane support to provide a zwitterionic polyurethane membrane, wherein the zwitterionic polyurethane membrane has a pore size distribution in a range of about 20 nm to about 5 μm, about 50 nm to about 4.5 μm, about 75 nm to about 4 μm, about 100 nm to about 3.5 μm, about 250 nm to about 3.0 μm, about 500 nm to about 2.5 μm, about 750 nm to about 2 μm, or about 1 μm.

31.

32.

33.

34. (canceled)

35. (canceled)

36. (canceled)

37. A method of separating plasma from whole blood, comprising:
providing whole blood to the plasma separation device of any one of claims 1 to 16, and allowing the plasma from the whole blood to filter from the blood inlet through the membrane to the plasma outlet.

38. (canceled)

39. (canceled)
